(19) United States
(12) Patent Application Publication
(10) Pub. No.: US 2026/0368456 A1
(43) Pub. Date: Nov. 19, 2026

(54) USER INTERFACES FOR AUTOMATIC TRANSLATIONS AND SHARING USER REPRESENTATIONS

(71) Applicant: Apple Inc., Cupertino, CA (US)

(72) Inventors: Eunice Y. LEE, San Francisco, CA (US); Jarrett A. FORD, Alameda, CA (US); Mitchell R. LERNER, San Francisco, CA (US)

(21) Appl. No.: 19/455,532

(22) Filed: Jan. 21, 2026

Related U.S. Application Data
(60) Provisional application No. 63/807,487, filed on May 16, 2025.
(60) Provisional application No. 63/818,435, filed on Jun. 5, 2025.

(51) Int. Cl. G06F 40/58; G06F 3/04842; G06F 3/16; G10L 15/22

(52) U.S. Cl. CPC G06F 40/58; G06F 3/04842; G06F 3/165; G10L 15/22

(57) ABSTRACT

The present disclosure generally relates to user interfaces for activating automatic translation of audio and text during a communication session as well as user interfaces for sharing a user representation with one or more contacts.

### CROSS-REFERENCE TO RELATED APPLICATIONS

This application claims priority to U.S. Provisional Patent Application No. 63/818,435, entitled “USER INTERFACES FOR AUTOMATIC TRANSLATIONS AND SHARING USER REPRESENTATIONS,” filed on Jun. 5, 2025; and to U.S. Provisional Patent Application No. 63/807,487, entitled “USER INTERFACES FOR AUTOMATIC TRANSLATIONS AND SHARING USER REPRESENTATIONS,” filed on May 16, 2025, the contents of each of which are hereby incorporated by reference in their entirety.

### FIELD

The present disclosure relates generally to computer user interfaces, and more specifically to techniques for activating automatic translation modes and sharing user representations with contactable users.

### BACKGROUND

Computer systems are used to translate text from one language to another language, thereby enabling individuals who do not understand a particular language in which a document is written to access a translated version of the document.

### BRIEF SUMMARY

Some techniques for activating automatic translation modes and sharing representations with contactable users using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for activating automatic translation modes and sharing user representations with contactable users. Such methods and interfaces optionally complement or replace other methods for activating automatic translation modes and sharing user representations with contactable users. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a computer system that is in communication with one or more display generation components and one or more input devices: receiving a first message from a first contact; in response to receiving the first message: in accordance with a determination that the first message is in a first language, displaying, via the one or more display generation components, a first option that, when selected, initiates a process for activating a first automatic translation mode for a first message transcript corresponding to the first contact, wherein activation of the first automatic translation mode enables messages received from the first contact to be translated from the first language to a second language; while displaying the first message transcript corresponding to the first contact, receiving, via the one or more input devices, a first input; and in response to receiving the first input, displaying a first contact details user interface associated with the first message transcript, wherein the first contact details user interface includes a plurality of options associated with the first message transcript including a second option for modifying an operation status of the first automatic translation mode for the first message transcript.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices. The one or more programs include instructions for: receiving a first message from a first contact; in response to receiving the first message: in accordance with a determination that the first message is in a first language, displaying, via the one or more display generation components, a first option that, when selected, initiates a process for activating a first automatic translation mode for a first message transcript corresponding to the first contact, wherein activation of the first automatic translation mode enables messages received from the first contact to be translated from the first language to a second language; while displaying the first message transcript corresponding to the first contact, receiving, via the one or more input devices, a first input; and in response to receiving the first input, displaying a first contact details user interface associated with the first message transcript, wherein the first contact details user interface includes a plurality of options associated with the first message transcript including a second option for modifying an operation status of the first automatic translation mode for the first message transcript.

In accordance with some embodiments, a transitory computer-readable storage medium is described. The transitory computer-readable storage medium stores one or more programs configured to be executed by one or more processors of a computer system that is in communication with one or more display generation components and one or more input devices. The one or more programs include instructions for: receiving a first message from a first contact; in response to receiving the first message: in accordance with a determination that the first message is in a first language, displaying, via the one or more display generation components, a first option that, when selected, initiates a process for activating a first automatic translation mode for a first message transcript corresponding to the first contact, wherein activation of the first automatic translation mode enables messages received from the first contact to be translated from the first language to a second language; while displaying the first message transcript corresponding to the first contact, receiving, via the one or more input devices, a first input; and in response to receiving the first input, displaying a first contact details user interface associated with the first message transcript, wherein the first contact details user interface includes a plurality of options associated with the first message transcript including a second option for modifying an operation status of the first automatic translation mode for the first message transcript.

In accordance with some embodiments, a computer system configured to communicate with one or more display generation components and one or more input devices is described. The computer system comprises one or more processors and memory storing one or more programs configured to be executed by the one or more processors. The one or more programs include instructions for: receiving a first message from a first contact; in response to receiving the first message: in accordance with a determination that the first message is in a first language, displaying, via the one or more display generation components, a first option that, when selected, initiates a process for activating a first automatic translation mode for a first message transcript corresponding to the first contact, wherein activation of the first automatic translation mode enables messages received from the first contact to be translated from the first language to a second language; while displaying the first message transcript corresponding to the first contact, receiving, via the one or more input devices, a first input; and in response to receiving the first input, displaying a first contact details user interface associated with the first message transcript, wherein the first contact details user interface includes a plurality of options associated with the first message transcript including a second option for modifying an operation status of the first automatic translation mode for the first message transcript.

In accordance with some embodiments, a computer system configured to communicate with one or more display generation components and one or more input devices is described. The computer system comprises: means for receiving a first message from a first contact; means for in response to receiving the first message: in accordance with a determination that the first message is in a first language, displaying, via the one or more display generation components, a first option that, when selected, initiates a process for activating a first automatic translation mode for a first message transcript corresponding to the first contact, wherein activation of the first automatic translation mode enables messages received from the first contact to be translated from the first language to a second language; means for while displaying the first message transcript corresponding to the first contact, receiving, via the one or more input devices, a first input; and means for in response to receiving the first input, displaying a first contact details user interface associated with the first message transcript, wherein the first contact details user interface includes a plurality of options associated with the first message transcript including a second option for modifying an operation status of the first automatic translation mode for the first message transcript.

In accordance with some embodiments, a computer program product is described.

The computer program product comprises one or more programs configured to be executed by one or more processors of a computer system that is in communication with one or more display generation components and one or more input devices. The one or more programs include instructions for: receiving a first message from a first contact; in response to receiving the first message: in accordance with a determination that the first message is in a first language, displaying, via the one or more display generation components, a first option that, when selected, initiates a process for activating a first automatic translation mode for a first message transcript corresponding to the first contact, wherein activation of the first automatic translation mode enables messages received from the first contact to be translated from the first language to a second language; while displaying the first message transcript corresponding to the first contact, receiving, via the one or more input devices, a first input; and in response to receiving the first input, displaying a first contact details user interface associated with the first message transcript, wherein the first contact details user interface includes a plurality of options associated with the first message transcript including a second option for modifying an operation status of the first automatic translation mode for the first message transcript.

In accordance with some embodiments, a method is described. The method comprises: at a computer system that is in communication with one or more display generation components, one or more input devices, and one or more output devices: receiving, via the one or more input devices, a first set of one or more inputs to initiate a first communication session between a first user associated with the computer system and a first participant associated with an external device; in response to receiving the first set of one or more inputs: in accordance with a determination that translation criteria are met, displaying, via the one or more display generation components, an option to enable operation of an automatic translation mode, wherein selection of the option to enable operation of the automatic translation enables translation of first audio received from the first participant; and in accordance with a determination that the translation criteria are not met, forgoing displaying the option to enable operation of the automatic translation mode; during the first communication session and while the automatic translation mode is enabled, receiving the first audio from the first participant, wherein the first audio is in a first language; and in response to receiving the first audio: outputting, via the one or more output devices, the first audio in the first language, wherein at least a portion of the first audio is output at a first volume; and outputting, via the one or more output devices, second audio at a second volume, different from the first volume, wherein the second audio is in a second language and is a translated version of the first audio.

In accordance with some embodiments, a non-transitory computer-readable storage medium is described. The non-transitory computer-readable storage medium stores one or more programs configured to be executed by one or more processors of a computer system that is in communication with one or more display generation components, one or more input devices, and one or more output devices. The one or more programs include instructions for: receiving, via the one or more input devices, a first set of one or more inputs to initiate a first communication session between a first user associated with the computer system and a first participant associated with an external device; in response to receiving the first set of one or more inputs: in accordance with a determination that translation criteria are met, displaying, via the one or more display generation components, an option to enable operation of an automatic translation mode, wherein selection of the option to enable operation of the automatic translation enables translation of first audio received from the first participant; and in accordance with a determination that the translation criteria are not met, forgoing displaying the option to enable operation of the automatic translation mode; during the first communication session and while the automatic translation mode is enabled, receiving the first audio from the first participant, wherein the first audio is in a first language; and in response to receiving the first audio: outputting, via the one or more output devices, the first audio in the first language, wherein at least a portion of the first audio is output at a first volume; and outputting, via the one or more output devices, second audio at a second volume, different from the first volume, wherein the second audio is in a second language and is a translated version of the first audio.

In accordance with some embodiments, a transitory computer-readable storage medium is described. The transitory computer-readable storage medium stores one or more programs configured to be executed by one or more processors of a computer system that is in communication with one or more display generation components, one or more input devices, one or more output devices. The one or more programs include instructions for: receiving, via the one or more input devices, a first set of one or more inputs to initiate a first communication session between a first user associated with the computer system and a first participant associated with an external device; in response to receiving the first set of one or more inputs: in accordance with a determination that translation criteria are met, displaying, via the one or more display generation components, an option to enable operation of an automatic translation mode, wherein selection of the option to enable operation of the automatic translation enables translation of first audio received from the first participant; and in accordance with a determination that the translation criteria are not met, forgoing displaying the option to enable operation of the automatic translation mode; during the first communication session and while the automatic translation mode is enabled, receiving the first audio from the first participant, wherein the first audio is in a first language; and in response to receiving the first audio: outputting, via the one or more output devices, the first audio in the first language, wherein at least a portion of the first audio is output at a first volume; and outputting, via the one or more output devices, second audio at a second volume, different from the first volume, wherein the second audio is in a second language and is a translated version of the first audio.

In accordance with some embodiments, a computer system configured to communicate with one or more display generation components, one or more input devices, and one or more output devices is described. The computer system comprises one or more processors and memory storing one or more programs configured to be executed by the one or more processors. The one or more programs include instructions for: receiving, via the one or more input devices, a first set of one or more inputs to initiate a first communication session between a first user associated with the computer system and a first participant associated with an external device; in response to receiving the first set of one or more inputs: in accordance with a determination that translation criteria are met, displaying, via the one or more display generation components, an option to enable operation of an automatic translation mode, wherein selection of the option to enable operation of the automatic translation enables translation of first audio received from the first participant; and in accordance with a determination that the translation criteria are not met, forgoing displaying the option to enable operation of the automatic translation mode; during the first communication session and while the automatic translation mode is enabled, receiving the first audio from the first participant, wherein the first audio is in a first language; and in response to receiving the first audio: outputting, via the one or more output devices, the first audio in the first language, wherein at least a portion of the first audio is output at a first volume; and outputting, via the one or more output devices, second audio at a second volume, different from the first volume, wherein the second audio is in a second language and is a translated version of the first audio.

In accordance with some embodiments, a computer system configured to communicate with one or more display generation components, one or more input devices, and one or more output devices is described. The computer system comprises: means for receiving, via the one or more input devices, a first set of one or more inputs to initiate a first communication session between a first user associated with the computer system and a first participant associated with an external device; means for in response to receiving the first set of one or more inputs: in accordance with a determination that translation criteria are met, displaying, via the one or more display generation components, an option to enable operation of an automatic translation mode, wherein selection of the option to enable operation of the automatic translation enables translation of first audio received from the first participant; and in accordance with a determination that the translation criteria are not met, forgoing displaying the option to enable operation of the automatic translation mode; means for during the first communication session and while the automatic translation mode is enabled, receiving the first audio from the first participant, wherein the first audio is in a first language; and means for in response to receiving the first audio: outputting, via the one or more output devices, the first audio in the first language, wherein at least a portion of the first audio is output at a first volume; and outputting, via the one or more output devices, second audio at a second volume, different from the first volume, wherein the second audio is in a second language and is a translated version of the first audio.

In accordance with some embodiments, a computer program product is described. The computer program product comprises one or more programs configured to be executed by one or more processors of a computer system that is in communication with one or more display generation components, one or more input devices, and one or more output devices. The one or more programs include instructions for: receiving, via the one or more input devices, a first set of one or more inputs to initiate a first communication session between a first user associated with the computer system and a first participant associated with an external device; in response to receiving the first set of one or more inputs: in accordance with a determination that translation criteria are met, displaying, via the one or more display generation components, an option to enable operation of an automatic translation mode, wherein selection of the option to enable operation of the automatic translation enables translation of first audio received from the first participant; and in accordance with a determination that the translation criteria are not met, forgoing displaying the option to enable operation of the automatic translation mode; during the first communication session and while the automatic translation mode is enabled, receiving the first audio from the first participant, wherein the first audio is in a first language; and in response to receiving the first audio: outputting, via the one or more output devices, the first audio in the first language, wherein at least a portion of the first audio is output at a first volume; and outputting, via the one or more output devices, second audio at a second volume, different from the first volume, wherein the second audio is in a second language and is a translated version of the first audio.

In accordance with some embodiments, a method is described. The method comprises: at a computer system that is in communication with one or more display generation components and one or more input devices: receiving, via the one or more input devices, a first set of one or more inputs corresponding to a first application; in response to receiving the first set of one or more inputs, displaying, via the one or more display generation components, a first user interface associated with the first application; receiving, via the one or more input devices, a first input directed to the first user interface; in response to receiving the first input, displaying a first option for initiating a process to share a first representation of a first user associated with the computer system with one or more contacts, wherein the first option was not displayed prior to receiving the first input; receiving, via the one or more input devices, a second input corresponding to a selection of the first option; and in response to receiving the second input, displaying one or more representations of the first user that are available to be shared with the one or more contacts.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices. The one or more programs include instructions for: receiving, via the one or more input devices, a first set of one or more inputs corresponding to a first application; in response to receiving the first set of one or more inputs, displaying, via the one or more display generation components, a first user interface associated with the first application; receiving, via the one or more input devices, a first input directed to the first user interface; in response to receiving the first input, displaying a first option for initiating a process to share a first representation of a first user associated with the computer system with one or more contacts, wherein the first option was not displayed prior to receiving the first input; receiving, via the one or more input devices, a second input corresponding to a selection of the first option; and in response to receiving the second input, displaying one or more representations of the first user that are available to be shared with the one or more contacts.

In accordance with some embodiments, a transitory computer-readable storage medium is described. The transitory computer-readable storage medium stores one or more programs configured to be executed by one or more processors of a computer system that is in communication with one or more display generation components and one or more input devices. The one or more programs include instructions for: receiving, via the one or more input devices, a first set of one or more inputs corresponding to a first application; in response to receiving the first set of one or more inputs, displaying, via the one or more display generation components, a first user interface associated with the first application; receiving, via the one or more input devices, a first input directed to the first user interface; in response to receiving the first input, displaying a first option for initiating a process to share a first representation of a first user associated with the computer system with one or more contacts, wherein the first option was not displayed prior to receiving the first input; receiving, via the one or more input devices, a second input corresponding to a selection of the first option; and in response to receiving the second input, displaying one or more representations of the first user that are available to be shared with the one or more contacts.

In accordance with some embodiments, a computer system configured to communicate with one or more display generation components and one or more input devices is described. The computer system comprises one or more processors and memory storing one or more programs configured to be executed by the one or more processors. The one or more programs include instructions for: receiving, via the one or more input devices, a first set of one or more inputs corresponding to a first application; in response to receiving the first set of one or more inputs, displaying, via the one or more display generation components, a first user interface associated with the first application; receiving, via the one or more input devices, a first input directed to the first user interface; in response to receiving the first input, displaying a first option for initiating a process to share a first representation of a first user associated with the computer system with one or more contacts, wherein the first option was not displayed prior to receiving the first input; receiving, via the one or more input devices, a second input corresponding to a selection of the first option; and in response to receiving the second input, displaying one or more representations of the first user that are available to be shared with the one or more contacts.

In accordance with some embodiments, a computer system configured to communicate with one or more display generation components and one or more input devices is described. The computer system comprises: means for receiving, via the one or more input devices, a first set of one or more inputs corresponding to a first application; means for in response to receiving the first set of one or more inputs, displaying, via the one or more display generation components, a first user interface associated with the first application; means for receiving, via the one or more input devices, a first input directed to the first user interface; means for in response to receiving the first input, displaying a first option for initiating a process to share a first representation of a first user associated with the computer system with one or more contacts, wherein the first option was not displayed prior to receiving the first input; means for receiving, via the one or more input devices, a second input corresponding to a selection of the first option; and means for in response to receiving the second input, displaying one or more representations of the first user that are available to be shared with the one or more contacts.

In accordance with some embodiments, a computer program product is described. The computer program product comprises one or more programs configured to be executed by one or more processors of a computer system that is in communication with one or more display generation components and one or more input devices. The one or more programs include instructions for: receiving, via the one or more input devices, a first set of one or more inputs corresponding to a first application; in response to receiving the first set of one or more inputs, displaying, via the one or more display generation components, a first user interface associated with the first application; receiving, via the one or more input devices, a first input directed to the first user interface; in response to receiving the first input, displaying a first option for initiating a process to share a first representation of a first user associated with the computer system with one or more contacts, wherein the first option was not displayed prior to receiving the first input; receiving, via the one or more input devices, a second input corresponding to a selection of the first option; and in response to receiving the second input, displaying one or more representations of the first user that are available to be shared with the one or more contacts.

In accordance with some embodiments, a method is described. The method comprises: at a computer system that is in communication with one or more display generation components and one or more input devices: displaying, via the one or more display generation components, a first user interface that is for configuring a graphical component of a custom representation of a user of the computer system; detecting, via the one or more input devices, a first set of one or more inputs selecting one or more custom graphical representations for the graphical component of the custom representation of the user of the computer system, wherein the first set of one or more inputs includes at least one input directed to the first user interface; in response to detecting the first set of one or more inputs, displaying, via the one or more display generation components, a second user interface that is for configuring one or more contact settings of the custom representation of the user of the computer system; while displaying the second user interface, detecting, via the one or more input devices, a second set of one or more inputs that includes a request to share the custom representation of the user of the computer system with one or more contacts; in response to detecting the second set of one or more inputs, initiating a process to share the custom representation of the user of the computer system with the one or more contacts; after the process to share the custom representation of the user of the computer system with the one or more contacts is performed, detecting, via the one or more input devices, a second input that corresponds to a request to configure the custom representation of the user of the computer system; in response to detecting the second input, displaying, via the one or more display generation components, a scrollable configuration user interface, including displaying a first set of options for configuring the graphical component of the custom representation of the user of the computer system; while displaying the first set of options for configuring the graphical component of the custom representation of the user of the computer system, detecting, via the one or more input devices, a third input that corresponds to a request to scroll within the scrollable configuration user interface; and in response to detecting the third input, displaying, via the one or more display generation components, a second set of options for configuring the one or more contact settings of the custom representation of the user of the computer system.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices. The one or more programs include instructions for: displaying, via the one or more display generation components, a first user interface that is for configuring a graphical component of a custom representation of a user of the computer system; detecting, via the one or more input devices, a first set of one or more inputs selecting one or more custom graphical representations for the graphical component of the custom representation of the user of the computer system, wherein the first set of one or more inputs includes at least one input directed to the first user interface; in response to detecting the first set of one or more inputs, displaying, via the one or more display generation components, a second user interface that is for configuring one or more contact settings of the custom representation of the user of the computer system; while displaying the second user interface, detecting, via the one or more input devices, a second set of one or more inputs that includes a request to share the custom representation of the user of the computer system with one or more contacts; in response to detecting the second set of one or more inputs, initiating a process to share the custom representation of the user of the computer system with the one or more contacts; after the process to share the custom representation of the user of the computer system with the one or more contacts is performed, detecting, via the one or more input devices, a second input that corresponds to a request to configure the custom representation of the user of the computer system; in response to detecting the second input, displaying, via the one or more display generation components, a scrollable configuration user interface, including displaying a first set of options for configuring the graphical component of the custom representation of the user of the computer system; while displaying the first set of options for configuring the graphical component of the custom representation of the user of the computer system, detecting, via the one or more input devices, a third input that corresponds to a request to scroll within the scrollable configuration user interface; and in response to detecting the third input, displaying, via the one or more display generation components, a second set of options for configuring the one or more contact settings of the custom representation of the user of the computer system.

In accordance with some embodiments, a transitory computer-readable storage medium is described. The transitory computer-readable storage medium stores one or more programs configured to be executed by one or more processors of a computer system that is in communication with one or more display generation components and one or more input devices. The one or more programs include instructions for: displaying, via the one or more display generation components, a first user interface that is for configuring a graphical component of a custom representation of a user of the computer system; detecting, via the one or more input devices, a first set of one or more inputs selecting one or more custom graphical representations for the graphical component of the custom representation of the user of the computer system, wherein the first set of one or more inputs includes at least one input directed to the first user interface; in response to detecting the first set of one or more inputs, displaying, via the one or more display generation components, a second user interface that is for configuring one or more contact settings of the custom representation of the user of the computer system; while displaying the second user interface, detecting, via the one or more input devices, a second set of one or more inputs that includes a request to share the custom representation of the user of the computer system with one or more contacts; in response to detecting the second set of one or more inputs, initiating a process to share the custom representation of the user of the computer system with the one or more contacts; after the process to share the custom representation of the user of the computer system with the one or more contacts is performed, detecting, via the one or more input devices, a second input that corresponds to a request to configure the custom representation of the user of the computer system; in response to detecting the second input, displaying, via the one or more display generation components, a scrollable configuration user interface, including displaying a first set of options for configuring the graphical component of the custom representation of the user of the computer system; while displaying the first set of options for configuring the graphical component of the custom representation of the user of the computer system, detecting, via the one or more input devices, a third input that corresponds to a request to scroll within the scrollable configuration user interface; and in response to detecting the third input, displaying, via the one or more display generation components, a second set of options for configuring the one or more contact settings of the custom representation of the user of the computer system.

In accordance with some embodiments, a computer system configured to communicate with one or more display generation components and one or more input devices is described. The computer system comprises one or more processors and memory storing one or more programs configured to be executed by the one or more processors. The one or more programs include instructions for: displaying, via the one or more display generation components, a first user interface that is for configuring a graphical component of a custom representation of a user of the computer system; detecting, via the one or more input devices, a first set of one or more inputs selecting one or more custom graphical representations for the graphical component of the custom representation of the user of the computer system, wherein the first set of one or more inputs includes at least one input directed to the first user interface; in response to detecting the first set of one or more inputs, displaying, via the one or more display generation components, a second user interface that is for configuring one or more contact settings of the custom representation of the user of the computer system; while displaying the second user interface, detecting, via the one or more input devices, a second set of one or more inputs that includes a request to share the custom representation of the user of the computer system with one or more contacts; in response to detecting the second set of one or more inputs, initiating a process to share the custom representation of the user of the computer system with the one or more contacts; after the process to share the custom representation of the user of the computer system with the one or more contacts is performed, detecting, via the one or more input devices, a second input that corresponds to a request to configure the custom representation of the user of the computer system; in response to detecting the second input, displaying, via the one or more display generation components, a scrollable configuration user interface, including displaying a first set of options for configuring the graphical component of the custom representation of the user of the computer system; while displaying the first set of options for configuring the graphical component of the custom representation of the user of the computer system, detecting, via the one or more input devices, a third input that corresponds to a request to scroll within the scrollable configuration user interface; and in response to detecting the third input, displaying, via the one or more display generation components, a second set of options for configuring the one or more contact settings of the custom representation of the user of the computer system.

In accordance with some embodiments, a computer system configured to communicate with one or more display generation components and one or more input devices is described. The computer system comprises: means for displaying, via the one or more display generation components, a first user interface that is for configuring a graphical component of a custom representation of a user of the computer system; means for detecting, via the one or more input devices, a first set of one or more inputs selecting one or more custom graphical representations for the graphical component of the custom representation of the user of the computer system, wherein the first set of one or more inputs includes at least one input directed to the first user interface; means for, in response to detecting the first set of one or more inputs, displaying, via the one or more display generation components, a second user interface that is for configuring one or more contact settings of the custom representation of the user of the computer system; means for, while displaying the second user interface, detecting, via the one or more input devices, a second set of one or more inputs that includes a request to share the custom representation of the user of the computer system with one or more contacts; means for, in response to detecting the second set of one or more inputs, initiating a process to share the custom representation of the user of the computer system with the one or more contacts; means for, after the process to share the custom representation of the user of the computer system with the one or more contacts is performed, detecting, via the one or more input devices, a second input that corresponds to a request to configure the custom representation of the user of the computer system; means for, in response to detecting the second input, displaying, via the one or more display generation components, a scrollable configuration user interface, including displaying a first set of options for configuring the graphical component of the custom representation of the user of the computer system; means for, while displaying the first set of options for configuring the graphical component of the custom representation of the user of the computer system, detecting, via the one or more input devices, a third input that corresponds to a request to scroll within the scrollable configuration user interface; and means for, in response to detecting the third input, displaying, via the one or more display generation components, a second set of options for configuring the one or more contact settings of the custom representation of the user of the computer system.

In accordance with some embodiments, a computer program product is described. The computer program product comprises one or more programs configured to be executed by one or more processors of a computer system that is in communication with one or more display generation components and one or more input devices. The one or more programs include instructions for: displaying, via the one or more display generation components, a first user interface that is for configuring a graphical component of a custom representation of a user of the computer system; detecting, via the one or more input devices, a first set of one or more inputs selecting one or more custom graphical representations for the graphical component of the custom representation of the user of the computer system, wherein the first set of one or more inputs includes at least one input directed to the first user interface; in response to detecting the first set of one or more inputs, displaying, via the one or more display generation components, a second user interface that is for configuring one or more contact settings of the custom representation of the user of the computer system; while displaying the second user interface, detecting, via the one or more input devices, a second set of one or more inputs that includes a request to share the custom representation of the user of the computer system with one or more contacts; in response to detecting the second set of one or more inputs, initiating a process to share the custom representation of the user of the computer system with the one or more contacts; after the process to share the custom representation of the user of the computer system with the one or more contacts is performed, detecting, via the one or more input devices, a second input that corresponds to a request to configure the custom representation of the user of the computer system; in response to detecting the second input, displaying, via the one or more display generation components, a scrollable configuration user interface, including displaying a first set of options for configuring the graphical component of the custom representation of the user of the computer system; while displaying the first set of options for configuring the graphical component of the custom representation of the user of the computer system, detecting, via the one or more input devices, a third input that corresponds to a request to scroll within the scrollable configuration user interface; and in response to detecting the third input, displaying, via the one or more display generation components, a second set of options for configuring the one or more contact settings of the custom representation of the user of the computer system.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for activating automatic translation modes and sharing representations with contactable users, thereby increasing the effectiveness, efficiency, and user satisfaction with such devices. Such methods and interfaces may complement or replace other methods for activating automatic translation modes and sharing representations with contactable users.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6W illustrate exemplary user interfaces for causing the display of an option to automatically translate messages for a message transcript.

FIG. 7 is a flow diagram illustrating methods for causing the display of an option to automatically translate messages for a message transcript

FIGS. 8A-8S illustrate exemplary user interfaces for automatically translating incoming and outgoing audio during a communication session.

FIG. 9 is a flow diagram illustrating methods for automatically translating incoming and outgoing audio during a communication session.

FIGS. 10A-10J illustrate exemplary user interfaces for displaying an option for sharing a user representation with one or more contacts.

FIG. 11 is a flow diagram illustrating methods for displaying an option for sharing a user representation with one or more contacts.

FIGS. 12A-12N illustrate exemplary user interfaces for configuring a custom user representation for sharing with one or more contacts in accordance with some embodiments.

FIGS. 13A-13B are a flow diagram illustrating methods for configuring a custom user representation for sharing with one or more contact in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for activating automatic translation modes and sharing user representations with contactable users. For example, it would be advantageous to provide a user with options for automatically translating text and audio during a communication session. Additionally, as an example, it would be advantageous to provide a user with an option for sharing a representation with other contactable users when opening an application of the computer system. Such techniques can reduce the cognitive burden on a user who activating automatic translation modes and sharing representations with contactable users, thereby enhancing productivity. Further, such techniques can reduce processor and battery power otherwise wasted on redundant user inputs.

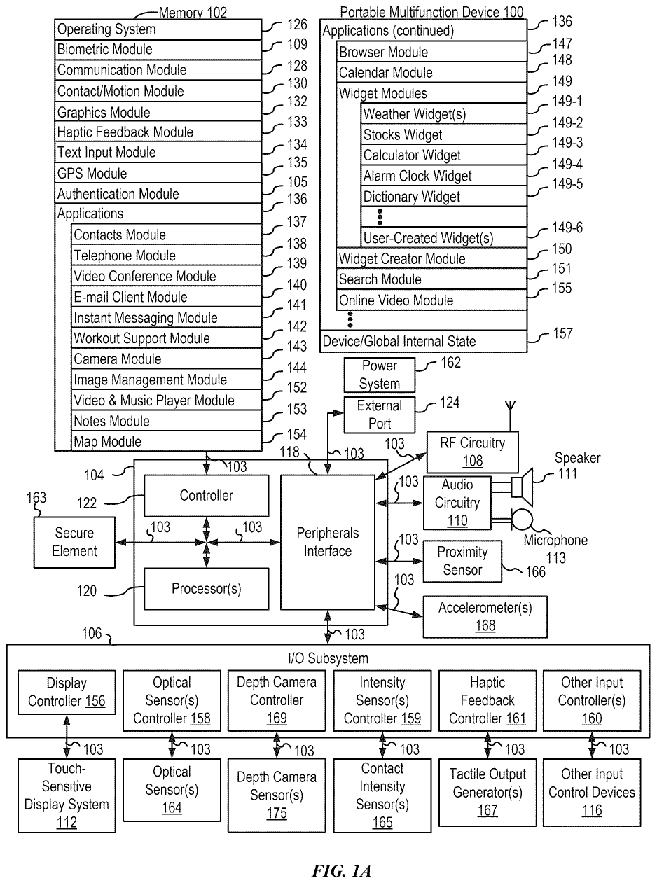

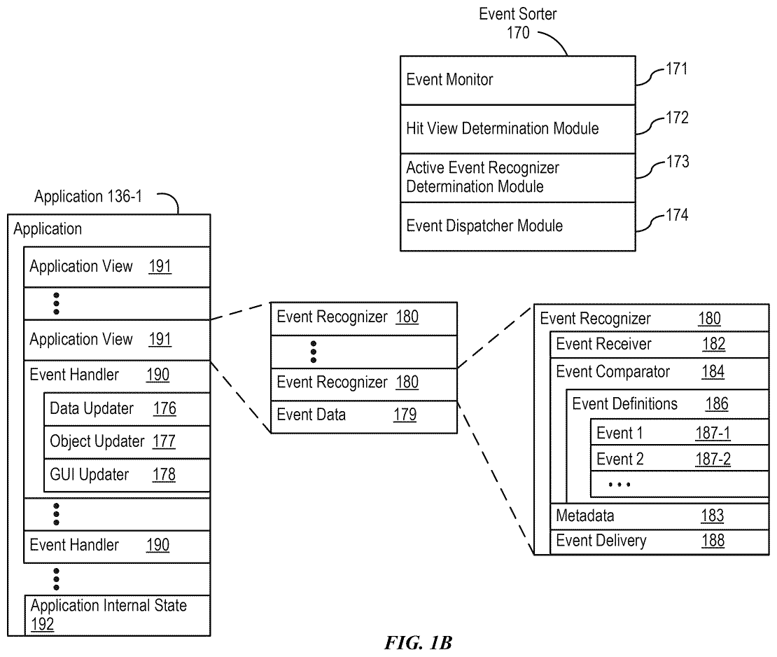

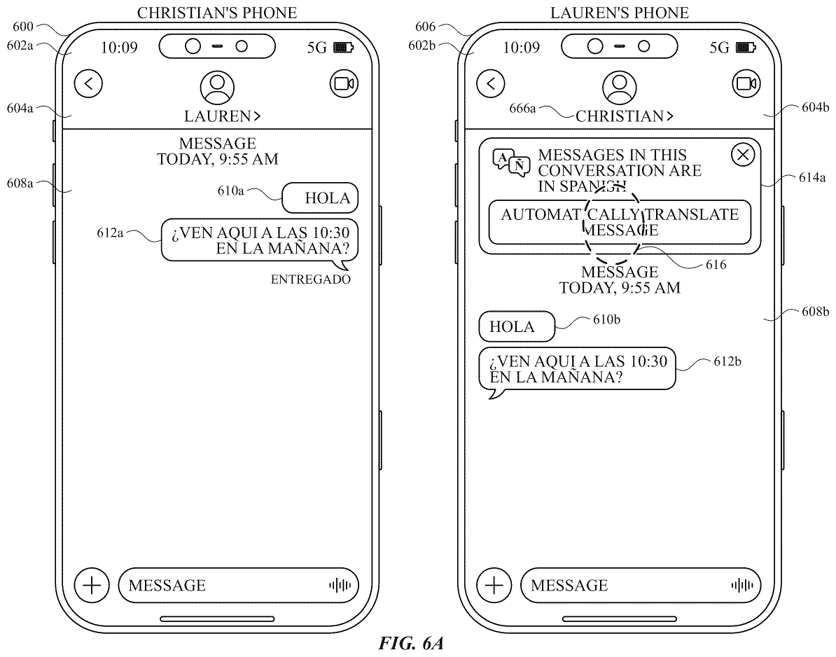

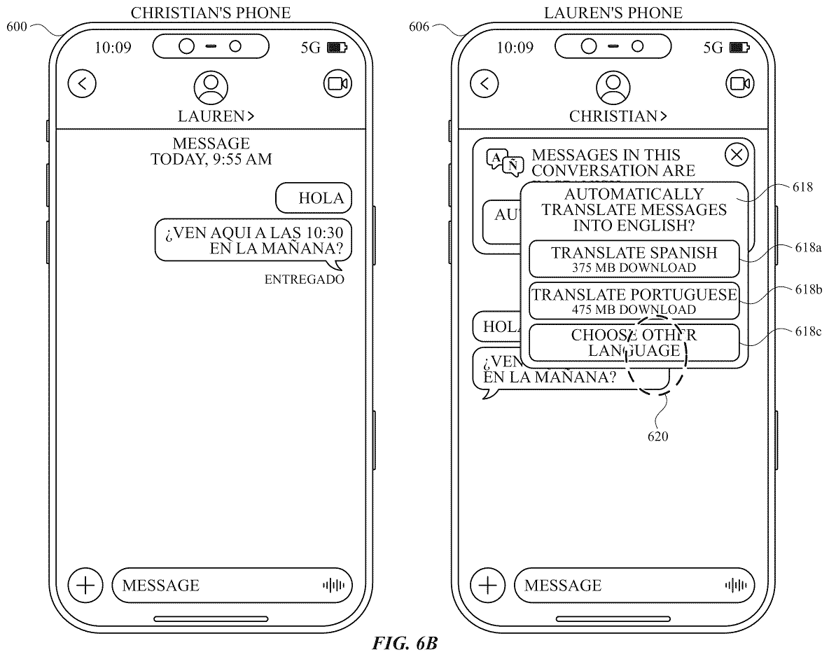

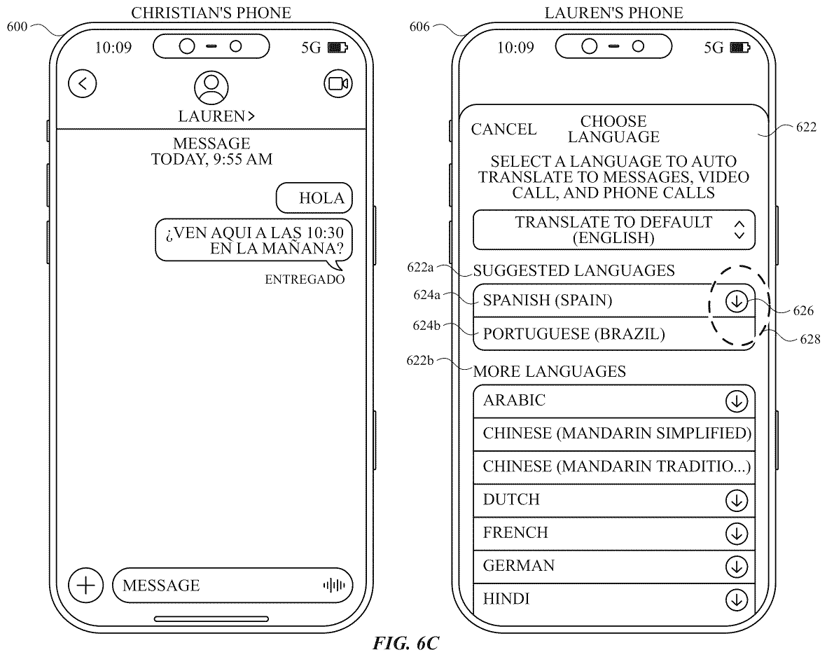

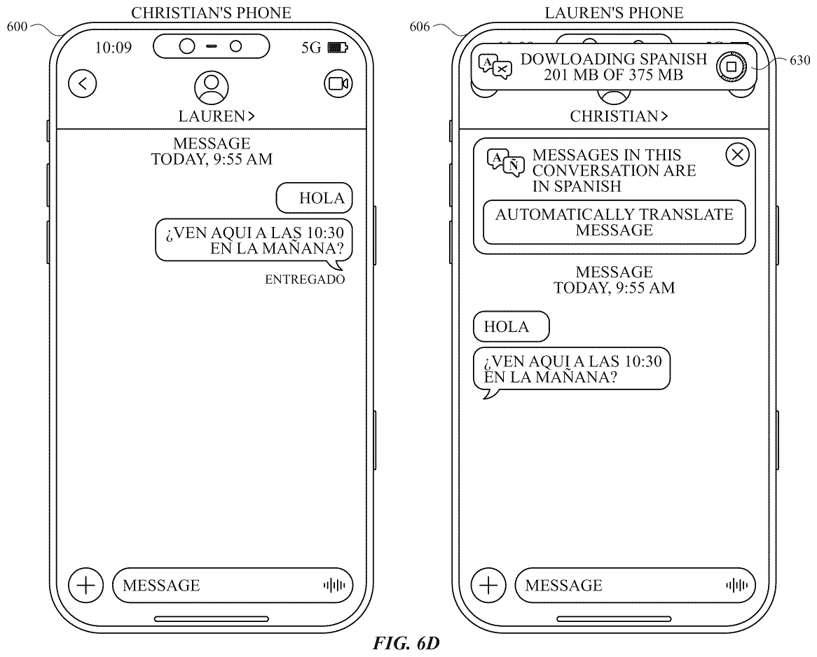

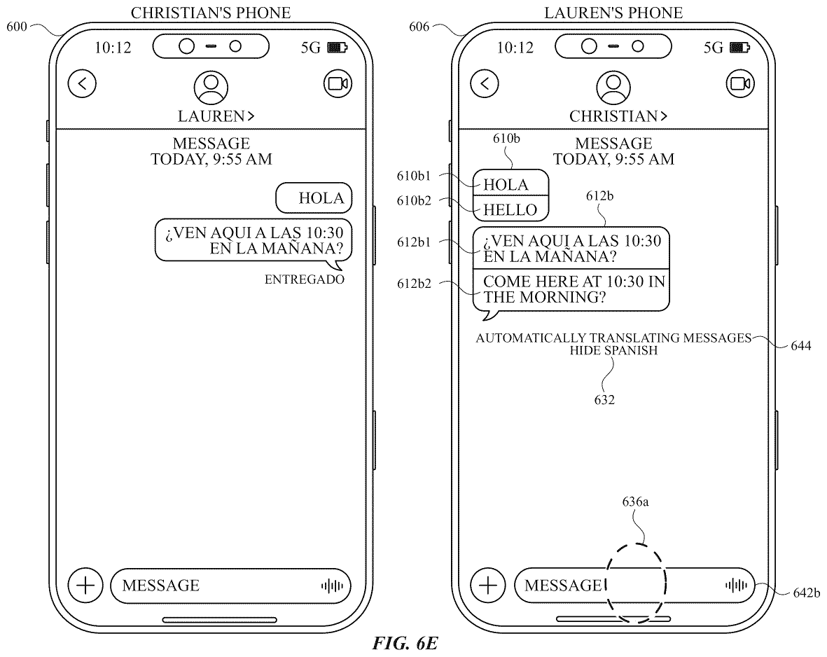

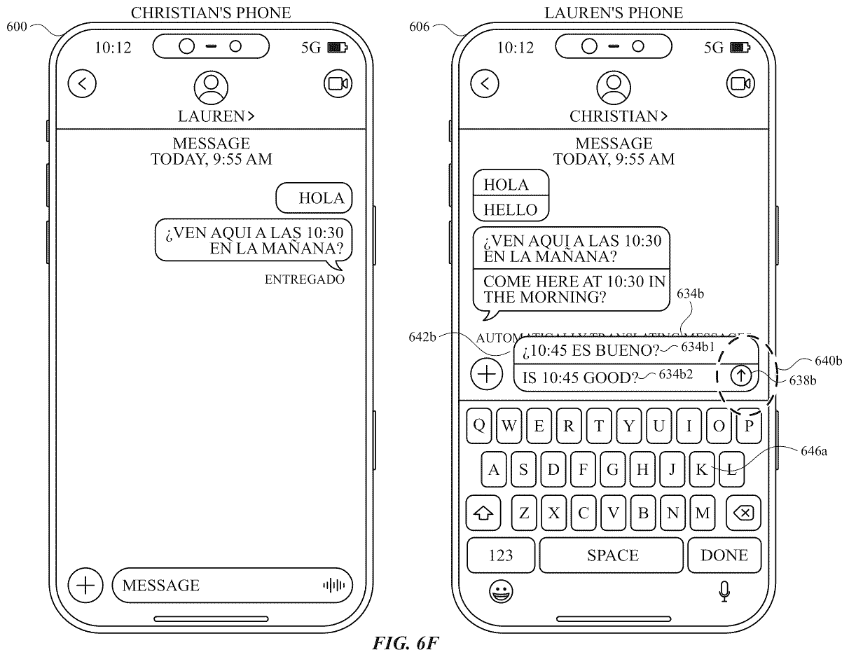

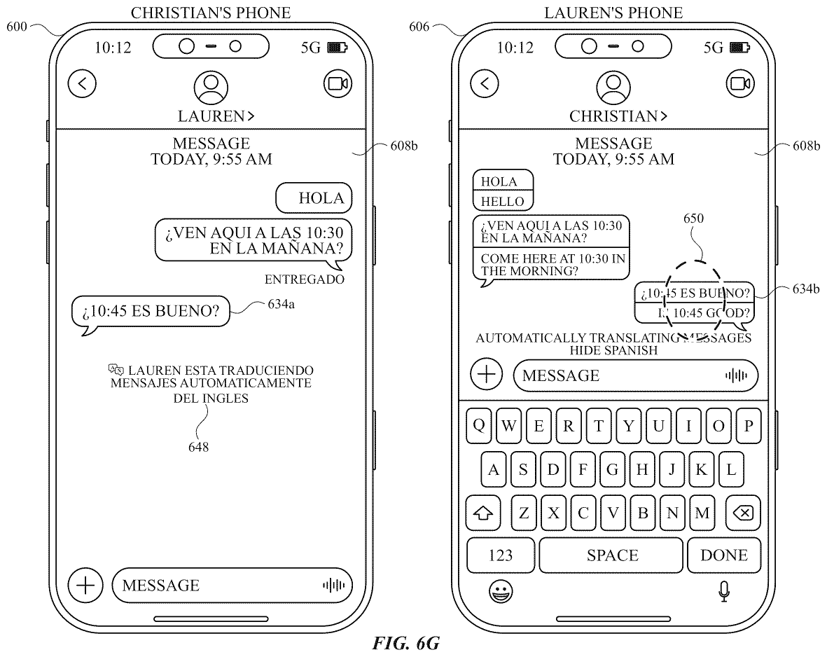

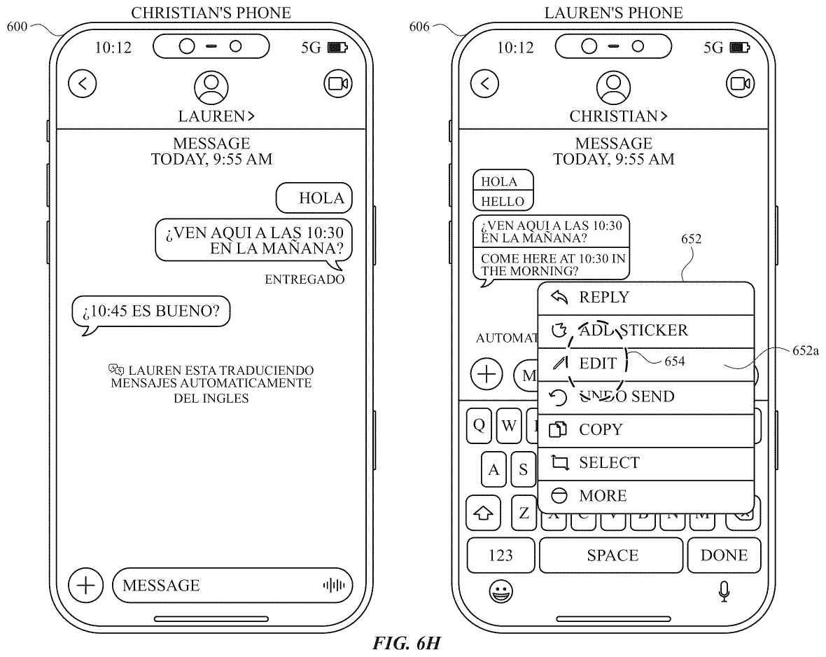

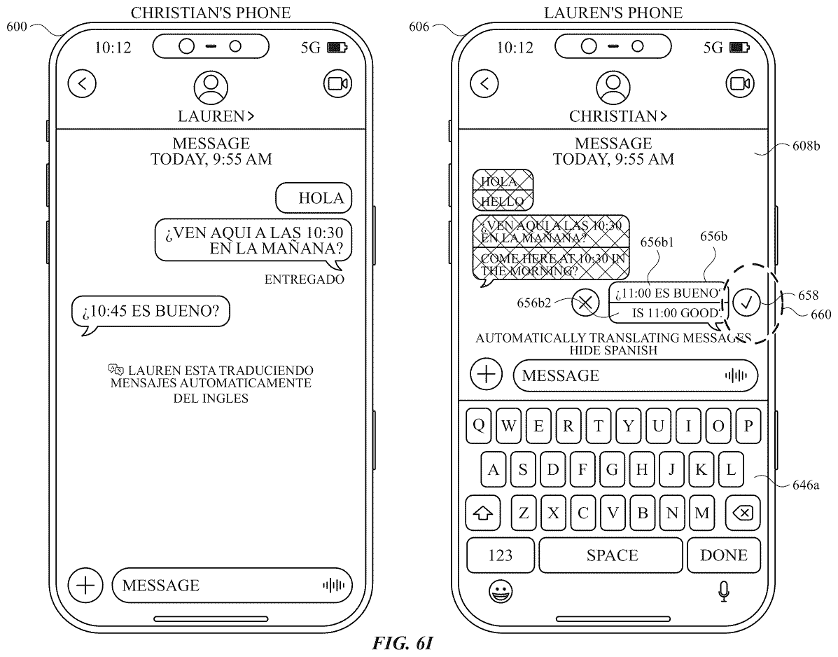

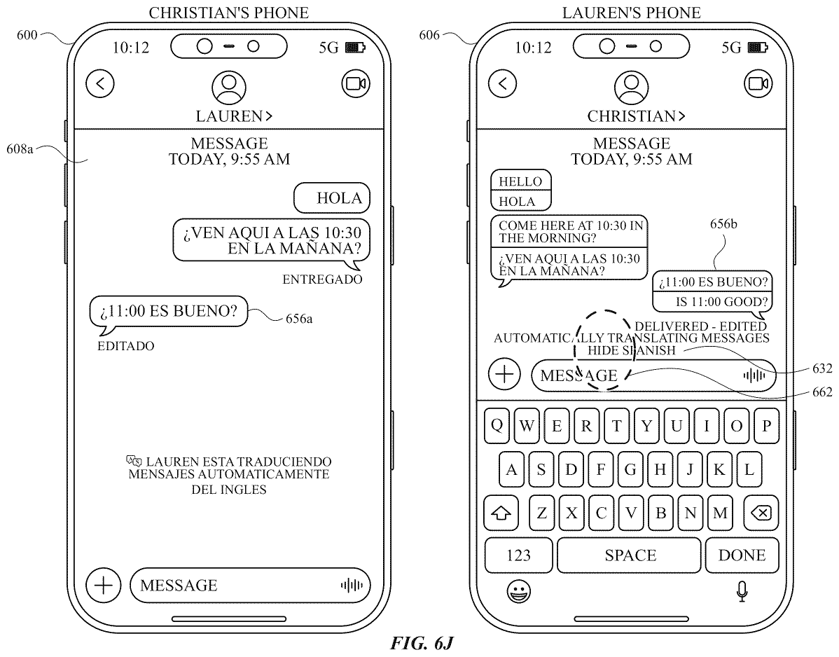

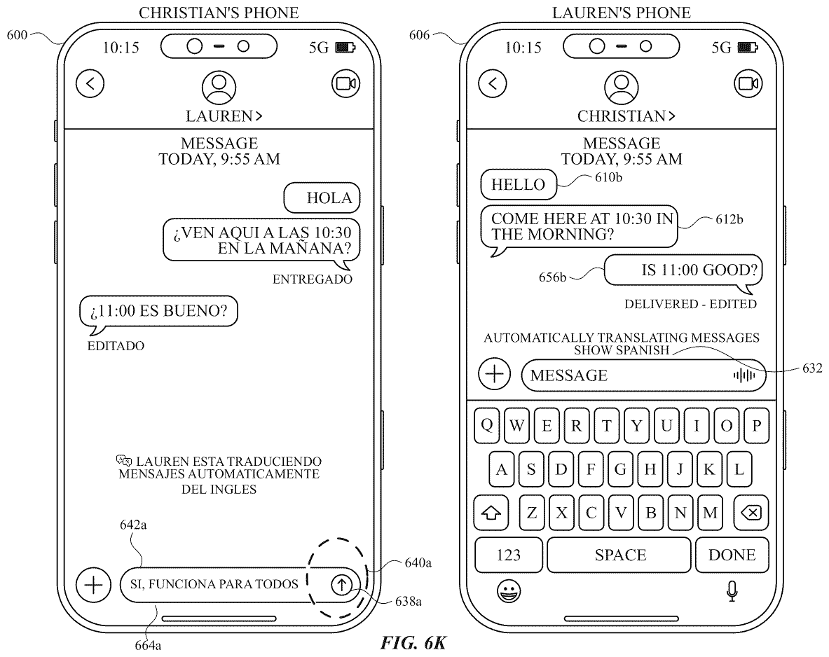

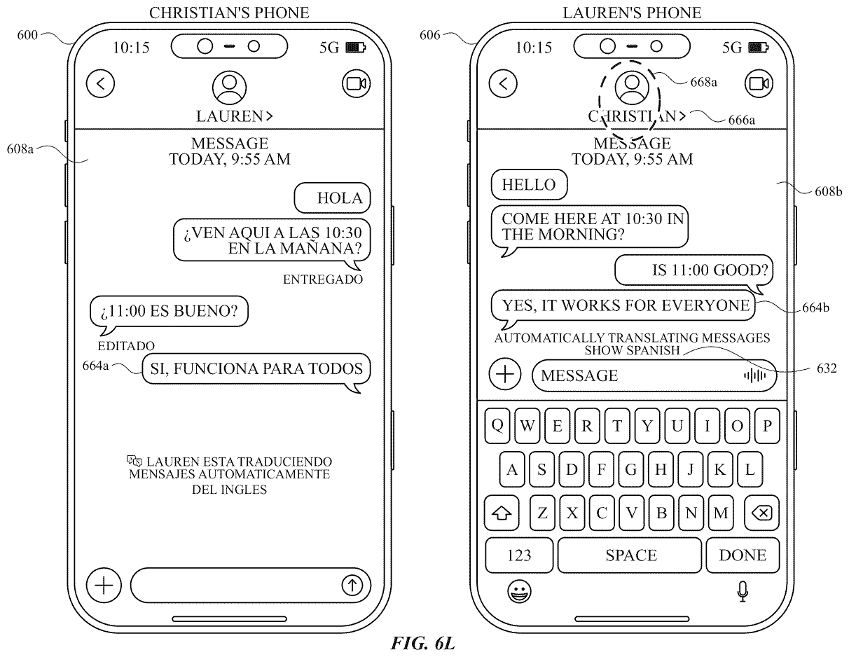

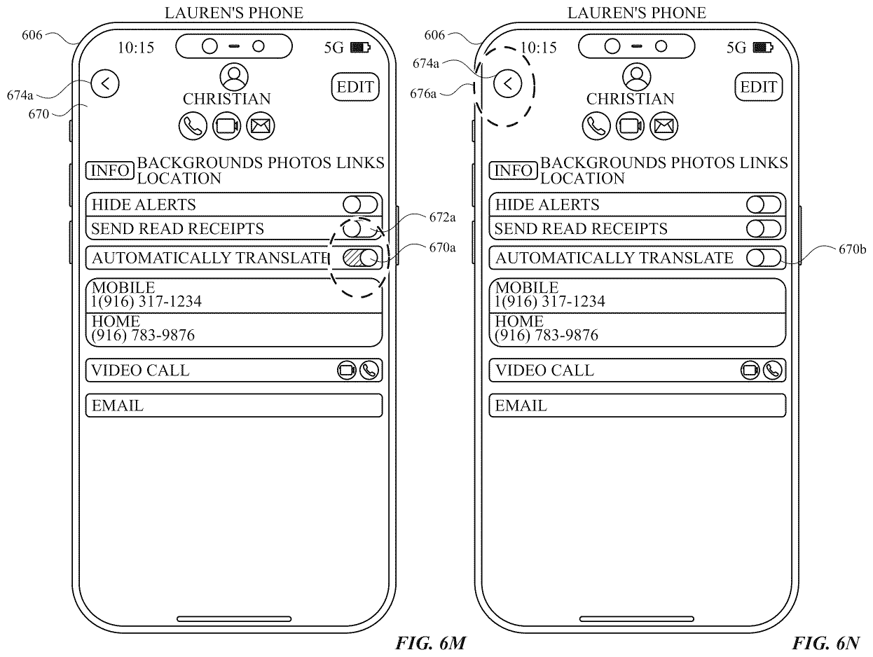

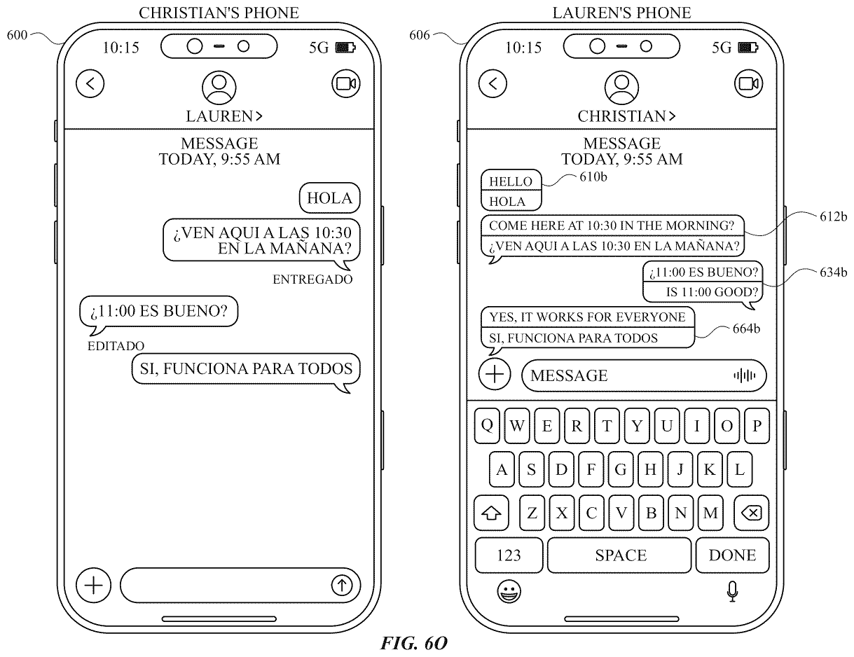

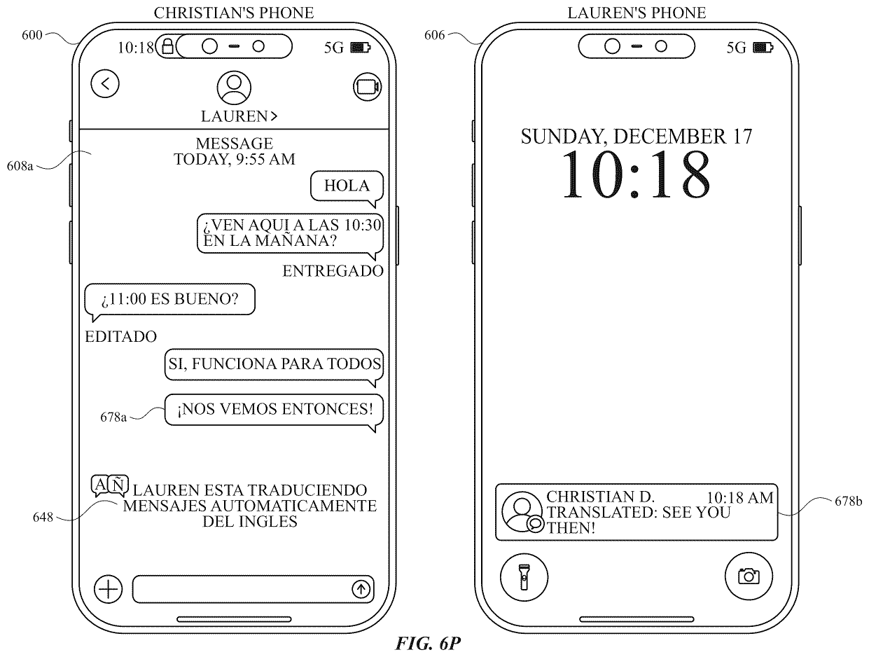

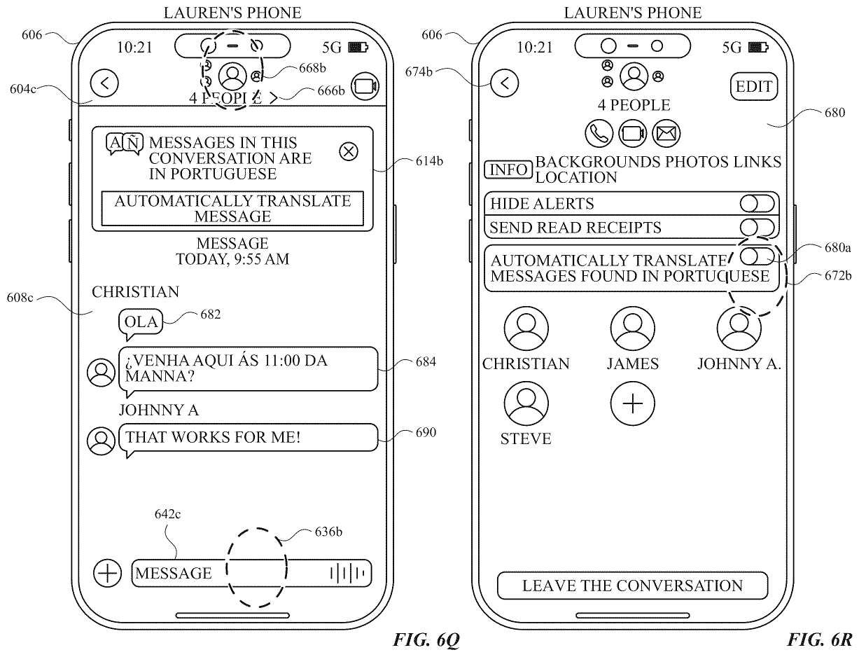

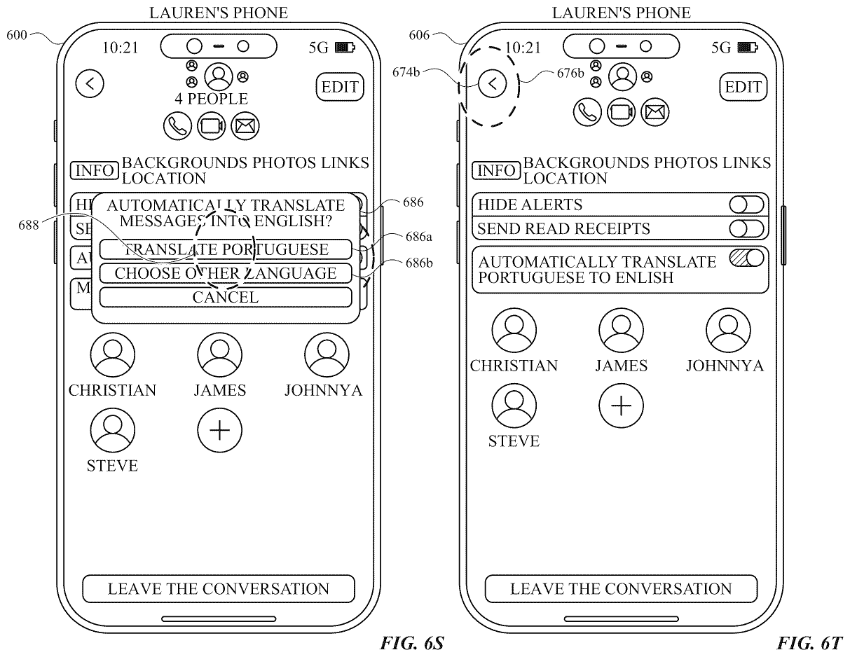

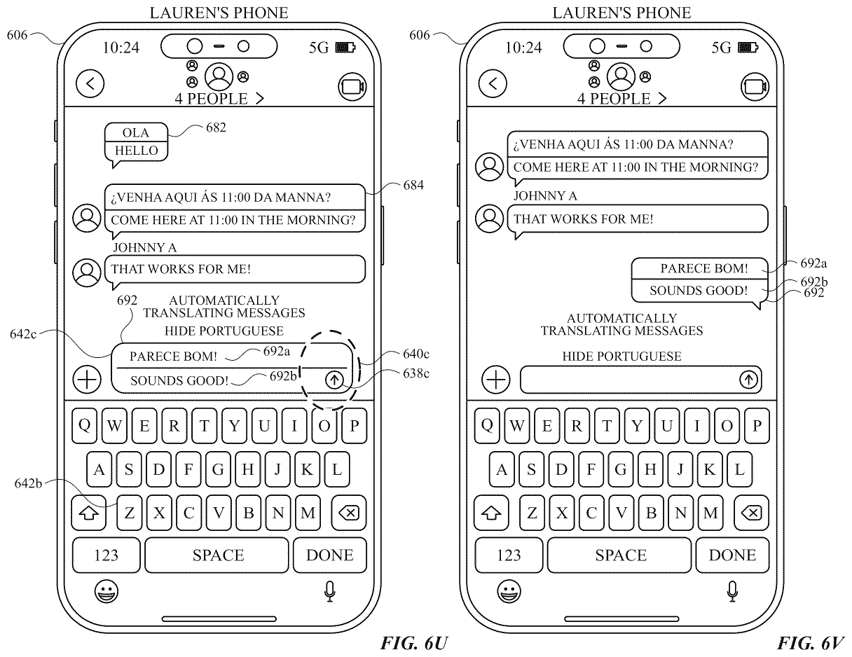

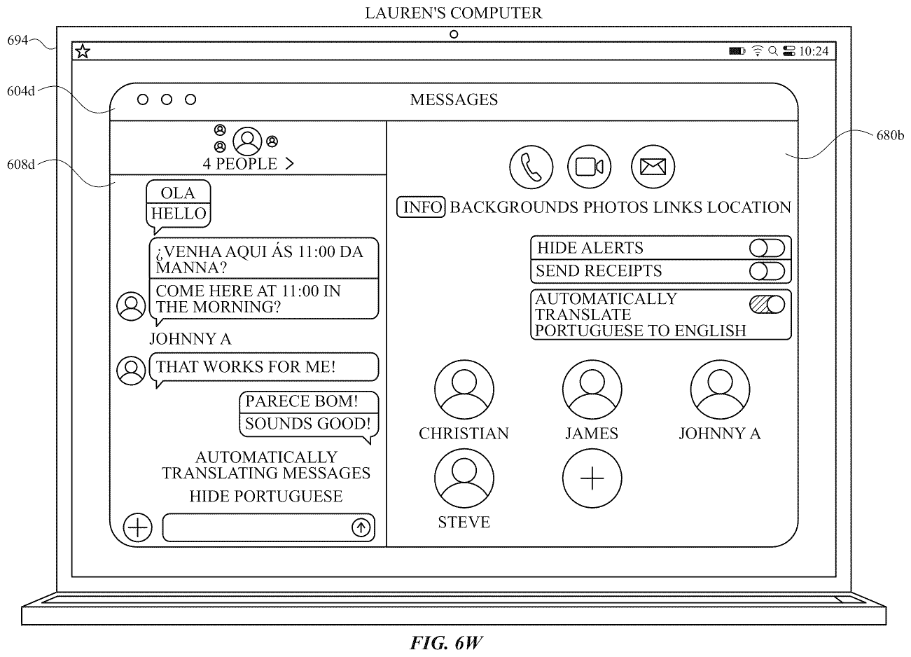

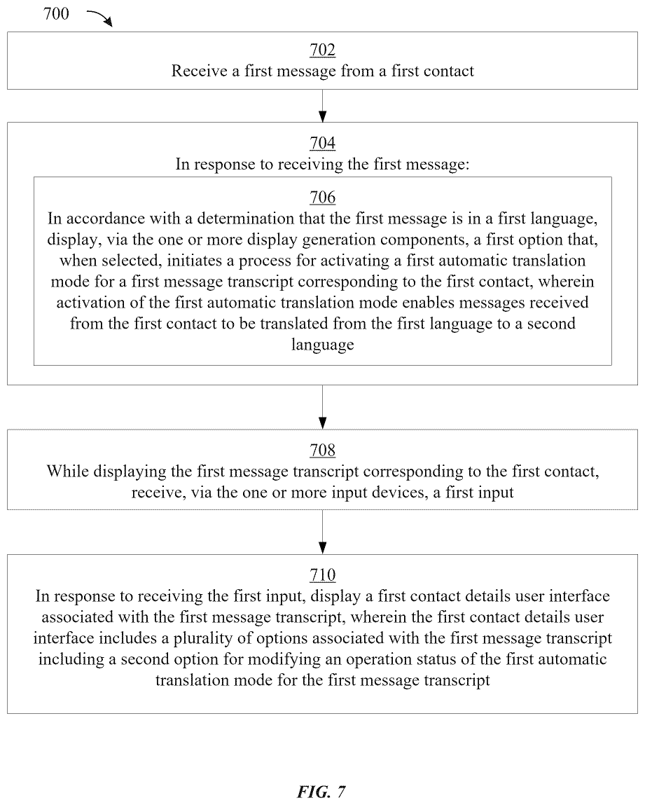

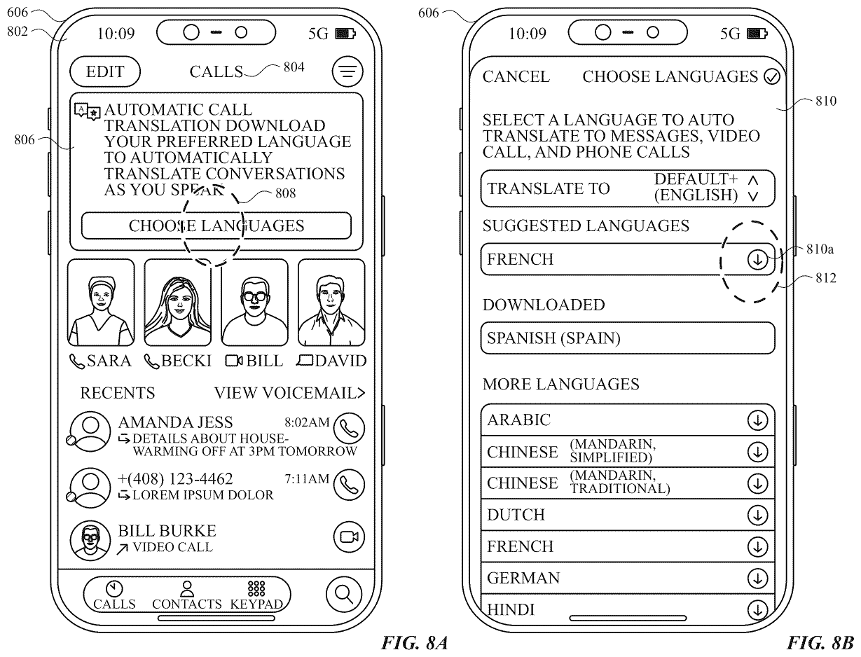

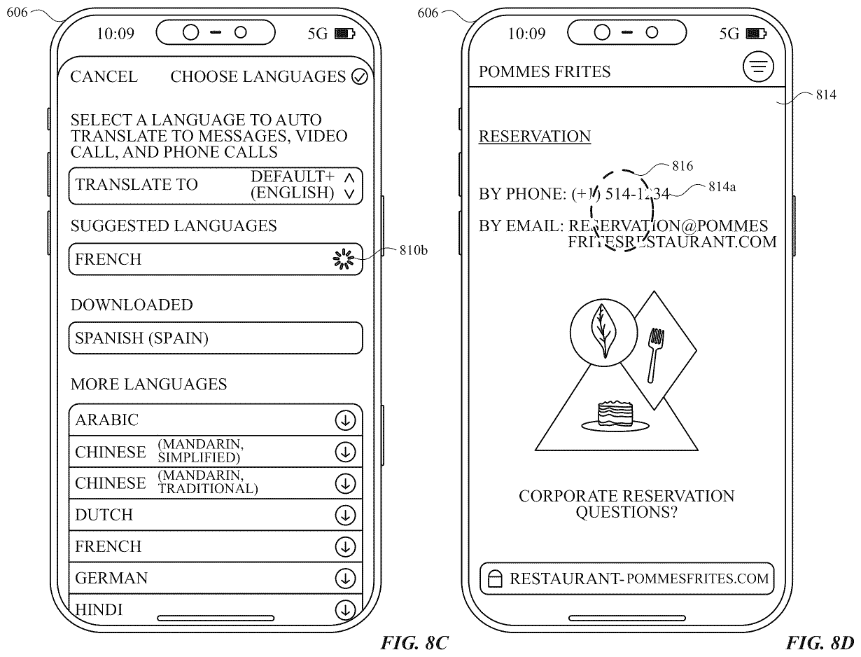

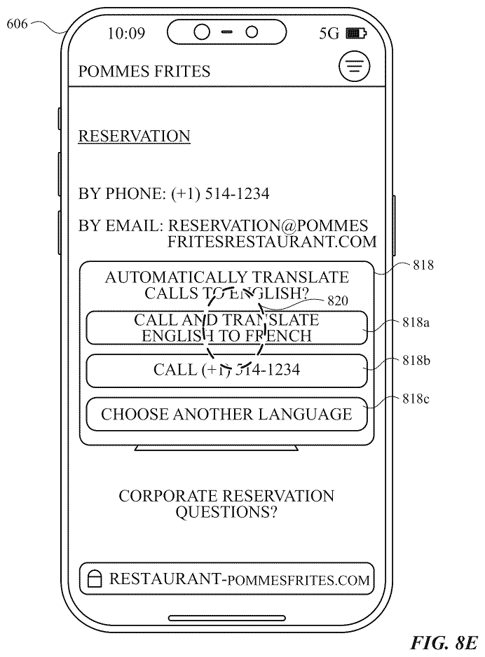

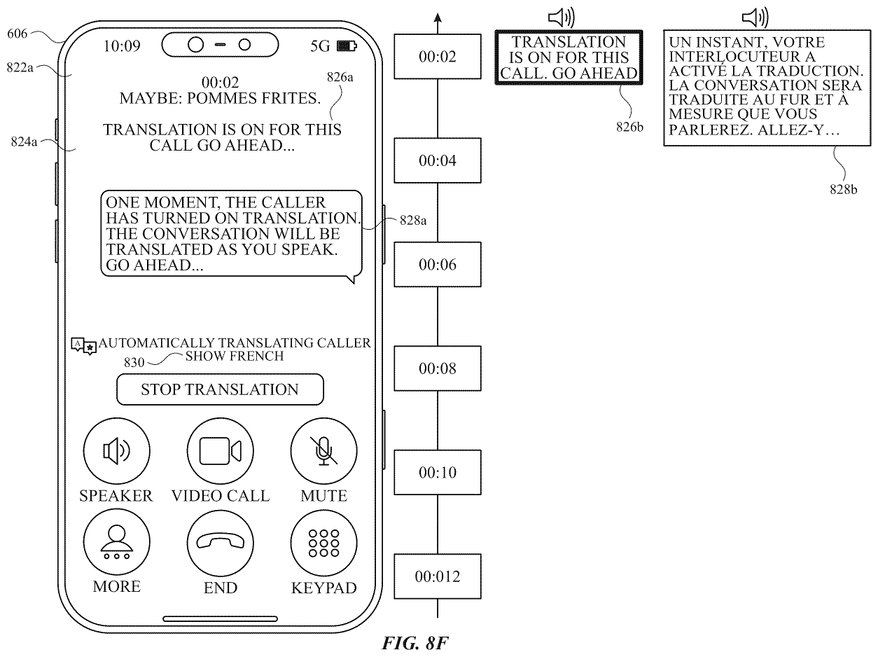

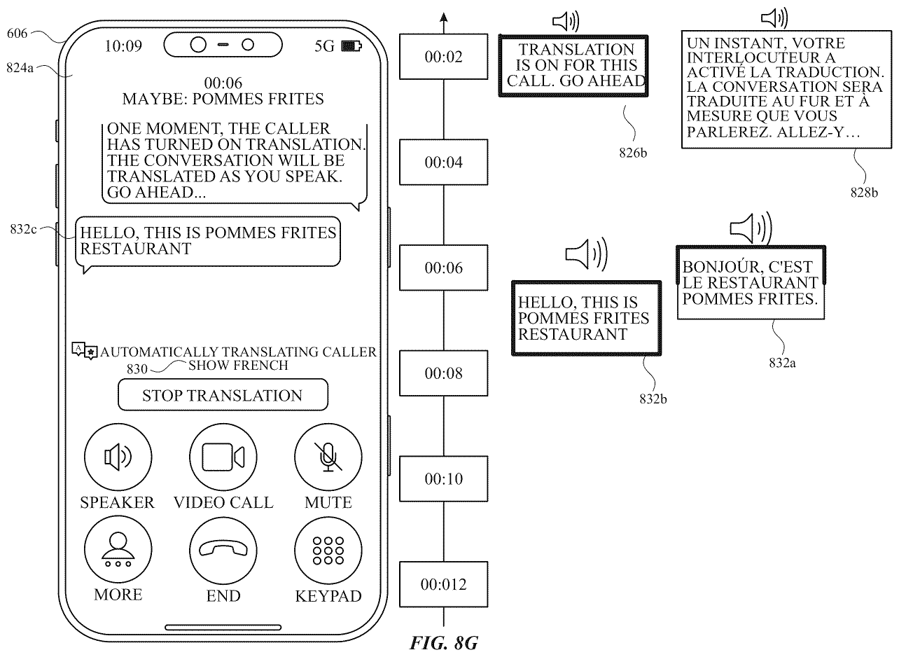

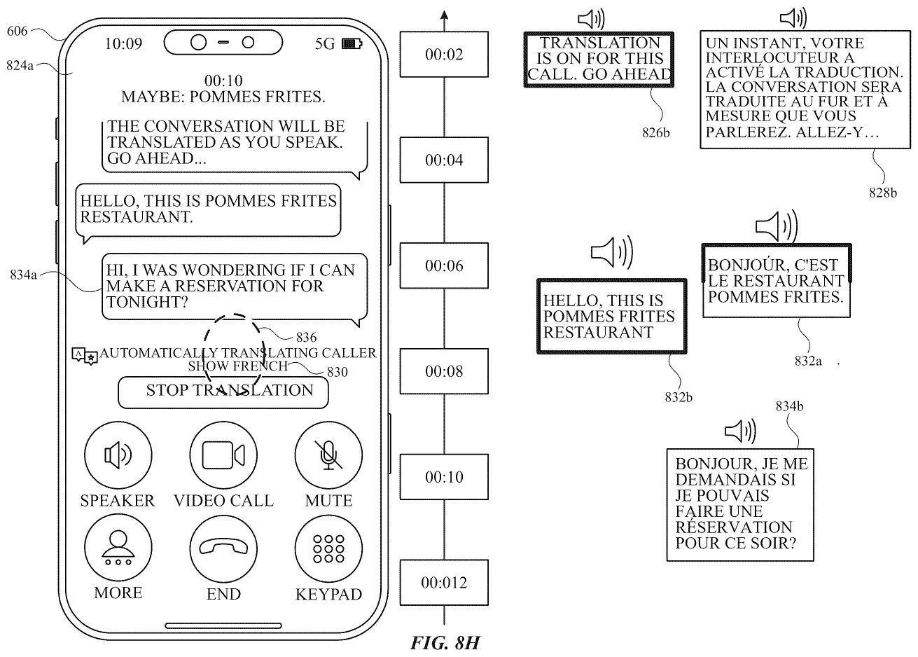

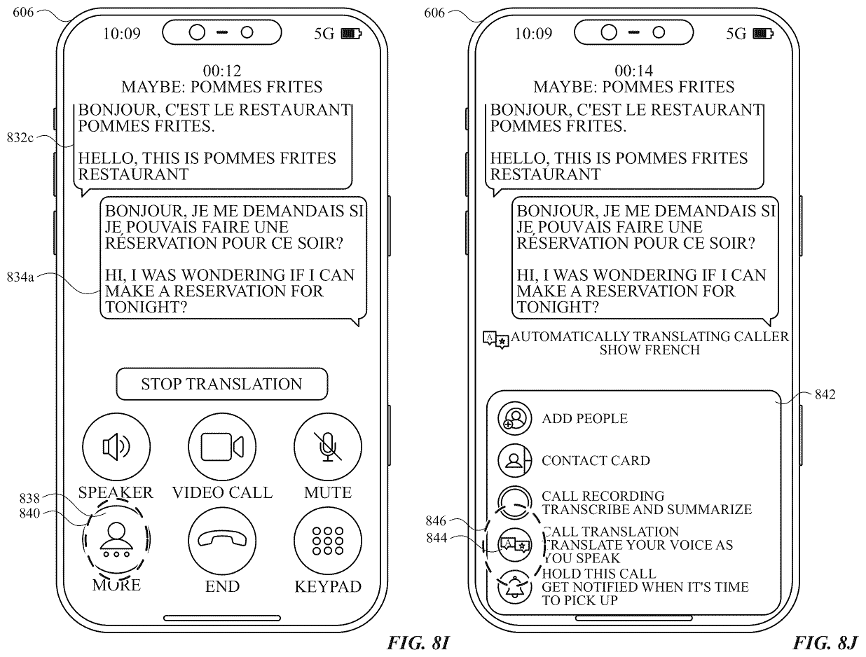

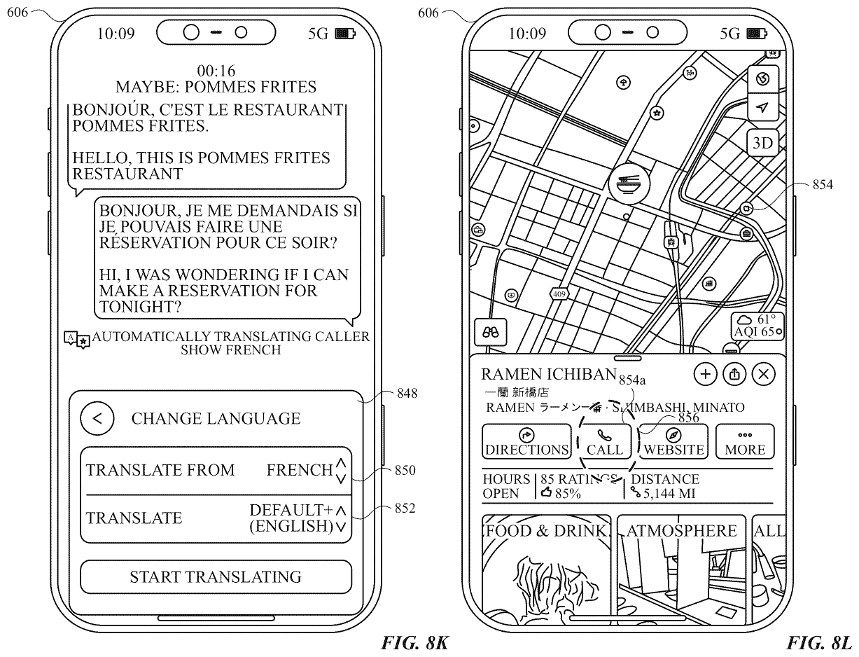

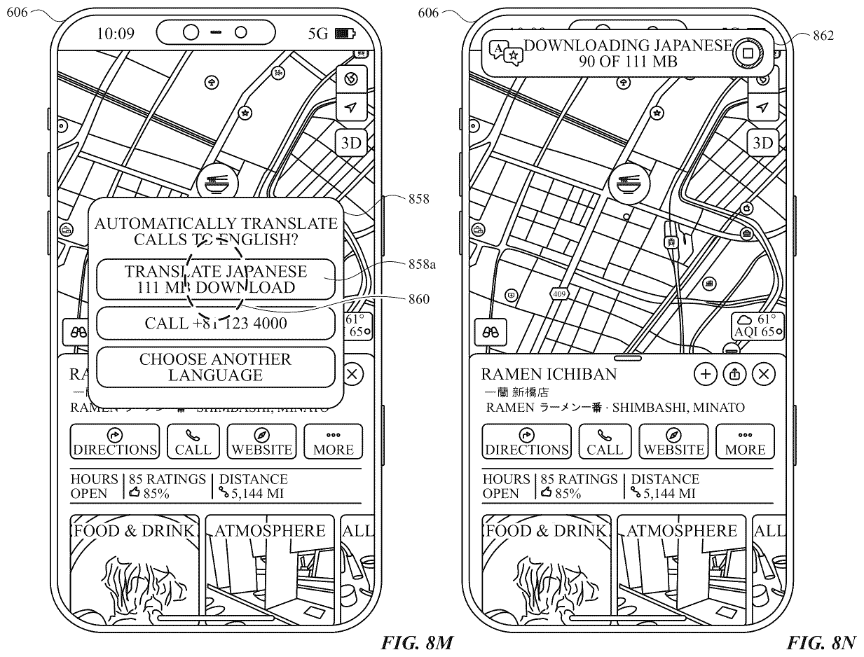

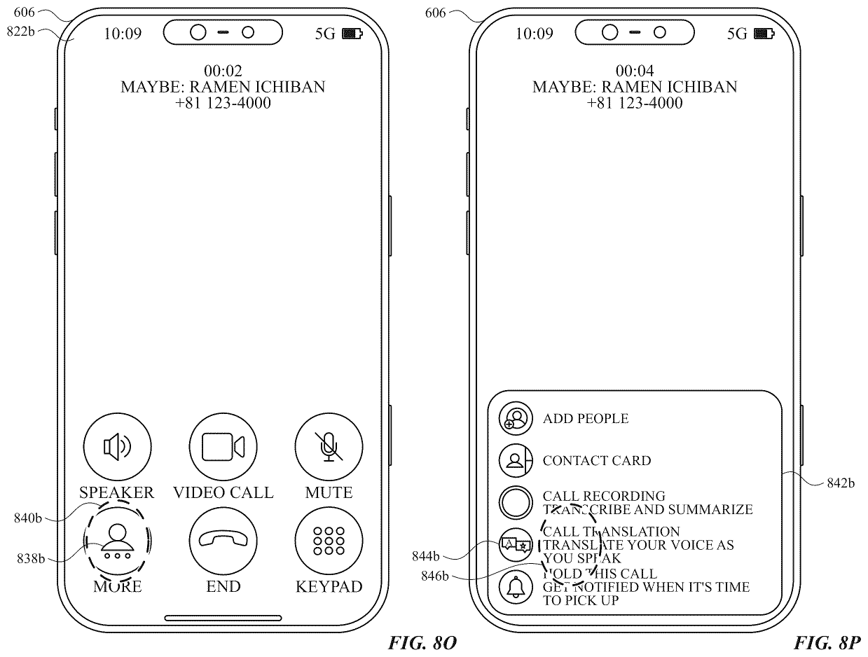

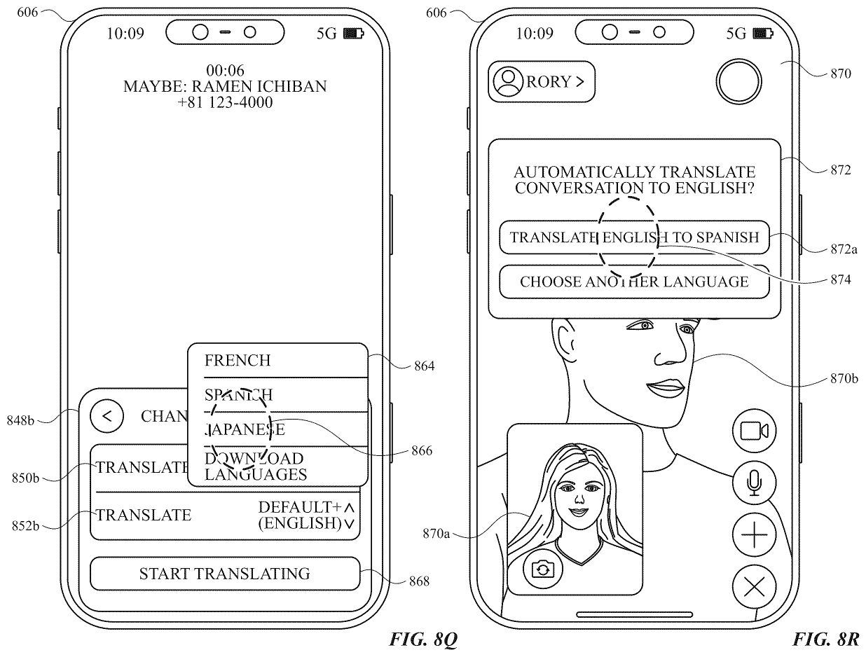

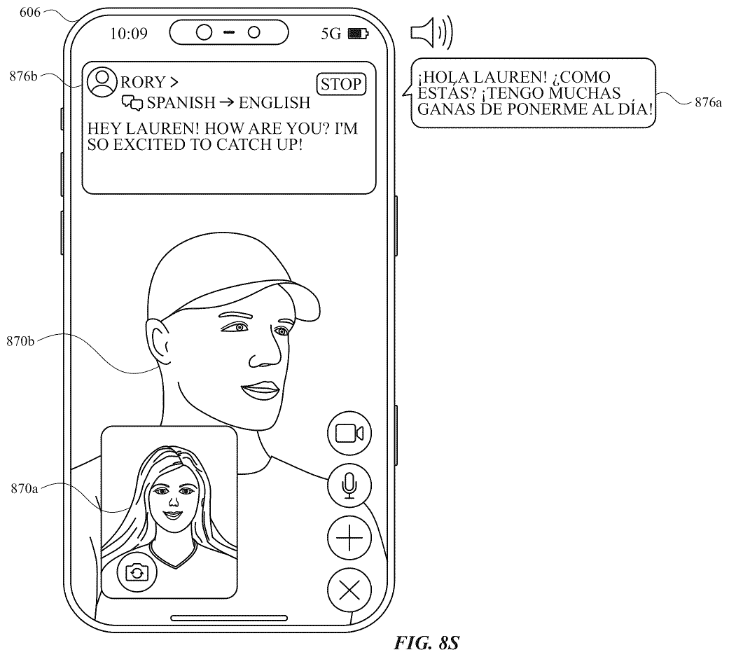

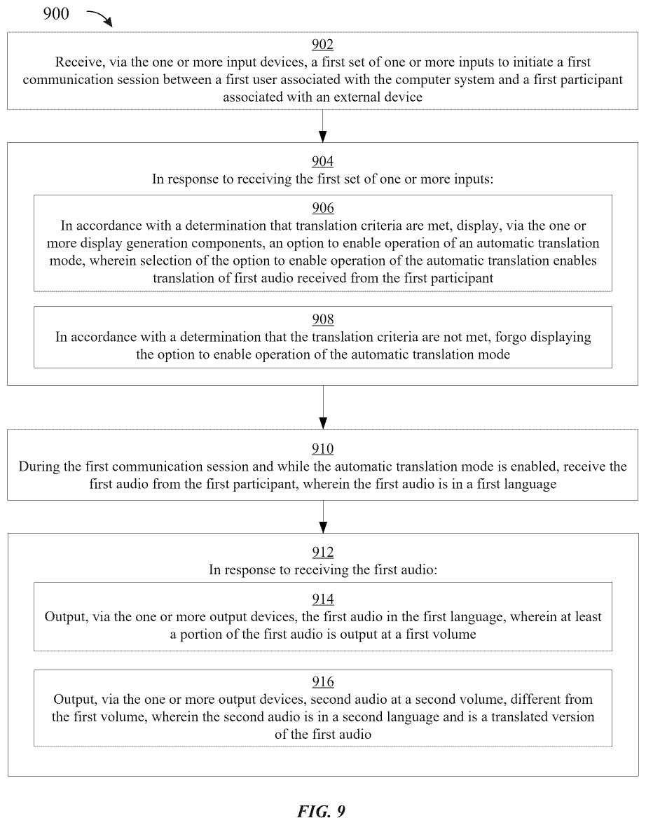

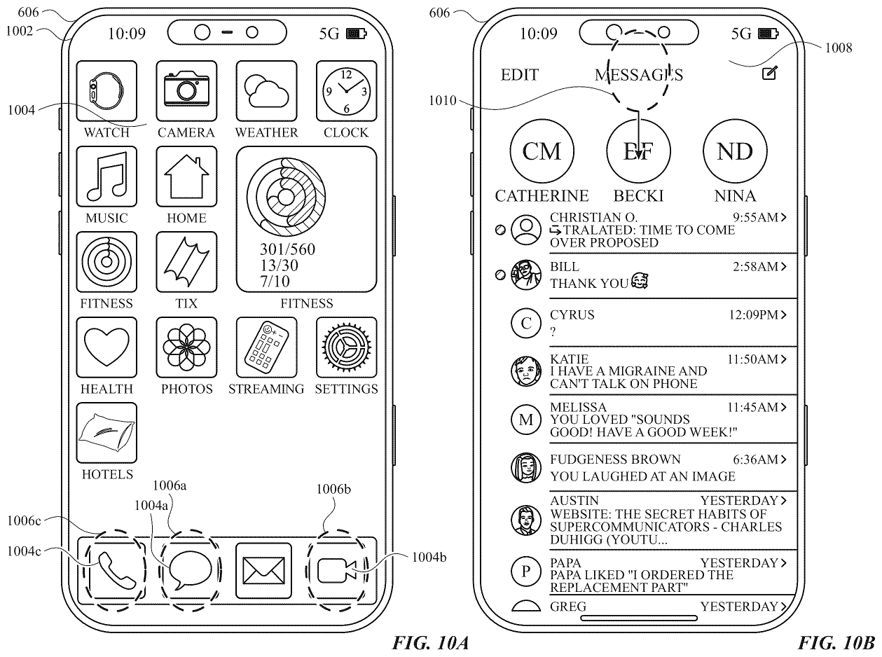

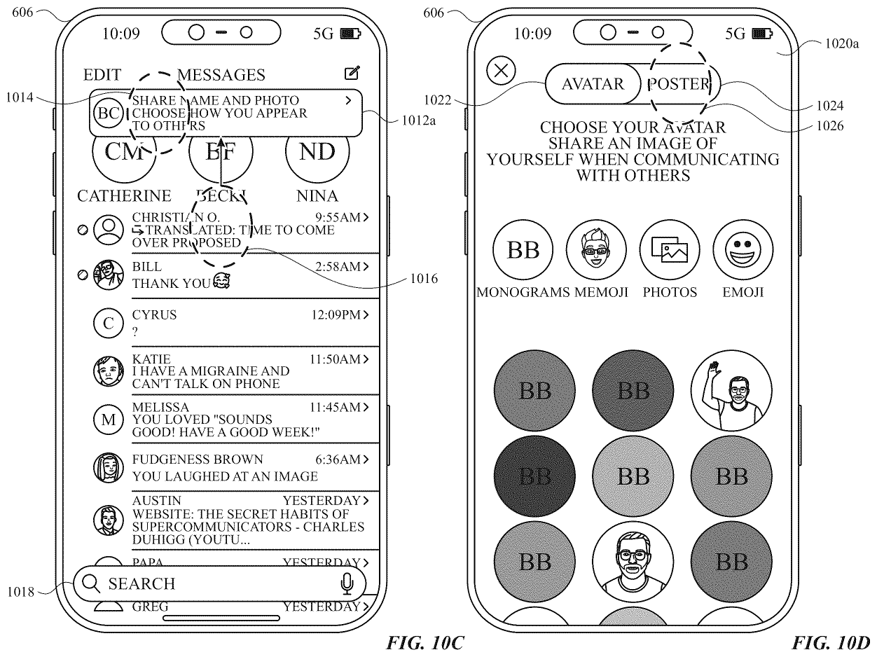

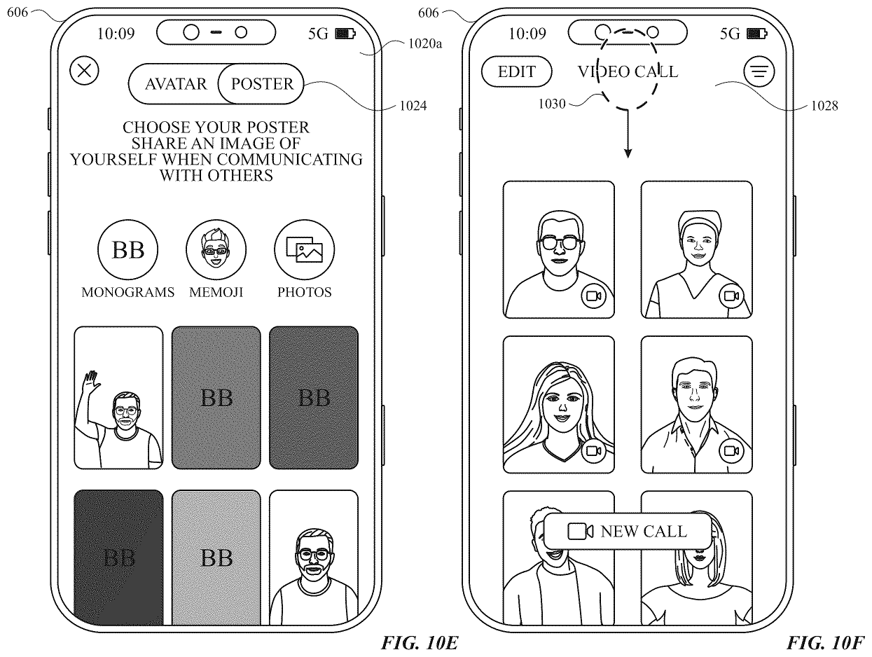

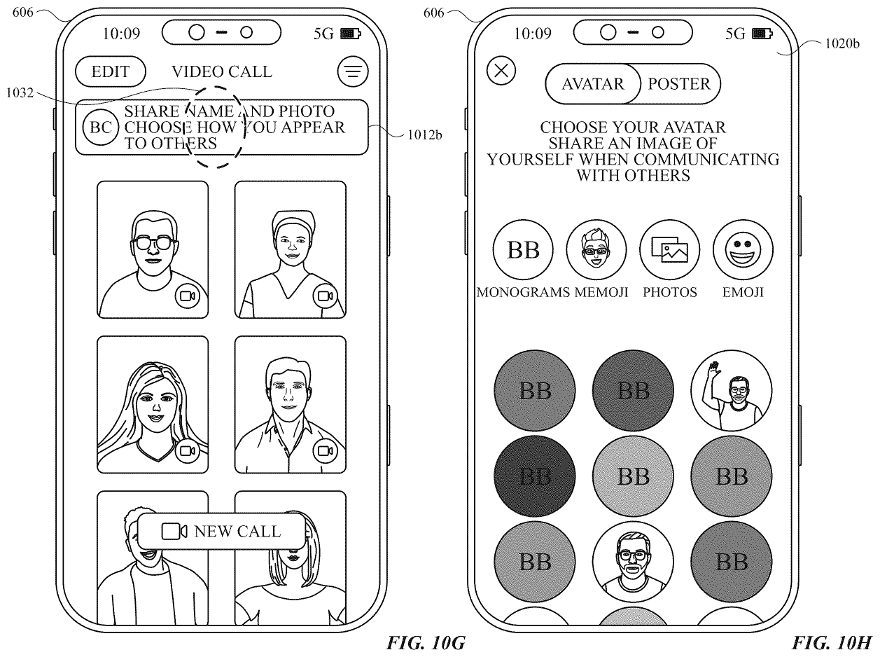

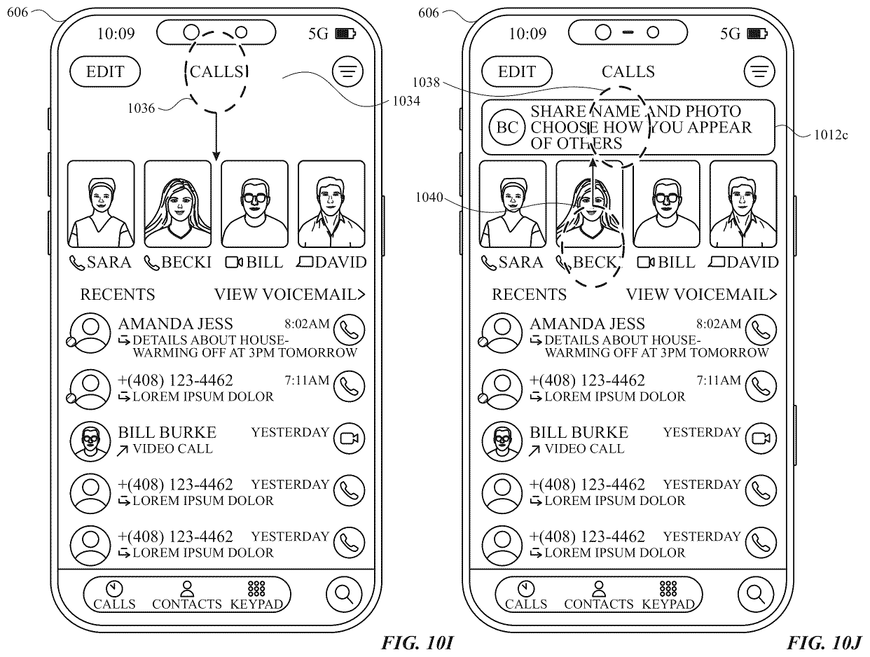

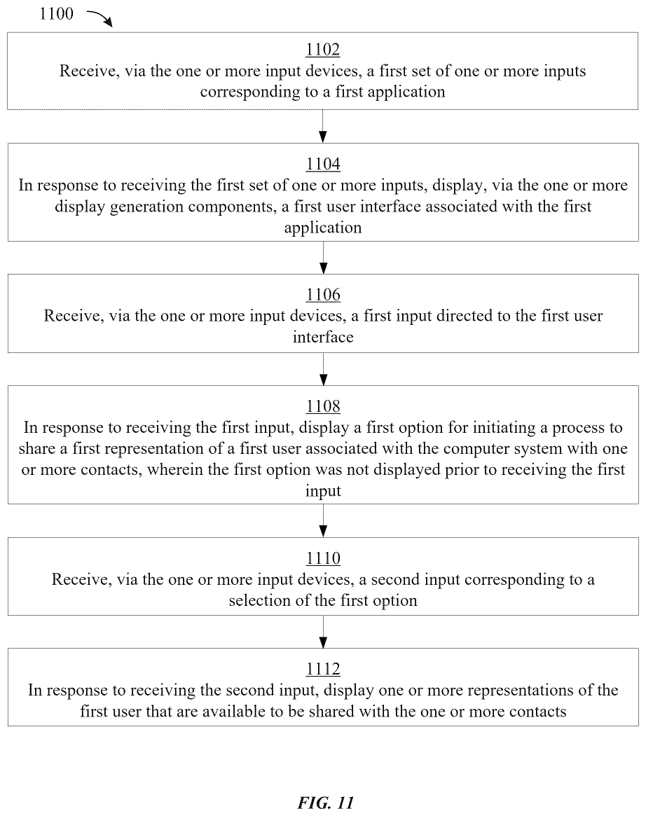

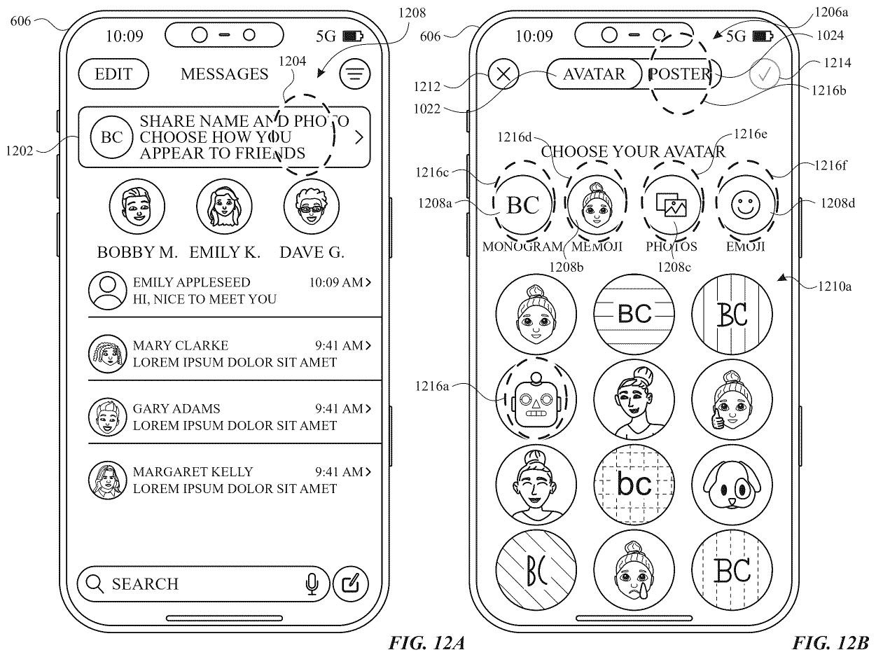

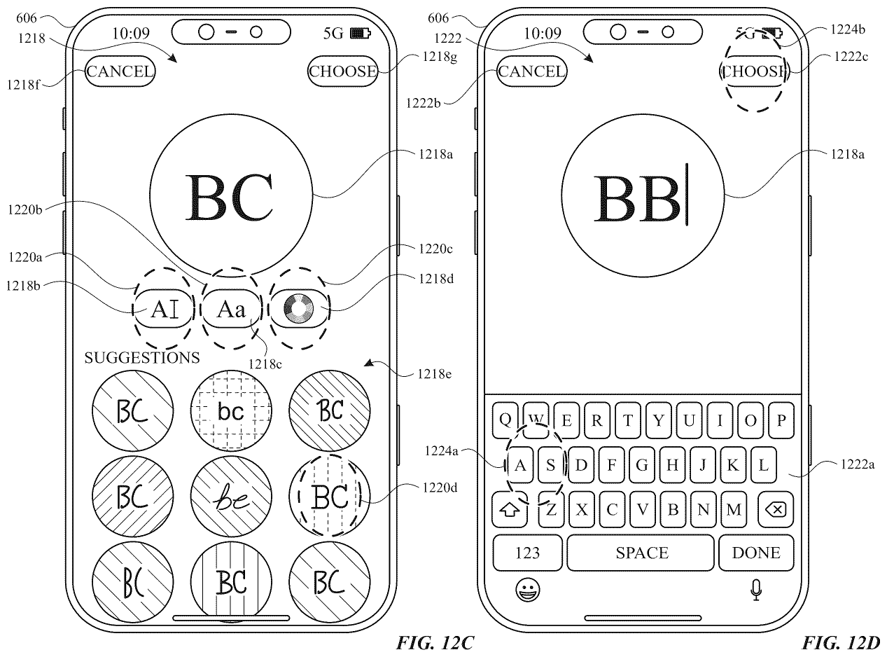

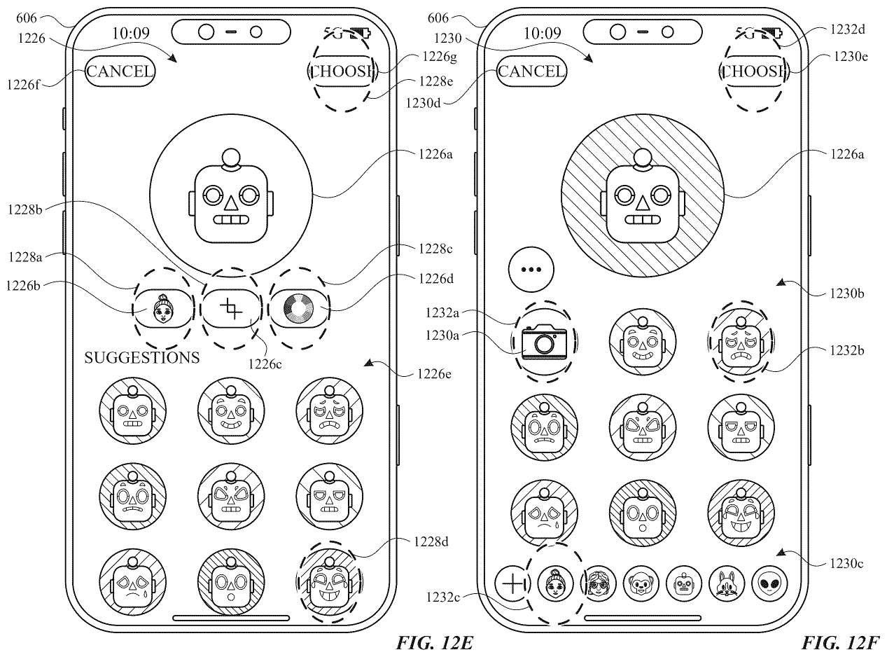

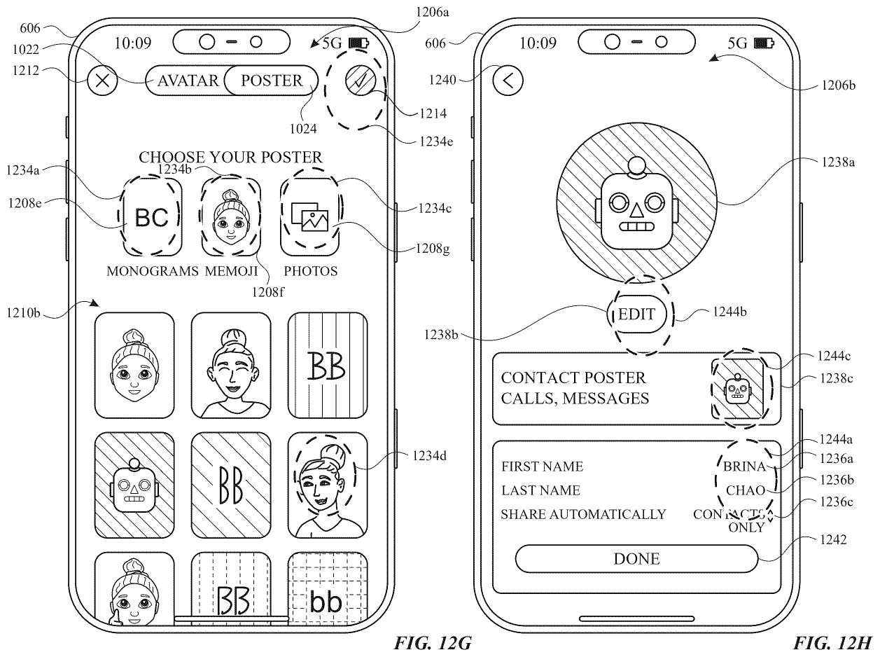

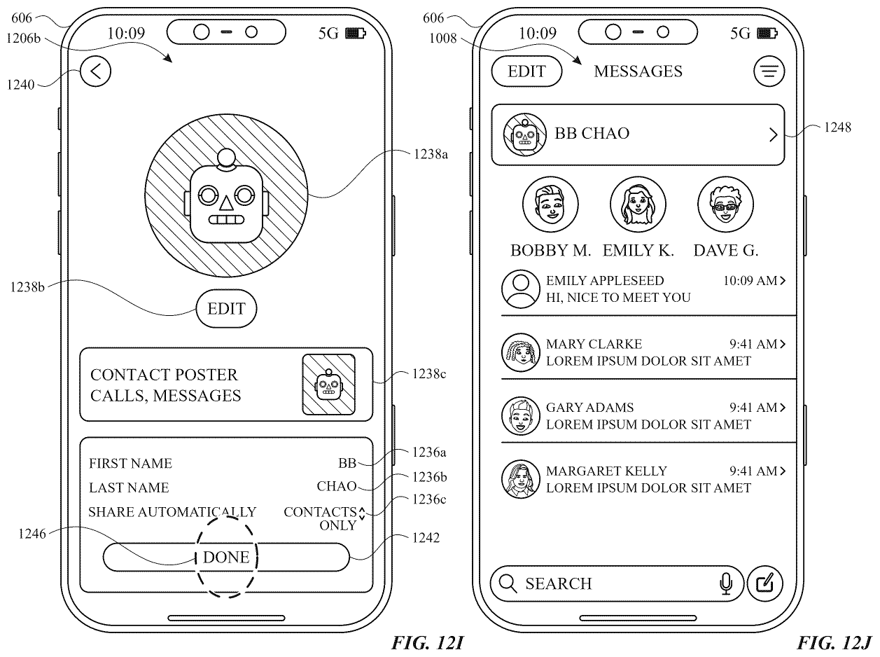

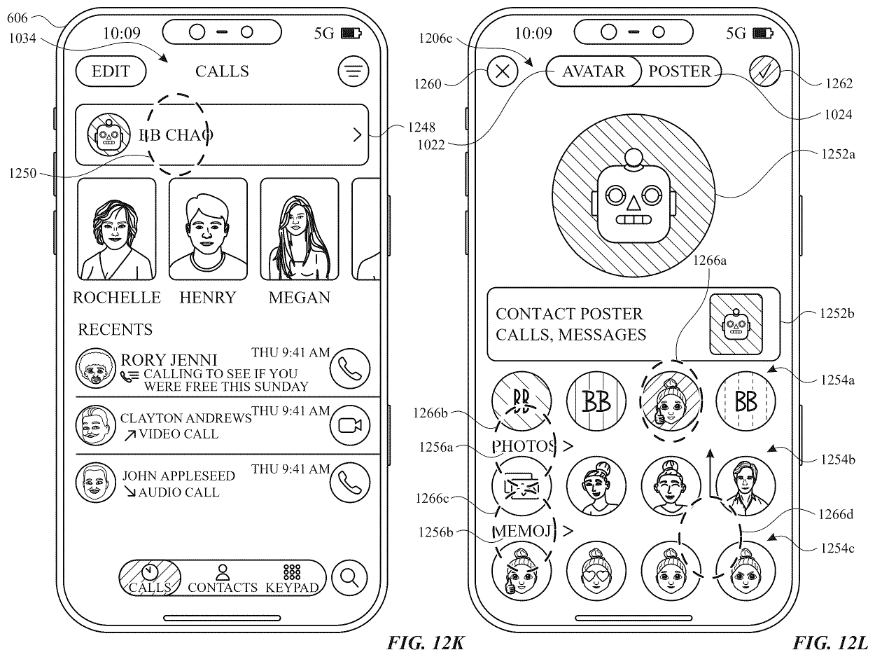

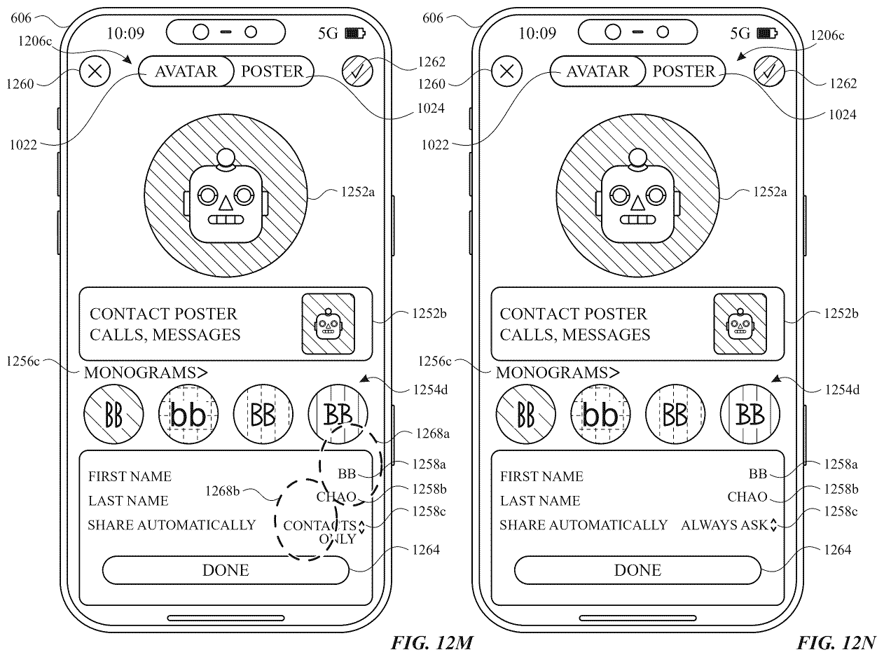

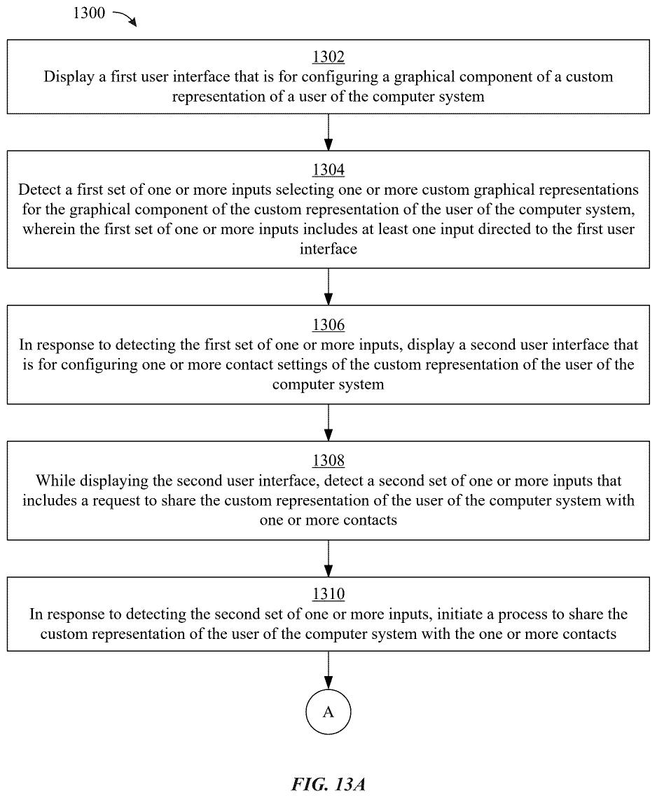

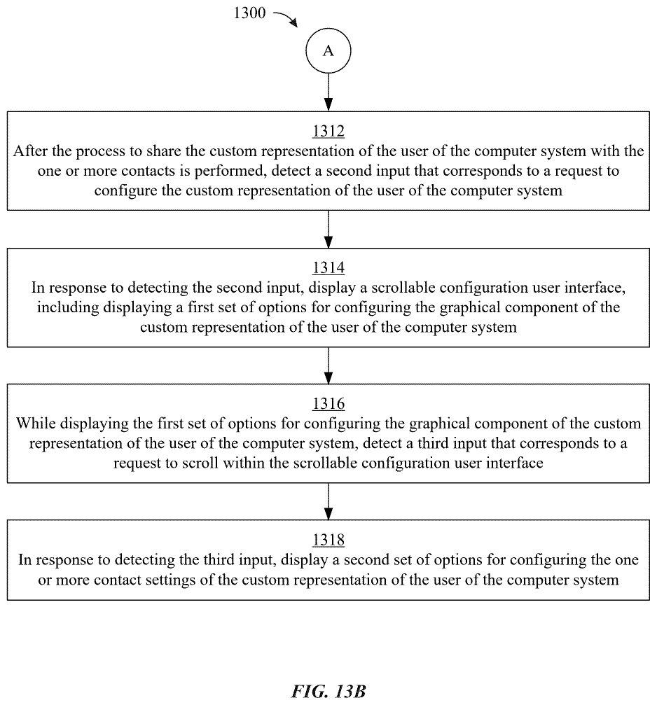

Below, FIGS. 1A-1B, 2, 3A-3G, 4A-4B, and 5A-5B provide a description of exemplary devices for performing the techniques for activating automatic translation modes and sharing representations with contactable users. FIGS. 6A-6W illustrate exemplary user interfaces for causing the display of an option to automatically translate messages for a message transcript. FIG. 7 is a flow diagram illustrating methods of method for causing the display of an option to automatically translate messages for a message transcript in accordance with some embodiments. The user interfaces in FIGS. 6A-6W are used to illustrate the processes described below, including the processes in FIG. 7. FIGS. 8A-8S illustrate exemplary user interfaces for automatically translating incoming and outgoing audio during a communication session. FIG. 9 is a flow diagram illustrating methods of automatically translating incoming and outgoing audio during a communication session in accordance with some embodiments. The user interfaces in FIGS. 8A-8S are used to illustrate the processes described below, including the processes in FIG. 9. FIGS. 10A-10J illustrate exemplary user interfaces for displaying an option for sharing a user representation with one or more contacts. FIG. 11 is a flow diagram illustrating methods of displaying an option for sharing a user representation with one or more contacts in accordance with some embodiments. The user interfaces in FIGS. 10A-10J are used to illustrate the processes described below, including the processes in FIG. 11. FIGS. 12A-12N illustrate exemplary user interfaces for configuring a custom user representation for sharing with one or more contacts in accordance with some embodiments. FIGS. 13A-13B are a flow diagram illustrating methods of configuring a custom user representation for sharing with one or more contacts in accordance with some embodiments. The user interfaces in FIGS. 12A-12N are used to illustrate the processes described below, including the processes in FIGS. 13A-13B.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

As used herein, the phrase “one or more of A and/or B” is construed to include all combinations of A and B, including, but not limited to: A individually without B; B individually without A, as well as a combination of A and B. The phrase “one or more of A, B, and/or C” is construed to include all combinations of A, B, and C, including, but not limited to: A individually without B and C; B individually without A and C; C individually without A and B; as well as any combinations of A, B, and/or C (e.g., A and B without C; A and C without B; B and C without A; and/or A, B, and C). Additionally, as used herein, the phrase “selected from the group consisting of A, B, C, and a combination thereof” and the phrase “at least one of A, B, and C” shall be construed to have the same meaning as the phrase “one or more of A, B, and/or C” as defined above. As used herein, the phrase “at least one of A, B, or C” and “one or more of A, B, or C” shall be construed to have the same meaning as the phrase “one or more of A, B, and/or C” as defined above. As used herein, the phrase “a combination including all of A, B, and C” is construed to include a combination of all the elements listed (e.g., a combination of A, B, and C).

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

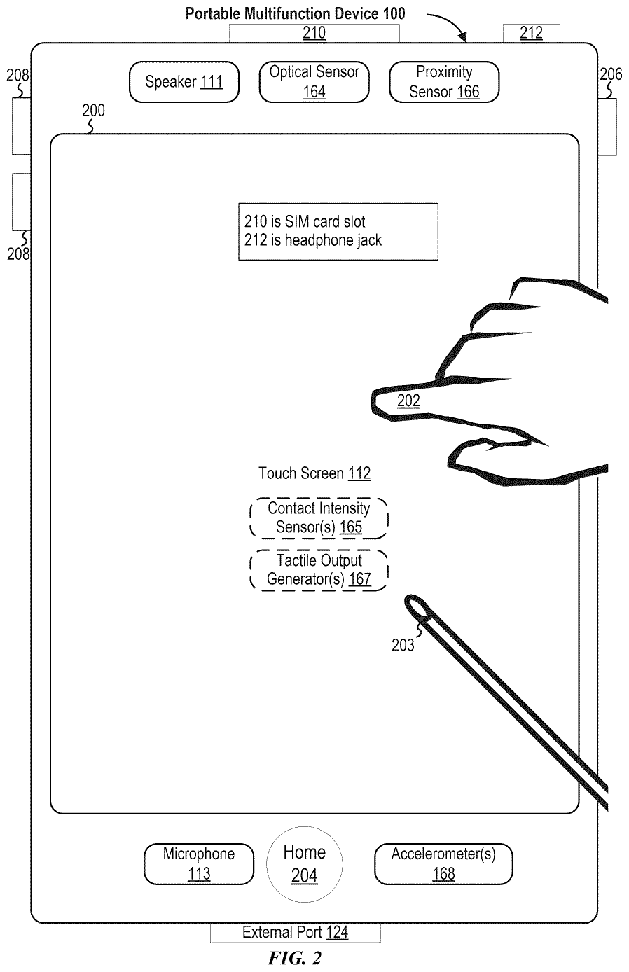

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

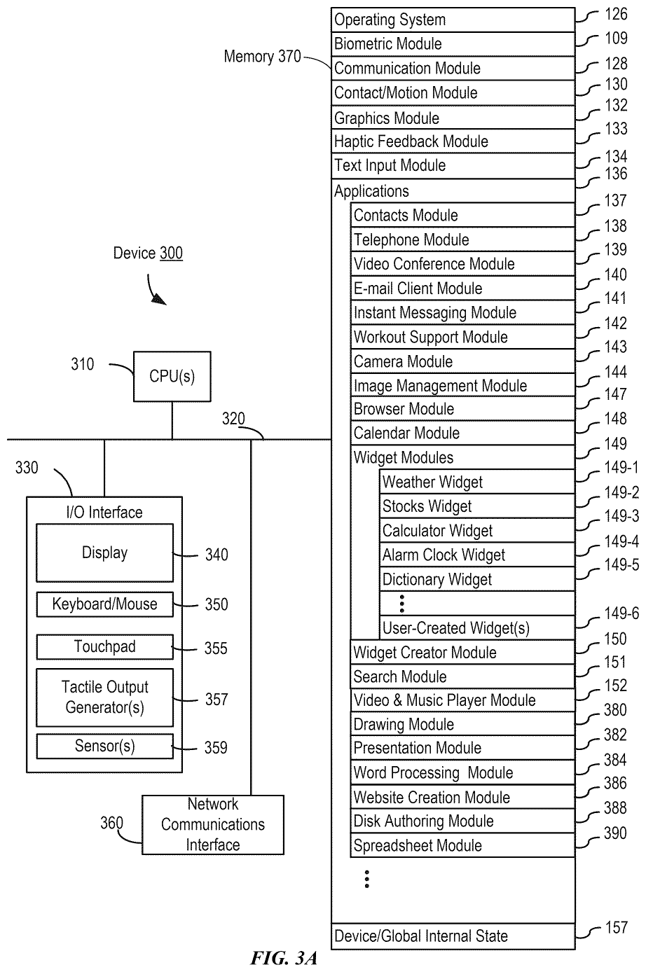

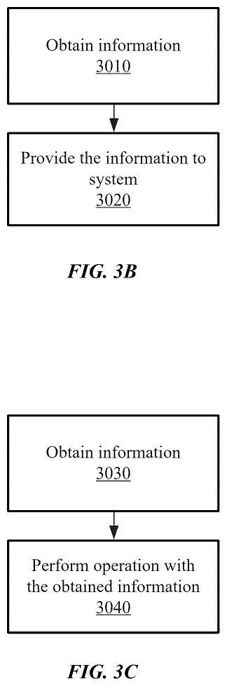

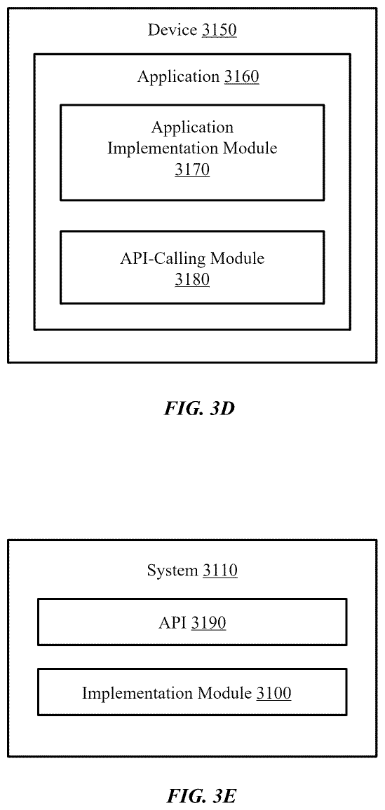

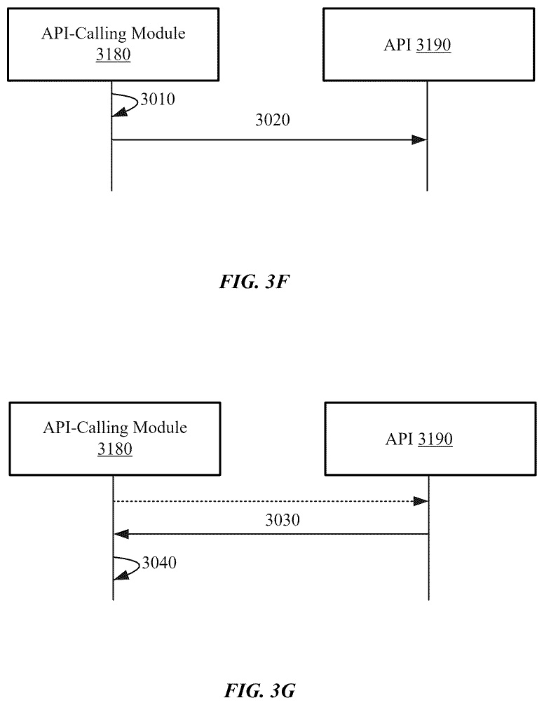

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search Module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700, 900, 1100, and 1300 (FIGS. 7, 9, 11, and 13A-13B) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

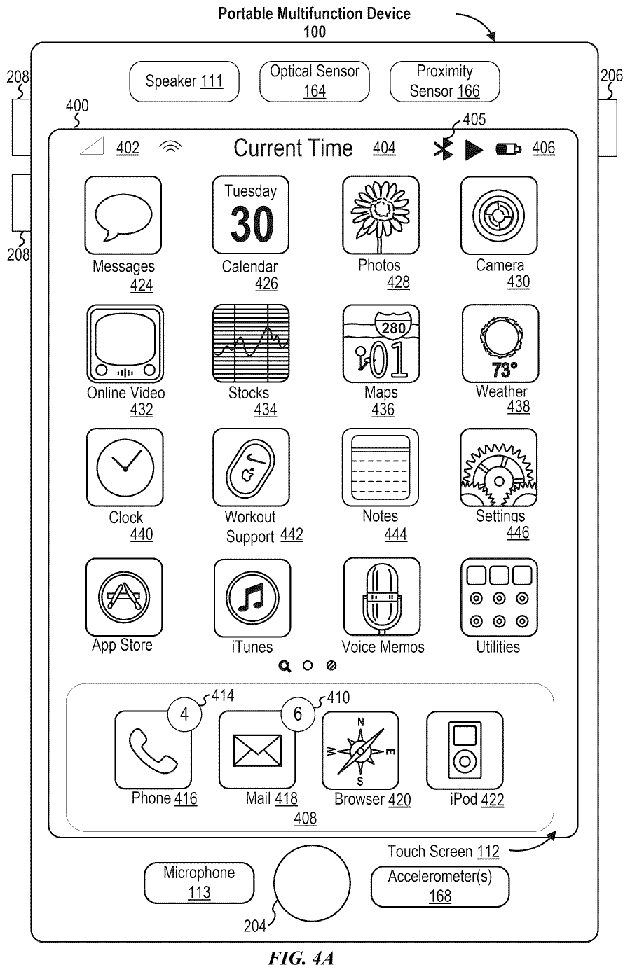

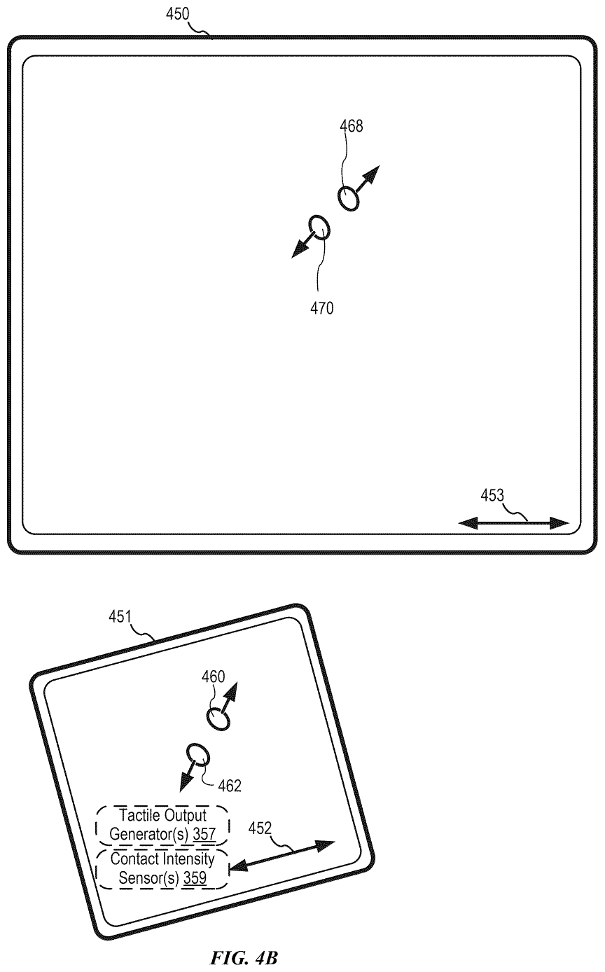

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery Status Indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

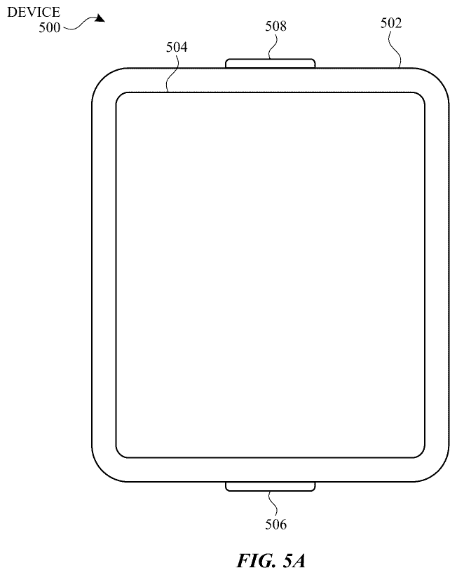

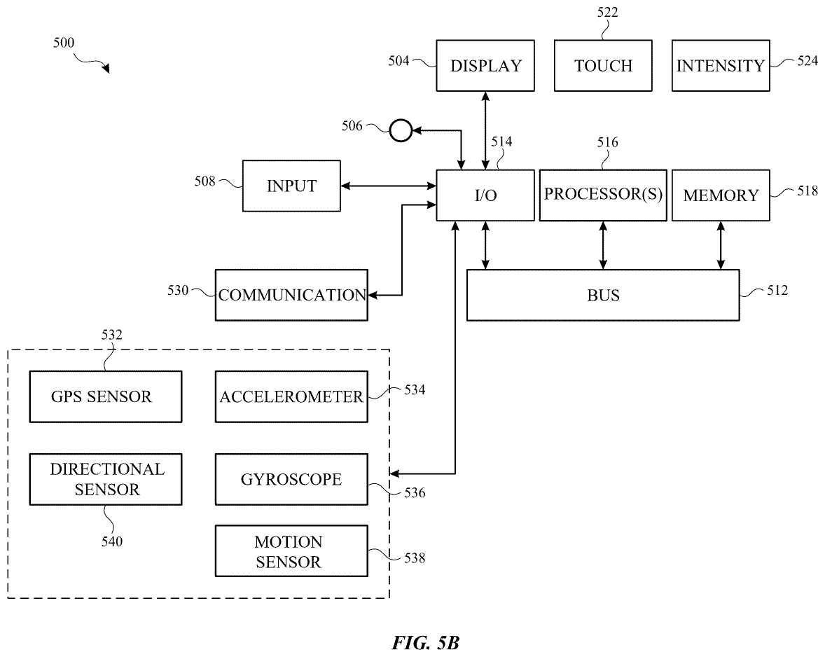

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including methods 700, 900, 1100, and 1300 (FIGS. 7, 9, 11, and 13A-13B). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6W illustrate exemplary methods for causing the display of an option to automatically translate messages for a message transcript associated with a respective contact in response to receiving a message in a foreign language, and while displaying a message transcript for a set of one or more contacts, receiving an input to display a contact details interface for the message transcript, which includes a plurality of settings associated with the current message transcript including an option to enable or disable an automatic translation mode for the current message transcript. The user interfaces in these figures are used to illustrate the processes described below, including the processes in FIG. 7.

FIGS. 6A-6P illustrate an exemplary method for automatically translating messages in a message transcript between user “Christian” and user “Lauren”.

FIG. 6A illustrates computer system 600 associated with user “Christian” and computer system 606 associated with user “Lauren,” in which computer system 600 and 606 are smart phones with respective touch-sensitive displays 602a and 602b. Although the depicted embodiments show an example in which computer systems 600 and 606 are smart phones, in other embodiments, computer systems 600 and 606 are different types of computer systems (e.g., tablets, laptop computers, desktop computers, wearable devices, and/or headsets). In some embodiments, computer system 600 and/or computer system 606 include one or more features of device 100, 300, and/or 500.

At FIG. 6A, computer system 600 displays messaging user interface 604a and computer system 606 displays messaging interface 604b. Messaging user interfaces 604a and 604b are used to receive and transmit messages (e.g., text messages, audio messages, linked messages, photos, and/or videos) in a messaging session between a user of computer system 600 (e.g., Christian) and a user of the computer system 606 (e.g., Lauren), respectively. Messaging user interface 604a includes message region 608a, which displays message 610a (e.g. “Hola”) and message 612a (e.g., “¿ Ven aquí a las 10:30 en la mañana?”), which are messages in Spanish that were transmitted from computer system 600 into the messaging session by the Christian. In some embodiments, messages (e.g., 610a and 612a) sent from a respective computer system are displayed on the right side of message region 608a to indicate that these are messages sent from a computer system (e.g., computer system 600). Messaging user interface 604b includes the messages region 608b, which displays message 610b (e.g., “Hola”) and message 612b (e.g., “¿ Ven aquí a las 10:30 en la mañana?”) that have been received by computer system 606. Messaging user interface 604b also includes automatic translation option 614a and contact header 666a (e.g., “Christian”). In some embodiments, messages (e.g., 610b and 612b) are displayed on the left side of message region 608b to indicate that these are messages received by a computer system (e.g., computer system 606). In some embodiments, automatic translation option 614a is displayed in response to computer system 606 receiving a message (e.g., message 610b and/or message 612b) in a foreign language (e.g., Spanish) that is different from the primary language of computer system 606 (e.g., English). At FIG. 6A, computer system 606 detects user input 616 (e.g., a tap input) directed towards automatic translation prompt 614a. In some embodiments, user input 616, and other user inputs described in FIGS. 6A-6W, can be a touch input (e.g., a tap input, long press input, and/or a swipe input), an air gesture, and/or a gaze-based input.

At FIG. 6B, in response to user input 616, computer system 606 displays automatic translation menu 618 that includes a variety of selectable options including language option 618a, language option 618b, and language option 618c. Option 618a is an option for selecting a language model (e.g., Spanish) to be used to translate messages received and transmitted by computer system 606 in the messaging session between Christian and Lauren (e.g., messages sent from Lauren's phone to Christian's phone will be translated from English to Spanish and messages received by Lauren's phone from Christian's phone will be translated from Spanish to English) and includes an indication of the file size (e.g., 375 megabytes) of a Spanish language model. In some embodiments, menu 618 includes language option 618a as a suggestion because computer system 606 determines that messages 610b and/or 612b are in Spanish. Option 618b is an option for selecting another language model (e.g., Portuguese) to be used to translate messages received and transmitted by computer system 606. In some embodiments, language option 618b does not include an indication of the file size of the Portuguese language model because the Portuguese language model has already been downloaded onto computer system 606. In some embodiments menu 618 includes both language options 618a and 618b as suggestions because computer system 606 determines that messages 610b and/or 612b include text that could correspond to either Spanish or Portuguese. In some embodiments a language model for Spanish has not been downloaded onto computer system 606 and selection of option 618a will cause the language model for Spanish to be downloaded onto computer system 606 and will cause computer system 606 to begin translating messages in the messaging session between Christian and Lauren using the Spanish language model (e.g., after the download of the respective language model is completed). In some embodiments selection of option 618b will cause computer system 606 to begin translating messages received in the messaging session between Christian and Lauren using the Portuguese language model without having to redownload the Portuguese language model. Option 618c is an option to display a list of additional languages (e.g., that were not suggested based on the determined language of messages 610b and/or 612b. At FIG. 6B, computer system 606 detects user input 620 (e.g., a tap input) corresponding to language option 618c.

At FIG. 6C, in response to user input 620, computer system 606 displays language menu 622. Language menu 622 includes a variety of language models that can be used to translate messages received and transmitted by computer system 606 in the messaging session between Christian and Lauren, which are categorized into suggested language group 622a and more languages group 622b. Suggested language group 622a includes language model option 624a and language model option 624b which correspond to the language options 618a and 618b (e.g., for Spanish and Portuguese) that were suggested in automatic translation menu 618 of FIG. 6B. In some embodiments, language model option 624a includes download icon 626 because a Spanish language model has not been downloaded onto computer system 606. In some embodiments, language model option 624b does not include an associated download icon because a language model for Portuguese has already been downloaded onto computer system 606. More languages group 622b includes a variety of language model options that do not correspond to the language options that were suggested in automatic translation menu 618 of FIG. 6B (e.g., 618a and 618b). At FIG. 6C, computer system 606 detects input 628 (e.g., a tap input) corresponding to download icon 626. At FIG. 6D, in response to user input 628, computer system 606 begins downloading a language model for Spanish and displays download indication 630 which provides a download status (e.g., 210 MB out of 375 MB) of the language model for Spanish.

At FIG. 6E, in response to user input 628 and after completion of the download of the language model for Spanish, computer system 606 displays an expanded version of messages 610b and 612b. The expanded versions of 610b and 612b include the original text 610b1 and 612b1, respectively, which are in Spanish (e.g., “Hola” and “¿ Ven aquí a las 10:30 en la mañana?”), and include the translated text 610b2 and 612b2, respectively, which are an English translation of original text 610b1 and 612b2 (e.g., “Hello” and “Come here at 10:30 in the morning?”). At FIG. 6E, computer system 606 displays automatic translation status indicator 644 indicating that messages received in a foreign language are being translated (e.g., “Automatic translating messages”). At FIG. 6E, computer system 606 also displays message expansion option 632. In some embodiments, selection of message expansion option 632 (e.g., “Hide Spanish”) will cause computer system 606 to display an un-expanded version of messages 610b and 612b such that original text 610b1 and 612b1 are no longer displayed, as depicted in further detail in FIG. 6K. At FIG. 6E, computer system receives input 636a (e.g., a tap input) directed to text field 642b.

At FIG. 6F, in response to receiving one or more inputs (e.g., input 636a and one or more inputs interacting with keyboard 646a), computer system 606 displays message 634b as a draft message in text field 642b. Text field 642b includes send icon 638b for transmitting a message drafted in text field 642b. In some embodiments, message 634b includes original text 634b2, which is the English text that message 634b was drafted in (e.g., “Is 10:45 good?”) and translated text 634b1 (“¿10:45 es bueno?”) which is a Spanish translation of original text 634b2. In some embodiments, portions of original text 634b2 and translated text 634b1 are concurrently displayed in text field 642b as message 634b is being drafted (e.g., via the one or more inputs interacting with keyboard 646a). At FIG. 6F, while the draft of message 634b is displayed in text field 642b, computer system 606 detects input 640b (e.g., a tap input) directed to send icon 638b.

At FIG. 6G, in response to receiving input 640b, computer system 606 displays message 634b as a sent message (e.g., in message region 608b) in expanded form, such that translated text 634b1 and translated text 634b2 are both included in message 634b. Additionally, in response to receiving input 640b, and computer system 600 displays message 634a as a received message (e.g., in message region 608a) in un-expanded form, such that only the Spanish version of the text is displayed (e.g., “¿10:45 es bueno?”). In some embodiments, in response to receiving message 634a, computer system 600 displays automatic translation indication 648 (e.g., “Lauren está traduciendo mensajes automáticamente del inglés”) indicating that Lauren is automatically translating messages from English. At FIG. 6G, computer system 606 detects input 650 (e.g., a tap and hold input) directed to message 634b. At FIG. 6H, in response to detecting input 650, computer system 606 displays message menu 652 which includes option 652a for editing a sent message. At FIG. 6H, computer system 606 detects one or more inputs including input 654 (e.g., a tap input) directed to option 652a (e.g., “edit”) and one or more inputs interacting with keyboard 646a.

At FIG. 6I, in response to detecting one or more inputs (e.g., input 654 and one or more inputs interacting with keyboard 646a), computer system 606 displays a draft of message 656b (e.g., in message region 608b) in expanded form, such that translated text 656b1 (e.g., “¿11:00 es bueno?”) and original text 656b2 (e.g., “Is 11:00 good?”) are both included in message 656b. Message 656b is an edited version of message 634b (e.g., drafted via one or more inputs corresponding to keyboard 646a). At FIG. 6I, computer system 606 also displays confirmation icon 658 and detects input 660 (e.g., a tap input) directed to confirmation icon 658.

At FIG. 6J, in response to detecting input 660, computer system 606 displays message 656b as a sent message (e.g., in message region 608b) in expanded form, such that translated text 656b1 and translated text 656b2 are both included in message 656b. Additionally, in response to receiving a message corresponding to message 656b sent by computer system 606, computer system 600 displays message 656a as a received message (e.g., in message region 608a) in un-expanded form, such that only the Spanish version of the edited text is displayed (e.g., “11:00 es bueno?”). At FIG. 6J, computer system 606 detects input 662 (e.g., a tap input) directed towards message expansion option 632.

At FIG. 6K, in response to detecting input 662, computer system 606 displays messages 610b, 612b, and 656b in unexpanded form, such that only the English versions of the text of messages 610b, 612b, and 656b are displayed. In some embodiments, a subsequent selection of message expansion option 632 (e.g., “Show Spanish”) will cause computer system 606 to redisplay the expanded versions of messages 610b, 612b, and 656b. At FIG. 6K, computer system 600 displays a draft of message 664a (e.g. “Si, funciona para todos”) and send icon 638a in text field 642a. At FIG. 6K, computer system 600 detects input 640a (e.g., a tap input) directed towards send icon 638a.

At FIG. 6L, in response to detecting input 640a, computer system 600 displays message 664a as a sent message in message region 608a. At FIG. 6L in response receiving a message corresponding to message 664a sent by computer system 600, computer system 606 displays message 664b in message region 608b as a message that has been translated from Spanish to English. In some embodiments, because message expansion option 632 was previously selected, message 664b is displayed in un-expanded form, such that only the English text of message 664b is displayed (e.g., “Yes, it works for everyone”). At FIG. 6L, computer system 606 detects input 668a directed towards contact header 666a corresponding to a contact for “Christian” (e.g., associated with computer system 600).

At FIG. 6M (note that FIGS. 6M and 6N only include computer system 606), in response to detecting input 668a, computer system 606 displays contact interface 670 corresponding to contactable user “Christian.” Contact interface 670 includes a variety of selectable options for adjusting the settings of the messaging application that corresponds to messaging interface 604b, including automatic translation option 670a (e.g., a selectable toggle) for activating or deactivating the automatic translation of messages received and transmitted by computer system 606 in message region 608b. In some embodiments, the variety of selectable options for adjusting the settings of the messaging application that corresponds to messaging interface 604b are settings that only affect the conversation with contact Christian. At FIG. 6M, because automatic translation was previously activated (e.g., see FIGS. 6C-6E) automatic translation option 670a is displayed with an indication that the automatic translation of messages is activated (e.g., the selectable toggle is in the right position). In some embodiments, contact interface 670 also includes return icon 674a that, when selected, redisplays messaging interface 604b. At FIG. 6M, computer system 606 detects input 672a (e.g., a tap input) directed to automatic translation option 670a.

At FIG. 6N, in response to detecting input 672a, computer system 606 displays automatic translation option 670a with an indication that the automatic translation of messages is deactivated (e.g., the selectable toggle is in the left position). At FIG. 6N, computer system 606 detects input 676a (e.g., a tap input) directed to return icon 674a.

At FIG. 6O, in response to detecting input 672 and input 676a, computer system 606 displays messages 610b, 612b, 656b, and 664b in expanded form, such that both the translated text (e.g., English) and original text (e.g., Spanish) are displayed in messages 610b, 612b, 656b, and 664b. In some embodiments, computer system 600 ceases to display automatic translation indication 648 after the automatic translation of messages is deactivated on computer system 606.

FIG. 6P illustrates an embodiment where automatic translation has been reactivated on computer system 606 (e.g., via selection of automatic translation option 670a in contact interface 670) and computer system 600 redisplays automatic translation indication 648 in message region 608a. At FIG. 6P, computer system 600 displays message 678a (e.g. “ [symbol] Nos vemos entonces!”) in message region 608a that was sent to computer system 606. In some embodiments, computer system 606 receives the message sent by computer system 600 in the form of a notification (e.g., notification 678b) because messaging interface 604b is not currently being displayed. In some embodiments, computer system 606 receives the message sent by computer system 600 while computer system 606 has automatic translation option 670a activated, and, as a result, notification 678b includes a translated version of message 678a with an indication that the message was translated (e.g., “Translated: See you then!”).

FIGS. 6Q-6W illustrate an exemplary method for automatically translating messages in a group message transcript between user “Lauren” and a group of contactable users, including “Christian,” “James,” Johnny A. ,“ and “Steve,” from the perspective of computer system 606 associated with “Lauren.” In some embodiments, contactable user “Christian” is associated with computer system 600 and contactable users James,” Johnny A.,” and “Steve,” are each associated with their own respective computer systems.

At FIG. 6Q, computer system 606 displays messaging user interface 604c. Messaging user interface 604c corresponds to a group messaging session between a user of computer system 606 (e.g., “Lauren”) and a group of contactable users. Messaging user interface 604c includes message region 608c, which displays message 682 (e.g. “Ola”) and message 684 (e.g., “¿ Venha aqui as 11:00 da manna?”), which are messages in Portuguese that were transmitted into the group messaging session by Christian via computer system 600 and were received by computer system 606. Message region 608c displays message 690, which is a message in English from contact “Johnny A.” Messaging user interface 604c also includes automatic translation prompt 614b and contact header 666b (e.g., “4 people”), identifying the number of participants in the group messaging session. In some embodiments, automatic translation prompt 614b is displayed in response to computer system 606 receiving a message (e.g., message 682 and/or message 684) in a foreign language (e.g., Portuguese) that is different from the primary language of computer system 606 (e.g., English). At FIG. 6Q, computer system 606 detects input 668b (e.g., a tap input) directed towards contact header 666b. In some embodiments, computer system 606 detects input 636b directed to text field 642c.

At FIG. 6R, in response to detecting input 668b, computer system 606 displays contact interface 680 corresponding to contactable users “Christian” (e.g., associated with computer system 600) “James,” Johnny A.,” and “Steve.” Contact interface 680 includes a variety of selectable options for adjusting the settings of messaging interface 604c, including automatic translation option 680a (e.g., a selectable toggle) for activating or deactivating the automatic translation of messages received and transmitted by computer system 606 in message region 608c. In some embodiments, the variety of selectable options for adjusting the settings of the messaging application that corresponds to messaging interface 604b are settings that only affect the group message conversation with contacts Christian, James, Johnny A., and Steve. At FIG. 6R, automatic translation option 680a is displayed with an indication that the automatic translation of messages is deactivated (e.g., the selectable toggle is in the left position). In some embodiments, option 680a also includes an indication of a suggested language model (e.g., Portuguese) that can be used to translate incoming and outgoing message in message region 608c. In some embodiments, the indication of the suggested language mode in option 680a is displayed because computer system 606 determined that one or more messages (e.g., message 682 and/or message 684) in message region 608c are in a foreign language (e.g., Portuguese). In some embodiments, contact interface 680 also includes return icon 674b that, upon selection, redisplays messaging interface 604c. At FIG. 6R, computer system 606 detects input 672b (e.g., a tap input) directed to automatic translation option 680a.

At FIG. 6S, in response to detecting input 672b, computer system 606 displays automatic translation menu 686 that includes a variety of selectable options including language option 686a and language option 686b. Option 686a is an option for selecting a language model (e.g., Portuguese) to be used to translate messages received and transmitted by computer system 606 in the group messaging session. In some embodiments, language menu 686 includes language option 686a based on determination that message 682 and/or message 684 are in Portuguese. Option 686b is an option to display a list of additional languages that, when selected, causes the display of language menu 622 as shown in FIG. 6C. At FIG. 6S, computer system 606 detects user input 688 (e.g., a tap input) corresponding to language option 686a.

At FIG. 6T, in response to detecting input 688, computer system 606 displays automatic translation option 680a with an indication that the automatic translation of messages is activated (e.g., the selectable toggle is in the right position). In some embodiments, automatic translation of the messages in the group messaging session is activated automatically in response to detecting input 688 because a language model for Portuguese was already downloaded onto computer system 606. At FIG. 6T, computer system 606 detects input 676b (e.g., a tap input) directed to return icon 674b.

At FIG. 6U, in response to detecting input 688 and input 676b, computer system 606 displays messages 682 and 684 in expanded form, such that both the translated text (e.g., “Hello” and “Come here at 11:00 in the morning?”) and original text (e.g., “Ola” and ““¿Venha aqui as 11:00 da manna?”) are displayed in messages 682 and 684, respectively. In some embodiments, message 690 is not displayed in expanded form in response to detecting input 688 and input 67b because message 690 is in English. At FIG. 6U, computer system 606 displays message 692 as a draft message in text field 642c, which is displayed in response to receiving input 636b (e.g., as shown in FIG. 6Q) and one or more inputs interacting with keyboard 646b. Text field 642c includes send icon 638c for transmitting a message drafted in text field 642c. In some embodiments, message 692 includes original text 692b, which is the English text that message 692 was drafted in (e.g., “Sounds good!”) and translated text 692a (“Parece bom!”) which is a Portuguese translation of original text 692b. In some embodiments, portions of original text 692b and translated text 692a are concurrently displayed in text field 642c as message 692 is being drafted (e.g., via input 636b). At FIG. 6U, while the draft of message 692 is displayed in text field 642c, computer system 606 detects input 640c directed to send icon 638c.

At FIG. 6V, in response to receiving input 640c, computer system 606 displays message 692 as a sent message (e.g., in message region 608c) in expanded form, such that translated text 692a and original text 692b are both included in message 692.

FIG. 6W illustrates computer system 694, which is a personal laptop computer associated with user “Lauren” and in communication with computer system 606 (e.g., user Lauren has an accessible profile linked to both computer systems 606 and 694). In some embodiments, computer system 694 includes one or more features of device 100, 300, and/or 500. At FIG. 6W, computer system 694 displays messaging interface 604d which includes message region 608d and contact interface 680b. Message region 608d corresponds to a group messaging session between Lauren and a group of contactable users including “Christian,” “James,” Johnn A.,” and “Steve,” (e.g., the same as message region 608c shown in FIG. 6V). Messaging interface 604d also includes contact interface 680b (e.g., the same as contact interface 680a shown in FIG. 6T). In some embodiments, computer system 694 automatically stores the same automatic translation settings that were enabled for the group messaging between Lauren and the contactable users in FIG. 6T (e.g., the automatic translation setting is synchronized across multiple computer systems associated with Lauren and/or a profile associated with Lauren).

FIG. 7 is a flow diagram illustrating a method for causing the display of an option to automatically translate messages for a message transcript using a computer system in accordance with some embodiments. Method 700 is performed at a computer system (e.g., 100, 300, 500, 600, 606, and/or 694) (e.g., a smartphone, a smartwatch, a tablet, personal computer and/or a head mounted device) that is in communication with one or more display generation components (e.g., a display, a touch-screen display (e.g., 602a and/or 602b) a monitor, a holographic display system, and/or a head-mounted display system) and one or more input devices (e.g., a touch-sensitive surface (e.g., a touch-sensitive display (e.g., 602a and/or 602b)), a mouse, a keyboard, a remote control, a visual input device (e.g., one or more cameras such as an infrared camera, a depth camera, a visible light camera, and/or a gaze tracking camera), and/or an audio input device (e.g., a microphone)). Some operations in method 700 are, optionally, combined, the orders of some operations are, optionally, changed, and some operations are, optionally, omitted.

As described below, method 700 provides an intuitive way for causing the display of an options for automatically translate messages for a message transcript. The method reduces the cognitive burden on a user for causing the display of an options for automatically translate messages for a message transcript, thereby creating a more efficient human-machine interface. For battery-operated computing devices, enabling a user to cause the display of an options for automatically translate messages for a message transcript faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

Performing an operation when a set of conditions has been met without requiring further user input (such as by displaying the first option for activating a first automatic translation mode based on whether the first received message is in a first language; automatically providing a suggested language that can be selected as the first language in the option for activating the first automatic translation mode; displaying an option to download a respective language model for the first language when the respective language model has not already been downloaded; displaying the plurality of respective suggested languages that can be selected as the first language when the first message meets the first set of translation criteria for a plurality of respective suggested languages; enabling messages received from the first contact prior to activating the first automatic translation mode to be translated; displaying the first respective message of the messages received from the first contact in either a first or second visual representation based on whether a first expanded message mode is operating; enabling the translation of outgoing messages before being transmitted to one or more participants; and automatically providing an indication that a suggested language can be selected as the first language in the second option based on whether messages received in the first message transcript meet a transition criteria) enhances the operability of the device by reducing unnecessary inputs and/or steps to navigate through different user interfaces or sets of controls, reducing energy usage by the device.

Providing improved feedback (such as by displaying both a first version of the respective message in a first language and a second version of the respective message in the second language; displaying different visual representations for outgoing messages depending on whether the automatic translation mode is activated; displaying an indication that a message was translated based on a determination that the second message was translated from the first language to the second language; displaying a first preview that includes versions of the third message in both a first and second language after activating the first automatic translation mode; displaying a second preview that includes versions of the transmitted message in both a first and second language after activating the first automatic translation mode; displaying a notification that includes an indication that the received message was translated after activating the first automatic translation mode; and changing the visual appearance of the messages received from the first contact in response to the fourth input) enhances the operability of the device by reducing accidental and mistaken inputs, reducing energy usage by the device.

Providing additional control options (such as by displaying a first contact details user interface in response to a first input received while displaying the first message transcript, wherein the first contact details interface includes a second option for modifying an operation status of the first automatic translation mode; and displaying an option for modifying the appearance of the messages received from the first contact in the first message transcript) without cluttering the UI with additional displayed controls enhances the operability of the device by reducing unnecessary inputs and/or steps to navigate through different user interfaces or sets of controls, reducing energy usage by the device.

The computer system (e.g. 606) receives (702) (e.g., via a communication bus and/or a wireless antenna) a first message (e.g., 610b and/or 612b) (e.g., a text message in a first message transcript (e.g., a section of a messaging user interface that displays received messages and transmitted messages associated with a first contact) corresponding to a messaging user interface (e.g., an interface for receiving, composing, and/or transmitting electronic messages (e.g., text messages, audio messages, linked messages, image messages, and/or video messages) between a user of the computer system and one or more participants associated with an external device)) from a first contact (e.g., a contactable user). In response to receiving the first message (704) and in accordance with a determination that the first message is in a first language (e.g., at least a portion of the message (e.g., one or more words of the message) is in a foreign language (e.g., identified as matching one or more words corresponding to a foreign language model (e.g., a database that includes an alphabet of a respective foreign language) not associated with the profile of the user of the computer system (e.g., Spanish, French, German))) (in some embodiments, in accordance with a determination that the first message is not in a respective language (e.g., not primary language of the computer system)), the computer system (e.g., 606) displays (706), via the one or more display generation components, a first option (e.g., 614a) (e.g., an affordance and/or selectable graphical user interface object) that, when selected, initiates a process for activating a first automatic translation mode for a first message transcript (e.g., 608b) (e.g., a section of a messaging user interface that displays transmitted messages (e.g., sent from the user of the computer system) and received messages (e.g., including the first message from the first contact) associated with a first contact of one or more contacts (e.g., including the first contact) associated with the message transcript) corresponding to the first contact (e.g., Christian), wherein activation of the first automatic translation mode enables messages received from the first contact (e.g., including the first message (in some embodiments, activation of the first automatic translation mode enables messages received from multiple contacts associated with the first message transcript to be translated; In some embodiments, activation of the first automatic translation mode only enables the translation of messages received from one or more contacts associated with the first message transcript)) to be translated (e.g., display a representation of the first message in the second language (e.g., English)) from the first language to a second language. In some embodiments, in accordance with a determination that the first message is in the second language, foregoing displaying the option to translate the first message. In some embodiments, once the first automatic translation mode is activated, future messages from one or more contacts associated with the message transcript (e.g., including the first contact) that are in the first language will be automatically translated, until the option/feature is disabled.

While displaying the first message transcript corresponding to the first contact, the computer system (e.g., 606) receives (708), via the one or more input devices, a first input (e.g., 668a) (e.g., directed to the message transcript (e.g., directed to a header (e.g., one or more representations (e.g., photos, monograms, avatars (e.g., customized, anthropomorphized, and/or animated graphical representations))) of the one or more contacts (e.g., including the first contact) associated with the message transcript)).

In response to receiving the first input, the computer system (e.g., 606) displays a first contact details user interface (e.g., 670) (in some embodiments, in response to receiving the first input, the computer system displays (710) the first contact details user interface replaces the display of the first message transcript) associated with the first message transcript, wherein the first contact details user interface includes a plurality of options (e.g., adjustable settings) associated with the first message transcript including a second option (e.g., 670a) (e.g., an affordance and/or selectable graphical user interface object) for modifying (e.g., activating or deactivating) an operation status of the first automatic translation mode for the first message transcript. In some embodiments, once the first automatic translation mode is activated, future messages from one or more contacts associated with the message transcript (e.g., including the first contact) that are in the first language will be automatically translated, until the option/feature is disabled.

In some embodiments, the first option (e.g., 614a) for activating the first automatic translation mode includes a first suggested language (e.g., Spanish) (in some embodiments, the first suggested language is based on one or more received messages in the transcript meeting a foreign language criterion (e.g., one or more messages have words that match a foreign language model with a threshold level of confidence)) to be translated from (e.g., the first language). In some embodiments, the first option includes a suggested language to be translated to (e.g., the second language).

In some embodiments, the computer system (e.g., 606) receives, via the one or more input devices, an input (e.g., 616) corresponding to the first option for activating the first automatic translation mode. In some embodiments, in response to receiving the input (e.g., 616) corresponding to the first option for activating the first automatic translation mode, the computer system (e.g., 606) initiates a process to translate future messages (e.g., 664b) (e.g., messages received after the automatic translation mode is activated) received from the first contact to be translated from the first language to the second language. In some embodiments, initiating the first process to activate the first automatic translation mode includes displaying a confirmation interface for choosing and/or downloading a language model for the first language. In some embodiments the confirmation prompt includes an option to display a list of all available languages that can be chosen and/or have available language models that can be downloaded for the first language.

In some embodiments, initiating the process for activating the first automatic translation mode for the first message transcript includes: in accordance with a determination that a respective language model (e.g., a database that includes an alphabet of a respective foreign language) for the first language has not been downloaded (e.g., transferred to the computer system), displaying, via the one or more display generation components, an option to download a respective language model for the first language (e.g., 618a, 618b, and/or 618c). In some embodiments, selection of the option to download a respective language will cause the first automatic translation mode to automatically activate once the respective language finishes downloading. In some embodiments, the respective language mode is a model for the second language. In some embodiments initiating the process for activating the first automatic translation mode for the first message transcript includes, in accordance with a determination that the respective language model for the first language is downloaded, forgoing displaying the option to download the respective language model for the first language.

In some embodiments, initiating the process for activating the first automatic translation mode for the first message transcript includes: in accordance with a determination that the first message meets a first set of translation criteria for a plurality (e.g., more than one) of respective suggested languages (e.g., the first messages has one or more words that match multiple foreign language models with a threshold level of confidence), displaying, via the one or more display generation components, the plurality of respective suggested languages to be translated from (e.g., Spanish and Portuguese) (e.g., as seen in FIG. 6B). In some embodiments, initiating the process for activating the first automatic translation mode for the first message transcript includes, in accordance with a determination that the first message does not meet the first set of translation criteria for the plurality of respective suggested languages, forgoing displaying the plurality of respective suggested languages to be translated from.

In some embodiments, activating the first automatic translation mode translates a previously received message (e.g., 610b and/or 612b) (e.g., as seen in FIG. 6E) from the first contact, that was received prior to activating the first automatic translation mode, from the first language to the second language. In some embodiments, translating messages received from the first contact prior to activating the first automatic translation mode causes the previously received messages to be displayed in expanded form (e.g., a first version of the message in a first language (e.g., a foreign language (e.g., Spanish)) and a second version of the message in a second language (e.g., the primary language of the computer system (e.g., English) are concurrently displayed)).

In some embodiments, while the first automatic translation mode is active and in accordance with a determination that a first expanded message mode (e.g., a mode of operation for modifying the visual appearance of a respective translated message (e.g., showing only the translated text of the respective message or showing both the translated text of the respective message and the original foreign language text of the respective message)) is operating, the computer system (e.g., 606) displays a first respective message (e.g., 610b and/or 612b), of the messages received from the first contact, in a first visual representation (e.g., 610b1, 610b2, 612b1, and/or 612b2 are displayed) (e.g., as seen in FIG. 6E). In some embodiments, while the first automatic translation mode is active and in accordance with a determination that the first expanded message mode is not operating, the computer system (e.g., 606) displays the first respective message (e.g., 610b and/or 612b) in a second visual representation (e.g., 610b2 and/or 612b2 are displayed) that is different from the first visual representation.

In some embodiments, the first visual representation includes a first version (e.g., a representation of the text of the message) of the first respective message in the first language (e.g., 610b1 and/or 612b1) and a second version of the first respective message in the second language (e.g., 610b2 and/or 612b2). In some embodiments, the first version of the first respective message is displayed above the second version of the first respective message. In some embodiments, the second visual representation includes a second version of the first respective message in the first language and does not include the second version of the first respective message in the second language.

In some embodiments, the computer system (e.g., 606) receives a request to send an outgoing message (e.g., 634b) (e.g., to the first contact in the message transcript). In some embodiments, in response to receiving the request to send a first outgoing message and in accordance with a determination that the first automatic translation mode is active, the computer system (e.g., 606) translates (e.g., from the second language to the first language) the first outgoing message (e.g., 634b) before the outgoing message is transmitted (e.g., before being received by an external device of the first contact).

In some embodiments, the first contact (e.g., Christian) is first participant (e.g., a user associated with an external device that is in a communication session (e.g., a text message exchange via the message transcript) with the user of the computer system) of a plurality (e.g., more than one) of participants (e.g., Christian, James, Johnny A., and/or Steve) associated with the first message transcript (e.g., 608c as seen in FIG. 6Q). In some embodiments, activating the first automatic translation mode enables outgoing messages to be translated from the second language to the first language before being transmitted to the plurality of participants.

In some embodiments, in response to receiving the request to send the outgoing message and in accordance with a determination that the first automatic translation mode is active, the computer system displays, via the one or more display generation components, a first visual representation (e.g., 634b as shown in FIG. 6G) of the outgoing message (e.g., an expanded version of the message, upon sending, is displayed with text in the language that the message was drafted in (e.g., English) and text in the language that the message was translated to upon sending (e.g., Spanish); In some embodiments, the text in the language that the message was drafted in is displayed above the text in the language that message was translated to upon sending). In some embodiments, in response to receiving the request to send the outgoing message and in accordance with a determination that the first automatic translation mode is not active, the computer system displays, via the one or more display generation components, a second visual representation (e.g., an unexpanded version of the message, upon sending, is displayed with the translated text (e.g., Spanish) and not the language that the message was drafted in and/or translated from (e.g., English)) of the outgoing message that is different from the first visual representation of the outgoing message to. In some embodiments, the first visual representation is displayed in response to receiving the request when an expanded message mode is enabled. In some embodiments, in accordance with a determination that the expanded message mode is not enabled, the first visual representation of the outgoing messages is the same as the second visual representation of the outgoing message (e.g., both visual representations only display the text of the message in the second language).

In some embodiments, while the first automatic translation mode is not active, the computer system (e.g., 600) receives (e.g., displaying in the message transcript) a second message (e.g., 634a) (e.g., from a contact associated with an external device) in the second language (e.g., the primary language of the computer system (e.g., English)). In some embodiments, in response to receiving the second message and in accordance with a determination that the second message was translated from the first language to the second language, the computer system displays, via the one or more display generation components, an indication that the second message was translated (e.g., 648). In some embodiments, the indication includes information corresponding to the operating mode of the external device that transmitted the message (e.g., an operation status of an automatic translation mode on the external device). In some embodiments, the second message was translated to the second language (e.g., from the first language) at the external device that transmitted the second message.

In some embodiments, while the first automatic translation mode is active, the computer system receives, via the one or more input devices, a first set of inputs (e.g., 636a and/or one or more inputs interacting with keyboard 646a) for composing (e.g., drafting) a third message (e.g., 634b) to be transmitted (e.g., sent to the first contact). In some embodiments, in response to receiving the first set of inputs, the computer system displays a first preview (e.g., 634b as shown in FIG. 6F) (e.g., a draft message displayed in a text input field of the message transcript) that includes a first version of the third message in the first language (e.g., 634b1) and a second version of the third message in the second language (e.g., 634b2).

In some embodiments, computer system (e.g., 606) displays, via the one or more display generation components, a first visual representation of a transmitted message (e.g., 634b in FIG. 6G). In some embodiments, while the first automatic translation mode is active, the computer system (e.g., 606) receives, via the one or more input devices, one or more inputs (e.g., 650, 654, one or more inputs interacting with keyboard 646a, and/or 658) (e.g., that include an input (e.g., a tap gesture) directed to the transmitted message) to initiate a process for editing the transmitted message (e.g., a message sent to the first contact). In some embodiments, in response to receiving the one or more inputs to initiate a process for editing the transmitted message, the computer system (e.g., 606) displays a second visual representation (e.g., a draft of an edited version of the transmitted message) of the transmitted message (e.g., 656b) that includes a first version of the transmitted message in the first language (e.g., 656b1) and a second version of the transmitted message in a second language (e.g., 656b2). In some embodiments, completing the process for editing the transmitted message includes sending a translation of the edited version of the transmitted message. In some embodiments, in response to completing the process for editing the transmitted message (e.g., sending the draft of the edited version of the transmitted message), the computer system displays, via the one or more display generation components, a first version of an edited transmitted message (e.g., an edited version of the previously transmitted message) in the first language and a second version of the edited transmitted message in the second language.

In some embodiments, while the first automatic translation mode is active, the computer system displays, via the one or more display generation components, a notification for a received message (e.g., 678b), wherein the notification includes an indication (e.g., “translated:” followed by the translated text of the received message) that the received message was translated. In some embodiments, the notification can be received while the message application associated with the message transcript is not open on the computer system.

In some embodiments, while the first automatic translation mode is active, the computer system (e.g., 606) enables (e.g., storing) a first automatic translation setting for the first message transcript. In some embodiments, while the first automatic translation mode is active, the computer system (e.g., 606) causes one or more external devices (e.g., 694) associated with a user of the computer system to enable the first automatic translation setting for the same first message transcript.

In some embodiments, computer system (e.g., 606) receives, via the one or more input devices, a first input (e.g., 672a) (e.g., a tap input) corresponding to the second option (e.g., 670a) (e.g., an on/off toggle) for modifying the operation status of the first automatic translation mode. In some embodiments, in response to receiving the first input corresponding to the second option and in accordance with a determination that the operation status of the first automatic translation mode was inactive (e.g., the toggle corresponding to the second option is in the “off” position) when the first input corresponding to the second option was received, the computer system initiates a second process to activate the first automatic translation mode.

In some embodiments, in response to receiving the first input (e.g., 672a) corresponding to the second option (e.g., 670a) and in accordance with a determination that the operation status of the first automatic translation mode was active (e.g., the toggle corresponding to the second option is in the “on” position) when the first input corresponding to the second option was received, the computer system (e.g., 606) deactivates the first automatic translation mode.

In some embodiments, a second expanded message mode (e.g., a mode of operation for modifying the visual appearance of a respective translated message (e.g., showing only the translated text of the respective message or showing both the translated text of the respective message and the original foreign language text of the respective message)) was not operating when the first input (e.g., 672a) corresponding to the second option (e.g., 670a) was received. In some embodiments, in response to receiving the first input corresponding to the second option in accordance with the determination that the operation status of the first automatic translation mode was active when the first input corresponding to the second option was received, the computer system (e.g., 606) changes a respective visual appearance of the messages (e.g., 610b, 612b, 634b, and/or 664b as shown in FIG. 60) received from the first contact in the message transcript. In some embodiments, before receiving the fourth input, the messages received from the first contact included only a visual display of the translated text of a respective message, and changing the visual appearance of the messages causes the respective message to include both the translated text of the respective message and the original foreign language text of the respective message. In some embodiments, only messages that were previously translated while the first automatic translation mode was operating will change their visual appearance in response to the fourth input.

In some embodiments, in accordance with a determination that one or more messages received in the first message transcript meet a second set of translation criteria (e.g., one or more messages received in the first message transcript have one or more respective words that match a foreign language models with a threshold level of confidence) for a second suggested language (e.g., a language corresponding to the foreign language model that matches one or more respective words of the one or more messages received in the first message transcript), the second option (e.g., 680a in FIG. 6R) includes an indication that the second suggested language can be selected as the first language. In some embodiments, in accordance with a determination that one or more messages received in the first message transcript do not meet a second set of translation criteria for the second suggested language, the second option does not include the indication that the second language can be selected as the first language.

In some embodiments, the computer system (e.g., 606) receives, via the one or more input devices, a second input (e.g., 672b) (e.g., a tap input) corresponding to the second option (e.g., 680a) for modifying the operation status of the first automatic translation mode. In some embodiments, in response to receiving the second input corresponding to the second option, displaying, via the one or more display generation components, an interface (e.g., 686) for confirming the suggested second language to be used as the first language.

In some embodiments, while displaying a second message transcript corresponding to a second contact (e.g., Christian, James, Johnny A., and/or Steve) (in some embodiments, the second message transcript also corresponds to multiple other contacts (e.g., including the first contact)), the computer system (e.g., 606) receives, via the one or more input devices, a sixth input (e.g., 668b in FIG. 6Q). In some embodiments, in response to receiving the sixth input, the computer system (e.g., 606) displays a second contact details user interface (e.g., 680) (in some embodiments, in response to receiving the sixth input, displaying the second contact details user interface replaces the display of the second message transcript) associated with the second message transcript (e.g., 608c) (in some embodiments, associated with the second contact), wherein the second contact details user interface includes a plurality of options (e.g., adjustable settings) associated with the second message transcript including a third option (e.g., 680a) (e.g., an affordance and/or selectable graphical user interface object) for modifying (e.g., an off/off toggle for activating or deactivating) an operation status of a third automatic translation mode for the second message transcript, different from the first automatic translation mode for the first message transcript. In some embodiments, the third automatic translation mode and the first automatic translation mode are independent such that one can be enabled or disabled without affect the status of the other.

In some embodiments, the computer system (e.g., 606) receives, via the one or more input devices, a seventh input (e.g., 672b) (e.g., a tap input) corresponding to the third option (e.g., 680a) for modifying the operation status of the third automatic translation mode. In some embodiments, in response to receiving the seventh input and in accordance with a determination that the operation status of the third automatic translation mode was inactive (e.g., the toggle corresponding to the third option is in the “off” position) when the seventh input was received, the computer system initiates a third process to activate the third automatic translation mode. In some embodiments, during the third process to activate the third automatic translation mode, the computer system enables messages received from the second contact to be translated from a third language, different from the first language, to the second language.

In some embodiments, while the first automatic translation mode is active, the computer system displays, via the one or more display generation components and in the first message transcript (e.g., 608a), an option (e.g., 632) for modifying an appearance (modifying the visual appearance of a respective translated message (e.g., showing only the translated text of the respective message or showing both the translated text of the respective message and the original foreign language text of the respective message)) of the messages received from the first contact.

In some embodiments, a second respective message of the messages received from the first contact (e.g., 610b, 612b, and/or 664b) has a first appearance that includes a third version of the second respective messages in the first language (e.g., 610b1, 612b1, and/or 664b1) and a fourth version of the second respective message in the second language (e.g., 610b2, 612b2, and/or 664b2), wherein the first appearance is a default appearance. In some embodiments, the option (e.g., 632) for modifying the appearance of the messages received from the first contact, when selected, changes the first appearance of the second respective messages to a second appearance of the second respective messages, wherein the second appearance includes the fourth version of the second respective messages (e.g., 610b2, 612b2, and/or 664b2) and does not include the third version of the second respective message (e.g., 610b1, 612b1, and/or 664b1).

Note that details of the processes described above with respect to method 700 (e.g., FIG. 7) are also applicable in an analogous manner to the methods described below. For example, methods 900, 1100, and/or 1300 optionally include one or more of the characteristics of the various methods described above with reference to method 700. For example, the computer system of method 700 can be the same computer system that performs methods 900, 1100, and/or 1300. For another example, the process for downloading various automatic translation language models in method 900 can be used to facilitate the process for automatically translating messages in method 700. For another example, the process for displaying an option for sharing a representation of the user in method 1100 can be performed in the same messaging application in which the various options for automatically translating messages are displayed in method 700. For brevity, these details are not repeated below.

FIGS. 8A-8S illustrate exemplary methods for preparing to make an outgoing call and, if translation criteria are met, displaying an option for automatically translating incoming and outgoing audio during the call. FIGS. 8A-8S also illustrate exemplary methods for, during a phone conversation, outputting audio in a first language from a first participant at a first volume (e.g., a full volume), and outputting audio in a second language, that is a translated version of the first language, at a second volume (e.g., a ducked volume), different from the first volume.

FIGS. 8A-8C illustrate a call log interface associated with a user of computer system 606 in which various automatic translation settings can be accessed and/or activated by the user of computer system 606 to be used during a future phone call.

FIG. 8A illustrates computer system 606. At FIG. 8A, computer system 606 displays call log interface 804, which includes a log of recent incoming and outgoing calls received and transmitted by computer system 606. In some embodiments, call log interface 804 also includes automatic translation option 806, which is displayed automatically upon opening call log interface 804. At FIG. 8A, computer system 606 detects input 808 (e.g., a tap input) directed to automatic translation option 806. In some embodiments, input 808, and other user inputs described in FIGS. 8A-8S, can be a touch input (e.g., a tap input, long press input, and/or a swipe input), an air gesture, and/or a gaze-based input. Although the depicted embodiments of FIGS. 8A-8C show automatic translation option 806 in call log interface 804, in other embodiments, automatic translation option 806 is displayed in different types of interfaces (e.g., a messages interface, a general computer system settings interface, and/or a live video call interface) associated with different applications.

At FIG. 8B, in response to detecting input 808, computer system 606 displays language menu 810 (e.g., a menu that includes one or more features discussed above with reference to language menu 622), which includes a variety of languages with associated language models that are available to be downloaded and used to translate audio during a phone call using computer system 606. In some embodiments, computer system displays “French” as a suggested language model to be downloaded based on a determination that computer system 606 is currently located (e.g., has a current GPS location) in a geographical region associated with the French language (e.g., Montreal, Canada). In some embodiments, the suggested language model French includes download icon 810a, indicating that the French language model has not already been downloaded onto computer system 606. At FIG. 8B, computer system 606 detects input 812 (e.g., a tap input) directed to download icon 810a. At FIG. 8C, in response to detecting input 812, download icon 810a is replaced with downloading indication 810b, indicating that the language model for French is currently being downloaded onto computer system 606.

FIGS. 8D-8K illustrate an example of a new phone call, initiated by computer system 606 with an external device associated with the restaurant “Pommes Frites,” located in Montreal, Canada.

At FIG. 8D, computer system 606 displays website interface 814, which is a third-party website associated with the restaurant Pommes Frites. Website interface 814 includes call option 814a, which is a selectable phone number associated with the restaurant Pommes Frites. At FIG. 8D, computer system 606 detects input 816 (e.g., a tap input) directed towards call option 814a.

At FIG. 8E, in response to detecting input 816, computer system 606 displays automatic translation menu 818. In some embodiments, automatic translation menu 818 is displayed in response to detecting input 816 because the phone number associated with the restaurant Pommes Frites corresponds to a geographical region (e.g., has an area code (e.g., 514) associated with Montreal, Canada) associated with a foreign language (e.g., French). Similarly, in some embodiments, automatic translation menu 818 includes option 818a for initiating a call with automatic translation (e.g., English to French) activated, which is suggested because computer system 606 determines that the number associated with the restaurant Pommes Frites is associated with the French language. In some embodiments, automatic translation menu 818 includes call option 818b, which is an option to initiate a call with the restaurant Pommes Frites without automatic translation activated. In some embodiments, option 818c is an option to display a list of additional languages (e.g., that were not suggested based on the determined language associated with the number for Pommes Frites), similar to the list of additional languages shown in FIG. 6C. At FIG. 8E, computer system 606 detects input 820 (e.g., a tap input) directed option 818a.

At FIG. 8F, in response to detecting input 820, computer system 606 displays live phone call interface 822a, representing a live communication session between computer system 606 and an external device (e.g., a smart phone) associated with the restaurant Pommes Frites in which incoming and outgoing audio is being translated (e.g., incoming audio in French is translated to English and outgoing audio in English is translated to French). In some embodiments, input 820 causes the initiation of the live communication session with an automatic translation mode for French activated because a French language model was already downloaded prior to computer system 606 detecting input 820. In some embodiments, in response to receiving input 820, live phone call interface includes transcript region 824a by default, which includes the chronological display of textual representations of incoming and outgoing audio received during the live communication session. In some embodiments, live phone call interface 822a includes a settings region with a variety of selectable options for managing the live communication session, including option 838a (e.g., “More”), which can be selected to initiate a process for modifying the automatic translation settings of the live communication session (as shown in FIG. 8I). In some embodiments, live phone call interface 822a includes an option for stopping automatic translation (e.g., “Stop translation”) that, when selected, causes deactivation of the automatic translation mode without ceasing the live communication session.

Continuing the example of FIG. 8F, at 00:02 seconds into the live communication session, computer system 606 outputs computer-generated audio 826b indicating that the live communication session is being translated (e.g., “Translation is on for this call. Go ahead”). In some embodiments, computer-generated audio 826b is output at volume that corresponds to the current volume setting (e.g., max volume) of computer system 606 because computer-generated audio 826b is audio intended for the user of computer system 606. At 00:02 seconds into the live communication session, computer system 606 simultaneously outputs computer-generated audio 828b, which is a translated version of the computer-generated audio being output on the external device associated with the restaurant Pommes Frites, indicating that the live communication session is being translated. In some embodiments, computer-generated audio 828b is output at a ducked volume (e.g., a volume lower than the current volume setting of computer system 606) because computer-generated audio 828b is audio intended for the external device associated with the restaurant Pommes Frites and not the user of computer system 606. In some embodiments, computer-generated audio 828b is in the same language as the computer-generated audio being output at the external device associated with the restaurant Pommes Frites (e.g., French). In an alternative embodiment, computer-generated audio 828b is a translated version of the computer-generated audio being output on the external device associated with the restaurant Pommes Frites and is in the same language as the computer-generated audio 826b (e.g., English).

Continuing the example of FIG. 8F, in conjunction with outputting computer-generated audio 826b and 828b, computer system 606 displays messages 826a and 828b in transcript region 824a. In some embodiments, message 826a is a textual representation of computer-generated audio 826b and message 828a is a textual representation of computer-generated audio 828b. In some embodiments, live phone call interface 822a includes an indication that automatic translation is enabled for the live communication session (e.g., “Automatically translating caller). In some embodiments, live phone call interface 822a includes transcript expansion option 830, which is an option that, when selected, modifies the visual representation of messages in transcript region 824a, such that the messages are updated to include both the primary language text (e.g., a textual representation of audio in the primary language of computer system (e.g., English)) and foreign language text (e.g., a textual representation of audio in a foreign language (e.g., French)). In some embodiments, upon initiating the live communication session (e.g., via input 820) the external device associated with the restaurant Pommes Frites displays an indication that automatic translation is enabled for the live communication session. In some embodiments, upon initiating the live communication session (e.g., via input 820) the external device associated with the restaurant Pommes Frites does not display a transcript of the incoming and outgoing audio by default, but displays an option that, when selected, causes the display of the transcript of the incoming and outgoing audio.

At FIG. 8G, at 00:06 seconds into the live communication session, computer system outputs audio 832a, corresponding to incoming audio in French (e.g., Bonjour, c'est le restaurant Pommes Frites”) transmitted by the external device associated with the restaurant Pommes Frites. At 00:07 seconds into the live communication session, computer system outputs audio 832b (e.g., (Hello, this is Pommes Frites restaurant”), which is a translated version of audio 832a. In some embodiments, a first portion of audio 832a has an initial volume corresponding to the current volume setting of computer system 606 (e.g., a max volume), which is reduced to a ducked volume as soon as audio 832b begins being output. In some embodiments, the entirety of audio 832b is output at the volume corresponding to the current volume setting of computer system 606 (e.g., a max volume) because audio 832b is intended for the user of computer system 606. In some embodiments, in conjunction with outputting audio 832b, computer system 606 displays message 832c in transcript region 824a, which is a textual representation of audio 832b (e.g., a translation of audio 832a). In some embodiments, message 832c is displayed in an unexpanded form (e.g., only the English text is displayed) by default because message expansion option 830 has not been selected.

At FIG. 8H, at 00:10 seconds into the live communication session, the computer system receives a spoken English message (e.g., “Hi, I was wondering if I can make a reservation for tonight?”) from the user of computer system 606. In response to receiving the spoken English message, computer system 606 displays message 834a in message transcript region 824a, which is a textual representation of the spoken English message. In some embodiments, message 834a is displayed in an unexpanded form (e.g., only the English text is displayed) by default because message expansion option 830 has not been selected. In some embodiments, in response to receiving the spoken English message, computer system 606 outputs audio 834b at a ducked volume. Audio 834b is a translated version (e.g., French) of the spoken English message that is being output at the external device associated with the restaurant Pommes Frites. At FIG. 8H, computer system 606 detects an input 836 (e.g., a tap input) directed towards message expansion option 830.

At FIG. 8I, in response to receiving input 836, computer system 606 displays an expanded version of message 832c, which includes both textual representation of audio 832a and 832b, and displays an expanded version of message 834a, which includes a textual representation of audio 834b along with the already displayed English text (as shown in FIG. 8H). At FIG. 8I, computer system 606 detects input 840 (e.g., a tap input) directed to option 838a. At FIG. 8J, in response to receiving input 840, computer system 606 displays live phone call menu 842, which includes call translation option 844. At FIG. 8J, computer system 606 detects input 846 (e.g., a tap input) directed to call translation option 844.

At FIG. 8K, in response to detecting input 846, computer system 606 displays change language interface 848 that includes translation option 850 for modifying the language to be translated from (e.g., as shown in FIG. 8Q) and option 852 for modifying the default language to be translated to, during the live communication session.

At FIG. 8L, computer system 606 displays maps interface 854 which includes a visual depiction of a satellite image of Tokyo, Japan. In some embodiments, a location associated with ramen restaurant Ramen Ichiban (e.g., located in Tokyo, Japan) has been selected by the user associated with computer system 606 and, as a result, maps interface 854 includes a variety of selectable options associated with Ramen Ichiban (e.g., directions, call, website, more, etc.). In some embodiments, the variety of selectable options includes call option 854a for initiating a phone call with Ramen Ichiban. At FIG. 8L, computer system 606 detects input 856 (e.g., a tap input) directed to call option 854a.

At FIG. 8M, in response to detecting input 856, computer system 606 displays automatic translation menu 858 (e.g., similar to automatic translation option 818 shown in FIG. 8E). In some embodiments, automatic translation menu 858 is displayed in response to detecting input 856 because the phone number associated with the restaurant Ramen Ichiban corresponds to a geographical region (e.g., has a country code (e.g., +81) associated with Japan) associated with the Japanese language. In some embodiments, automatic translation menu 858 includes option 858a for downloading a Japanese language model, rather than initiating a translated call with Ramen Ichiban, because a Japanese language model has not previously been downloaded onto computer system 606. At FIG. 8M, computer system 606 detects input 860 (e.g., a tap input) directed option 858a. At FIG. 8N, in response to detecting input 860, computer system 606 displays download indication 862, which provides a download status (e.g., 90 MB out of 111 MB) of the language model for Japanese.

FIGS. 80-8Q illustrate an example of a new phone call with an unknown number (e.g., a number not previously stored as a contact in computer system 606 and/or a number that does not have an associated automatic translation setting that was previously used) associated with restaurant Ramen Ichiban, initiated by computer system 606.

At FIG. 80, computer system displays live phone call interface 822b, representing a live communication session between computer system 606 and an unknown number associated with the restaurant Ramen Ichiban. In some embodiments, live phone call interface 822a includes a settings region with a variety of selectable options for managing the live communication session, including option 838b (e.g., “More”), which can be selected to initiate a process for modifying the automatic translation settings of the live communication session. In some embodiments, because the live communication session is with an unknown number, incoming and outgoing audio is not automatically translated by default. At FIG. 80, computer system 606 detects input 840b (e.g., a tap input) directed to option 838b. At FIG. 8P, in response to receiving input 840b, computer system 606 displays live phone call menu 842b, which includes call translation option 844b. At FIG. 8P, computer system 606 detects input 846b (e.g., a tap input) directed to call translation option 844b.

At FIG. 8Q, in response to detecting input 846b, computer system 606 displays change language interface 848b that includes translation option 850b for modifying the language to be translated from and option 852b for modifying the default language to be translated to, during the communication session. At FIG. 8Q, in response to receiving an input directed to option 850b, computer system 606 displays language menu 864, which includes a variety of languages to be used as the language to be translated from during the live communication session (e.g., languages that have language models previously downloaded onto computer system 606 (e.g., French, Spanish, and Japanese). At FIG. 8Q, computer system detects input 866 directed to the option for Japanese in language menu 864. In some embodiments, after detecting input 866, a subsequent input directed to start translation option 868 will cause computer system 606 to begin translating incoming and outgoing audio in the communication session with the unknown number (e.g., outgoing audio in English will be translated to Japanese and incoming audio in Japanese will be translated to English).

FIGS. 8R-8S illustrate an example of a new live video call with a known contact, “Rory” (e.g., a contactable user with a number previously stored as a contact in computer system 606 and/or a number that has an associated automatic translation setting that was previously used).

At FIG. 8R, computer system 606 displays live video call interface 870, representing a live video communication session between computer system 606 and a known number associated with contact Rory. In some embodiments, during the live video communication session, live video call interface 870 includes live video stream 870a transmitted from computer system 606 and live video stream 870b transmitted from an external device associated with contact Rory. In some embodiments, because Rory is a known contact (e.g., has an associated automatic translation setting that was previously used to translate audio received from Rory in previous communication sessions with the user of computer system 606), live video call interface 870 includes automatic translation option 872. In some embodiments, automatic translation option 872 includes language option 872a for Spanish because Spanish was the language previously used to translate audio during a previous communication session with Rory. At FIG. 8R, computer system 606 detects input 874 (e.g., a tap input) directed to language option 872a.

At FIG. 8S, in response to detecting input 874, computer system 606 begins translating incoming audio (e.g., from Spanish to English) and outgoing audio (e.g., from English to Spanish) during the live video call with Rory. At FIG. 8S, computer system 606 receives audio 876a in Spanish from Rory (e.g., [symbol] Hola Lauren! ¿ Como estas? [symbol] Tengo Muchas ganas de ponerme al dia!“). In response to receiving audio 876a, computer system displays message 876b (e.g., ”Hey Jen! How are you? I'm so excited to catch up!), which is an English translation of audio 876a. In some embodiments, message 876b is displayed concurrently with live video streams 870a and 870b. In some embodiments, because audio 876a is being translated during a live video call, rather than a live phone call (e.g., without live video), computer system 606 does not output computer-generated audio corresponding to the English translation of audio 876a.

FIG. 9 is a flow diagram illustrating a method for automatically translating incoming and outgoing audio during a communication session. Method 900 is performed at a computer system (e.g., 100, 300, 500, 600, 606, and/or 694) that is in communication with one or more display generation components (e.g., a display, a touch-screen display, a monitor, a holographic display system, and/or a head-mounted display system), one or more input devices (e.g., a touch-sensitive surface (e.g., a touch-sensitive display), a mouse, a keyboard, a remote control, a visual input device (e.g., one or more cameras such as an infrared camera, a depth camera, a visible light camera, and/or a gaze tracking camera), and/or an audio input device (e.g., a microphone)), and one or more output devices (e.g., speakers, headphones, and/or earbuds).

As described below, method 900 provides an intuitive way for automatically translating incoming and outgoing audio during a communication session. The method reduces the cognitive burden on a user for automatically translating incoming and outgoing audio during a communication session, thereby creating a more efficient human-machine interface. For battery-operated computing devices, enabling a user to automatically translate incoming and outgoing audio during a communication session faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

Performing an operation when a set of conditions has been met without requiring further user input (such as by automatically displaying an option to enable operation of the automatic translation mode based on whether translation criteria is met; automatically providing an option for using a suggested language as the first language during the first communication session; automatically initiating the first communication session when the first suggested language is selected based on whether a respective language model has been downloaded; automatically downloading a respective language model for a suggested language upon selection based on whether the respective language model has been downloaded; automatically providing a suggested language to be translated from based on the current geographical location of the computer system; and automatically display an option to enable automatic translation when the participant is a known participant) enhances the operability of the device by reducing unnecessary inputs and/or steps to navigate through different user interfaces or sets of controls, reducing energy usage by the device.

Providing improved feedback (such as by outputting translated and untranslated audio at different volumes during a first communication session; outputting translated and untranslated audio at durations that overlap during the first communication session; lowering the volume of the first audio when it begins to overlap with the second audio; outputting a translated version of the received audio input the first volume; outputting different audio indications that the first communication session is being translated at different volumes; displaying a first transcript of the communication session that includes a first textual representation of the first audio in the second language; displaying both a first textual representation of the first audio in a first language and a second textual representation of the respective message in the second language; displaying both a live video transmission from the fourth participant as well as a transcript of the live video communication; and outputting translated audio when the computer system is not operating in an automatic translation, but the external device has an automatic translation mode enabled) enhances the operability of the device by reducing accidental and mistaken inputs, reducing energy usage by the device.

Providing additional control options (such as by displaying an option to select a third language that was not suggested; displaying a call log interface that includes an option for initiating a process to download one more language models; providing an option to deactivate the automatic translation mode during the first communication session; providing an option to initiate a process for changing the translation mode during the first communication session; and displaying an option to display the second message transcript without displaying the message transcript in response to receiving the third audio) without cluttering the UI with additional displayed controls enhances the operability of the device by reducing unnecessary inputs and/or steps to navigate through different user interfaces or sets of controls, reducing energy usage by the device.

The computer system (e.g., 606) receives (902), via the one or more input devices, a first set of one or more inputs (e.g., 816 and/or 856) (in some embodiments, the first set of inputs includes a first input that is a selection (e.g., a tap input) of a phone number to initiate an outgoing call; In some embodiments, the phone number is listed in an online website associated the first participant; In some embodiments, the phone number is listed in a maps application as part of a location and/or business associated with the first participant; In some embodiments, the phone number is stored in the contacts of a profile associated with the user of the computer system) to initiate a first communication session (e.g., a live transmission audio and/or video) between a first user associated with the computer system and a first participant associated with an external device (e.g., a phone associated with an individual and/or a business).

In response to receiving the first set of one or more inputs (904) and in accordance with a determination that translation criteria are met, the computer system displays (906), via the one or more display generation components, an option (e.g., 818 and/or 858) (e.g., an affordance and/or selectable graphical user interface object (in some embodiments, the object overlays at least a portion of content that is displayed by the computer system)) to enable operation of an automatic translation mode, wherein selection of the option to enable operation of the automatic translation enables translation of first audio received from the first participant (e.g., enabling the computer system to output a translated version of the first audio, received in a first language (e.g., Spanish, French, German), into a second language (e.g., English)).

In response to receiving the first set of one or more inputs (904) (e.g., 816 and/or 856) and in accordance with a determination that the translation criteria are not met, the computer system (e.g., 606) forgoes (908) displaying the option (e.g., 818 and/or 858) to enable operation of the automatic translation mode.

During the first communication session and while the automatic translation mode is enabled, the computer system (e.g., 606) receives (910) the first audio from the first participant, wherein the first audio is in a first language ((e.g., Spanish, French, German) that is different from a second language (e.g., English) associated with a profile associated with the first user (e.g., an account associated with the user of computer system that was previously established in a phone call application used to facilitate the first communication session (in some embodiments, establishing the account of the user of the computer system in the phone call application includes setting a default language (e.g., English) to be used in the phone call application))).

In response to receiving the first audio (912), the computer system (e.g., 606) outputs (914), via the one or more output devices, the first audio in the first language (e.g., 832a), wherein at least a portion of the first audio (e.g., a portion of the first audio that overlaps with the second audio) is output at a first volume (e.g., a ducked volume (e.g., a volume that has been lowered relative to a current volume setting of the computer system and/or the volume of a second audio output)).

In response to receiving the first audio (912), the computer system (e.g., 606) outputs (916), via the one or more output devices, second audio (e.g., 832b) at a second volume (e.g., a volume that corresponds to the current volume setting of the computer system), different from (e.g., louder than) the first volume, wherein the second audio is in the second language and is a translated version of the first audio.

In some embodiments, the external device has an external phone number and the translation criteria includes a first criterion that is met when the first external phone number corresponds to (e.g., the first external phone number has a country code associated with a foreign language (e.g., a country code associated with Japan (e.g., +91) has an associated foreign language of Japanese) and/or the first external phone number has a regional area code associated with a foreign language (e.g., a regional area code associated with Montreal, Canada (e.g., 514) is associated with a foreign language of French)) a foreign language (e.g., as seen in FIG. 8D) (e.g., a language different from the primary language of the computer system).

In some embodiments, the option to enable operation of an automatic translation mode is an option to select a first suggested language (e.g., 818a and/or 858a) that is identified (e.g., designated) as the first language during the first communication session, wherein the first suggested language is based off a determination that an external phone number of the external device is associated with the first suggested language.

In some embodiments, the determination that the external phone number is associated with the first suggested language is based on a respective geographical region associated with the external phone number (e.g., as seen in FIG. 8D) (e.g., the first external phone number has a country code associated with a foreign language and/or the first external phone number has a regional area code associated with a foreign language).

In some embodiments, in accordance with a determination that a first respective language model (e.g., a database that includes an alphabet of the respective language) for the first suggested language has been downloaded (e.g., transferred to the computer system), the option to select the suggested language (e.g., 818a and/or 858a), when selected (e.g., via a tap input), initiates the first communication session using the first suggested language as the first language and using the downloaded first respective language model.

In some embodiments, in accordance with a determination that a second respective language model (e.g., a database that includes an alphabet of the respective language) for the first suggested language has not been downloaded (e.g., transferred to the computer system), the option to select the first suggested language (e.g., 858a), when selected initiates a download (e.g., 862) of the second respective language model for the first suggested language.

In some embodiments, the option to enable operation of an automatic translation mode (e.g., 818a) is displayed as part of a first user interface (e.g., 818). In some embodiments, the first user interface includes an option (e.g., 818c) that, when selected, causes the display of a third language, different from the first suggested language, that is available to be used as the first language during the first communication session. In some embodiments, selection of the option causes the display of a second use interface with a menu of selectable languages to be used as the first language during the communication session (e.g., including the third language). In some embodiments the menu of selectable languages includes the suggested language.

In some embodiments, the computer system (e.g., 606) displays a call log interface (e.g., 804) (e.g., an interface associated with a call log application that includes log of received and transmitted calls on the computer system) that includes an option (e.g., 806) that, when selected, initiates a process to download one or more language models that can be used as the first language during the first communication session. In some embodiments, the option for initiating the process to download one or more language models is automatically displayed in the call log interface when an associated call log application is opened. In some embodiments, initiating the process to download the one or more language models that can be used as the first language during the communication session is performed before displaying the option to enable operation of the automatic translation mode.

In some embodiments, the computer system (e.g., 606) receives a first input (e.g., 808) corresponding to the option for initiating a process to download one or more language models. In some embodiments, in response to receiving the first input, the computer system (e.g., 606) displays a language download interface (e.g., 810) that includes a suggested language to be translated to (e.g., 810a) (e.g., a primary language of the computer system (e.g., English)) and a suggested language to be translated from (e.g., a foreign language that is not the primary language of the computer system).

In some embodiments, the suggested language to be translated from (e.g., 810a) is based on the current geographical location of the computer system (e.g., based on a determination (e.g., using GPS data associated with the computer system) that the computer system is in a location (e.g., within the geographical boundaries of a country and/or region) associated with a foreign language).

In some embodiments, the suggested language to be translated from is a selectable option (e.g., 810a) that, when selected (e.g., via a tap input), causes a download (e.g., 810b) of a language model associated with the suggested language to be translated from (e.g., transferred to the computer system).

In some embodiments, the language download interface (e.g., 810) includes a plurality (e.g., more than one) of options for languages to be translated from, and wherein the plurality of options for languages to be translated from have a plurality of respective language models that are available to be downloaded. In some embodiments, the plurality of options for languages to be translated from are selectable options that, when selected, causes a language model associated with the selected language option to be downloaded.

In some embodiments, the first audio (e.g., 832a) and the second audio (e.g., 832b) overlap (e.g., overlap in time such that a portion of the first audio is played while a portion of the second audio is also played at the same time). In some embodiments, the start of the first audio is offset from (e.g., occurs before) the start of the second audio.

In some embodiments, the first audio (e.g., 832a) has a first audio portion that does not overlap with the second audio and the first audio has a second audio portion that begins when the first audio overlaps with the second audio (e.g., 832b). In some embodiments, the first audio potion is output at a third volume (e.g., corresponding to a current output volume setting of the computer system) that is louder than the first volume (e.g., a ducked volume). In some embodiments, the second audio portion is output at the first volume.

In some embodiments, the second volume is a volume corresponding to a current output volume setting of the computer system.

In some embodiments, the computer system (e.g., 606) receives, via the one or more input devices, an audio input (e.g., speech) from the user in the second language. In some embodiments, in response to receiving the audio input, the computer system (e.g., 606) outputs third audio (e.g., 834b) in the first language at the first volume (e.g., a ducked volume (e.g., a volume that has been lowered relative to a current volume setting of the computer system and/or the volume of a second audio output)), wherein the third audio in the first language is a translated version of the audio input.

In some embodiments, during the first communication session and while the automatic translation mode is enabled and prior to receiving the first audio from the first participant, the computer system (e.g., 606) outputs first audio (e.g., a voice prompt generated by the computer system) indicating that the first communication session is being translated (e.g., 826b), wherein the first audio indicating that the first communication session is being translated is output in the second language (e.g., English) at the second volume. In some embodiments, during the first communication session and while the automatic translation mode is enabled and prior to receiving the first audio from the first participant, the computer system (e.g., 606) outputs second audio (e.g., a voice prompt generated by the computer system) indicating that the first communication session is being translated (e.g., 828b), wherein the second audio indicating that the first communication session is being translated is output in the first language (e.g., French) at the first volume (e.g., a ducked volume).

In some embodiments, the first audio indicating that the first communication session is being translated (e.g., 826b) includes first content and the second audio indicating that the first communication session is being translated (e.g., 828b) includes second content that is different from the first content.

In some embodiments, the computer system (e.g., 606) receives, via the one or more input devices, a second set of one or more inputs to initiate a communication session between the first user and a second participant (e.g., Rory as seen in FIG. 8R). In some embodiments, in response to receiving the second set of one or more inputs, the computer system initiates the communication session between the first user and the second participant. In some embodiments, in response to receiving the second set of one or more inputs and in accordance with a determination that the second participant is a known participant (e.g., Rory) (e.g., a contactable user with contact information stored in the computer system) that is associated with a language that was used to translate previous audio received from the second participant (e.g., during a previous communication session), the computer system (e.g., 606) displays an option (e.g., 872a) to enable a second automatic translation mode that, when selected, enables translation of audio received from the second participant. In some embodiments, the option to enable a second automatic translation mode will provide a suggested language to be translated from based on a determination that the suggested language was previously used to translate audio during a prior communication session with the second participant.

In some embodiments, the computer system (e.g., 606) receives, via the one or more input devices, a third set of one or more inputs to initiate a communication session between the first user and a third participant (e.g., Ramen Ichiban as seen in FIG. 80), wherein the third participant is an unknown participant (e.g., a participant with a contact number that has not been stored in the computer system). In some embodiments, in response to receiving the third set of one or more inputs, the computer system (e.g., 606) initiates the communication session between the first user and the third participant (e.g., Ramen Ichiban). In some embodiments, during the communication session between the first user and the third participant, the computer system displays, via the one or more display generation components, a first selectable user interface object (e.g., 838b) that, when selected, initiates a process for enabling translation of audio received from the third participant.

In some embodiments, during the communication session between the first user and the third participant (e.g., Ramen Ichiban) the computer system (e.g., 606) receives, via the one or more input devices, a fourth set of one or more inputs (e.g., 840b, 846b, and/or a selection of option 850b) that includes an input (e.g., 840b) corresponding to the first selectable user interface object. In some embodiments, in response to receiving the fourth set of one or more inputs, the computer system (e.g., 606) displays a language confirmation interface (e.g., 864) that includes a suggested language (e.g., Japanese, Spanish, and/or French) that can be used to translate the audio received from the third participant.

In some embodiments, during the first communication session and while the automatic translation mode is enabled, the computer system displays, via the one or more display generation components, a first transcript (e.g., 824a) of the first communication session (a textual representation of incoming and outgoing audio during the communication session) that includes a first textual representation (e.g., 832c) (e.g., a text translation) of the first audio in the second language.

In some embodiments, the transcript of the first communication session includes (e.g., concurrently displays with the first textual representation) an option (e.g., 830) (e.g., a selectable GUI object) for modifying a visual appearance of the transcript of the communication session that, when selected, causes the display of a second textual representation (e.g., 832c as seen in FIG. 8I) of the first audio in the first language, wherein the first textual representation and the second textual representation are concurrently displayed. In some embodiments, in accordance with a determination that the second textual representation and first textual representation are concurrently displayed, selection of the option for modifying the visual appearance of the transcript removes the display of the second textual representation in the transcript of the communication session.

In some embodiments, during the first communication session and while the automatic translation mode is enabled, the computer system (e.g., 606) concurrently displays, via the one or more display generation components, a transcript of the communication session (e.g., 824a) and an option to deactivate the automatic translation mode (e.g., “Stop translation” as seen in FIG. 8F). In some embodiments, deactivating the automatic translation mode will stop the display of respective text translations of incoming audio in the message transcript. In some embodiments deactivating the automatic translation mode will stop outputting translated audio in response to receiving respective audio in a first language. In some embodiments, deactivating the automatic translation mode will not automatically stop the communication session.

In some embodiments, during the first communication session and while the automatic translation mode is enabled, the computer system (e.g., 606) displays, via the one or more display generation components, a second selectable user interface object (e.g., 838a) that, when selected, initiates a process for changing a translation model used to translate the first audio received from the first participant. In some embodiments, during the first communication session and while the automatic translation mode is enabled, the computer system (e.g., 606) receives, via the one or more input devices, an input (e.g., 840a) corresponding to the second selectable user interface object (e.g., 838a). In some embodiments, during the first communication session and while the automatic translation mode is enabled and in response to receiving the third input (e.g., 840a), the computer system (e.g., 606) initiates the process for changing the translation model used to translate the first audio received from the first participant (e.g., as seen in FIGS. 8J and 8K).

In some embodiments, the computer system (e.g., 606) receives, via the one or more input devices, a set of one or more inputs to initiate a live video communication session between the first user and a fourth participant (e.g., Rory as shown in FIGS. 8R and 8S). In some embodiments, in response to receiving the one or more inputs to initiate a live video communication session between the first user and the fourth participant, the computer system initiates the live video communication session. In some embodiments, during the live video communication session, the computer system (e.g., 606) receives audio (e.g., 876a) from the fourth participant in a fourth language (e.g., Spanish). In some embodiments, during the live video communication session, the computer system (e.g., 606) displays, via the one or more display generation components, a live video transmission (e.g., 870b) from the fourth participant and a transcript of the live video communication session that includes a textual representation (e.g., 876b) of the audio from the fourth participant in a fifth language, wherein the fifth language is a translated version of the fourth language. In some embodiments, translated audio of the fifth audio is not output during the live video communication session.

In some embodiments, during the first communication session and while the automatic translation mode is not enabled, the computer system (e.g., 606) receives third audio from the first participant in the first language. In some embodiments, in response to receiving the third audio and in accordance with a determination that a second automatic translation mode is currently operating on the external device, the computer system (e.g., 606) outputs, via the one or more output devise, fourth audio in the second language and forgoes displaying a second message transcript of the first communication session.

In some embodiments, in response to receiving the third audio and in accordance with a determination that the second automatic translation mode is currently operating on the external device, the computer system (e.g., 606) displays, via the one or more display generation components, an option to display the second message transcript of the first communication session.

In some embodiments, the second audio (e.g., 832b) in the second language is generated by the computer system (e.g., based on respective language model used to translated the first audio in the first language).

Note that details of the processes described above with respect to method 900 (e.g., FIG. 9) are also applicable in an analogous manner to the methods described above/below. For example, methods 700, 1100, and/or 1300 optionally include one or more of the characteristics of the various methods described above with reference to method 900. For example, the computer system of method 900 can be the same computer system that performs methods 700, 1100, and/or 1300. For another example, the process for downloading various language models to be used for automatically translating messages in method 700 can be used to facilitate the translation of audio communication sessions in method 900. For another example, the process for displaying an option for sharing a representation of the user in method 1100 can be performed in the same live communication interfaces described in method 900. For brevity, these details are not repeated below.

FIGS. 10A-10J illustrate exemplary methods for opening an application and displaying a user interface that does not initially show an option for sharing a user's representation with one or more contacts, and receiving an input to display the option, which can be selected to display a user interface for selecting a representation of the user of the computer system to be shared with other contacts.

FIG. 10A illustrates computer system 606. At FIG. 10A, computer system 606 displays home interface 1004, which includes various selectable icons for opening applications associated with computer system 606, including icon 1004a (e.g., an icon for opening a messaging application), icon 1004b (e.g., an icon for opening a live video call application), and icon 1004c (e.g., an icon for opening a call log application). At FIG. 10A, computer system 606 detects input 1006a (e.g., a tap input) directed to icon 1004a. In some embodiments, computer system 606 detects input 1006b (e.g., a tap input) directed to icon 1004b for opening a live video call application (e.g., as shown in FIG. 10F). In some embodiments, computer system 606 detects input 1006c (e.g., a tap input directed to icon 1004c for opening a call log application (e.g., as shown in FIG. 10I). In some embodiments, user inputs 1006a, 1006b, 1006c, and other user inputs described in FIGS. 10A-10J can be touch inputs (e.g., tap inputs, long press inputs, and/or swipe inputs), air gestures, and/or gaze-based inputs.

At FIG. 10B, in response to detecting input 1006c, computer system 606 displays messaging interface 1008, which includes various message threads (e.g., previews of the last message received or sent in a respective message conversation) between the user of computer system 606 and one or more contacts. At FIG. 10B, computer system 606 detects input 1010 (e.g., a downward swipe input) directed to messaging interface 1008. In some embodiments, input 1010 can be directed to any portion of messaging interface 1008.

At FIG. 10C, in response to detecting input 1010, computer system 606 displays sharing option 1012a, which is an option for sharing a name and photo of the user of computer system 606 with one or more contacts. Sharing option 1012a is displayed at the top of messaging interface 1008 and is displayed concurrently with the various message threads. In some embodiments, in response to detecting input 1010, computer system 606 displays message bar 1018 for performing a keyword search across the variety of message threads in messaging interface 1008. In some embodiments, message bar 1018 is displayed at the bottom of messaging interface 1008 and concurrently with sharing option 1012a and the variety of message threads. In some embodiments, sharing option 1012a was not displayed when the messaging application was first opened because a sharing name and photo mode (e.g., a mode that, when activated, causes the name and visual representation (e.g., a photo and/or avatar) of the user of computer system 606 to be displayed on one or more external devices associated with one or more contacts, such that the one or more contacts can attribute the displayed name and visual representation to their contact information associated with the user of computer system 606) was previously activated before computer system 606 detected input 1006c. In some embodiments, sharing option 1012a is displayed when the messaging application is first opened if the sharing name and photo mode is not activated at the time computer system 606 detects input 1006c. At FIG. 10C, computer system 606 detects input 1014 (e.g., a tap input) directed to sharing option 1012a. In some embodiments, at FIG. 10C, computer system 606 detects input 1016 (e.g., an upward swipe input) directed to messaging interface 1008 that causes computer system 606 to cease displaying sharing option 1012a and message bar 1018 (e.g., as shown in FIG. 10B).

At FIG. 10D, in response to detecting input 1014, computer system 606 displays sharing interface 1020a. At FIG. 10D, avatar option 1022 is currently selected and, as a result, sharing interface 1020a displays a variety of options for sharing an avatar of the user of computer system 606 with one or more contacts. At FIG. 10D, computer system 606 detects input 1026 (e.g., tap input) directed to poster option 1024.

At FIG. 10E, in response to detecting input 1026, computer system 606 displays sharing interface 1020 with an indication that poster option 1024 is currently selected. In some embodiments, when poster option 1024 is selected, sharing interface 1020 displays a variety of options for sharing a poster (e.g., photos to be used as a background image) of the user of computer system 606 with one or more contacts.

At FIG. 10F, in response to detecting input 1006b (e.g., as shown in FIG. 10A), computer system 606 displays live video call interface 1028. In some embodiments, live video call interface 1028 is being used to facilitate a live video communication session with the user of computer system 606 and multiple participants. In some embodiments, during the live video communication session, live video call interface 1028 includes live video feeds from computer system 606 and from external devices associated with the multiple participants. At FIG. 10F, computer system 606 detects input 1030 (e.g., a downward swipe input) directed to live video call interface 1028. In some embodiments, input 1030 can be directed to any portion of live video call interface 1028.

At FIG. 10G, in response to detecting input 1030, computer system 606 displays sharing option 1012b, which is an option for sharing a name and photo of the user of computer system 606 with one or more contacts (e.g., same as option 1012a in FIG. 10C). At FIG. 10G, computer system 606 detects input 1032 (e.g., a tap input) directed to sharing option 1012b. At FIG. 10H, in response to detecting input 1032, computer system 606 displays sharing interface 1020b (e.g., the same as sharing interface 1020a in FIG. 10D).

At FIG. 10I, in response to detecting input 1006c (e.g., as shown in FIG. 10A), computer system 606 displays call log interface 1034, which includes log of recent incoming and outgoing calls received and transmitted by computer system 606. At FIG. 10I, computer system 606 detects input 1036 (e.g., a downward swipe input) directed to call log interface 1034. In some embodiments, input 1036 can be directed to any portion of call log interface 1034.

At FIG. 10J, in response to detecting input 1036, computer system 606 displays sharing option 1012c, which is an option for sharing a name and photo of the user of computer system 606 with one or more contacts (e.g., same as option 1012a in FIG. 10C and option 1012b in FIG. 10G). At FIG. 10J, computer system 606 detects input 1038 (e.g., a tap input) directed to sharing option 1012c that, when selected, causes the display of a sharing interface (e.g., sharing interfaces 1020a and/or 1020b as shown in FIGS. 10D and 10H). In some embodiments, at FIG. 10J, computer system 606 detects input 1040 (e.g., a upward swipe input) directed to call log interface 1034 that, when selected, causes computer system 606 to cease displaying sharing option 1012c (e.g., as shown in FIG. 10I).

FIG. 11 is a flow diagram illustrating a method for displaying an option for sharing a user's representation with one or more contacts. Method 1100 is performed at a computer system (e.g., 100, 300, 500, 600, 606, and/or 694) e.g., a smartphone, a smartwatch, a tablet, personal computer and/or a head mounted device) that is in communication with one or more display generation (e.g., a display, a touch-screen display, a monitor, a holographic display system, and/or a head-mounted display system) components and one or more input devices (e.g., a touch-sensitive surface (e.g., a touch-sensitive display), a mouse, a keyboard, a remote control, a visual input device (e.g., one or more cameras such as an infrared camera, a depth camera, a visible light camera, and/or a gaze tracking camera), and/or an audio input device (e.g., a microphone)).

As described below, method 1100 provides an intuitive way for displaying an option for sharing a user's representation with one or more contacts. The method reduces the cognitive burden on a user for displaying an option for sharing a user's representation with one or more contacts, thereby creating a more efficient human-machine interface. For battery-operated computing devices, enabling a user to display an option for sharing a user's representation with one or more contacts faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

Performing an operation when a set of conditions has been met without requiring further user input (such as by automatically displaying the third option in response to receiving the third set of one or more inputs when a second mode of operation for sharing the one or more representations of the first user was previously enabled; and ceasing to display the first option in response to a second swipe input in a second direction) enhances the operability of the device by reducing unnecessary inputs and/or steps to navigate through different user interfaces or sets of controls, reducing energy usage by the device.

Providing additional control options (such as by displaying a first option for initiating a process to share a representation of the first user with the one or more contacts in response to receiving the first input, wherein the first option was not displayed prior to receiving the first input; displaying a second option for initiating a process to share a representation of the first user with the one or more accounts in response to receiving the second input; displaying both the first option and one or more message threads in the first user interface; displaying both the first option and the search bar in the first user interface; and concurrently displaying the first option with the one or more representations of the live video transmissions) without cluttering the UI with additional displayed controls enhances the operability of the device by reducing unnecessary inputs and/or steps to navigate through different user interfaces or sets of controls, reducing energy usage by the device.

The computer system (e.g., 606) receives (1102), via the one or more input devices, a first set of one or more inputs (e.g., 1006a, 1006b, and/or 1006c) corresponding to a first application (e.g., an application (e.g., a messaging application, live video phone call application, and/or a phone call log application) enabled to access contacts (e.g., stored phone numbers of external devices associated with individuals and/or businesses) associated with a profile of the user of the computer system). In response to receiving the first set of one or more inputs, the computer system (e.g., 606) displays (1104), via the one or more display generation components, a first user interface (e.g., 1008, 1028, and/or 1034) associated with the first application.

The computer system (e.g., 606) receives (1106), via the one or more input devices, a first input (e.g., 1010) (e.g., a swipe gesture) directed to the first user interface (e.g., 1008) (in some embodiments, the first input can be directed to any portion of the first user interface). In response to receiving the first input, the computer system (e.g., 606) displays (1108) a first option (e.g., 1012a) (e.g., an affordance and/or selectable graphical user interface object) for initiating a process to share a first representation (e.g., a photo, avatar (e.g., a customized, anthropomorphized, and/or animated graphical representation of the user)) of a first user associated with the computer system with one or more contacts (e.g., one or more contactable users) (in some embodiments, selecting the option enables the one or more contacts to display the representation of the first user in various applications), wherein the first option (e.g., 1012a) was not displayed prior to receiving the first input.

The computer system (e.g., 606) receives (1110), via the one or more input devices, a second input (e.g., 1014) corresponding to a selection (e.g., a tap gesture) of the first option (e.g., 1012a). In response to receiving the second input (e.g., 1014), the computer system (e.g., 606) displays (1112) one or more representations of the first user that are available to be shared with the one or more contacts (e.g., as shown in FIG. 10D).

In some embodiments, the computer system (e.g., 606) receives, via the one or more input devices, a second set of one or more inputs (e.g., 1004b) corresponding to a second application that is different from the first application (e.g., a messaging application). In some embodiments, in response to receiving the second set of one or more inputs, the computer system (e.g., 606) displays, via the one or more display generation components, a second user interface (e.g., 1028) associated with the second application (e.g., a live video phone call application).

In some embodiments, the computer system (e.g., 606) receives, via the one or more input devices, a second input (e.g., 1030) (e.g., swipe gesture) directed to the second user interface (e.g., 1028) (in some embodiments, the first input can be directed to any portion of the first user interface). In some embodiments, in response to receiving the second input, the computer system (e.g., 606) displays a second option (e.g., 1012b) (e.g., an affordance and/or selectable graphical user interface object) for initiating the process to share the first representation (e.g., a photo, avatar (e.g., a customized, anthropomorphized, and/or animated graphical representation of the user)) of the first user associated with the computer system with the one or more contacts (e.g., one or more contactable users) (in some embodiments, selecting the option enables the one or more contacts to display the representation of the first user in various applications) (in some embodiments, the second option was not displayed prior to receiving the second input).

In some embodiments, the computer system (e.g., 606) receives, via the one or more input devices, a third input (e.g., 1032) corresponding to a selection (e.g., a tap gesture) of the second option (e.g., 1012b). In some embodiments, in response to receiving the third input, the computer system (e.g., 606) displays the one or more representations of the first user that are available to be shared with the one or more contacts (e.g., as shown in FIG. 10H).

In some embodiments, the computer system (e.g., 606) receives, via the one or more input devices, a third set of one or more inputs (e.g., 1006c, 1006b, and/or 1006c) corresponding to the first application. In some embodiments, in response to receiving the third set of one or more inputs and in accordance with a determination that a first mode of operation (e.g., a mode of operation for allowing the user to share a representation with the one or more contacts was previously activated) for sharing the one or more representations of the first user with the one or more contacts was not previously enabled, the computer system (e.g., 606) displays, via the one or more display generation components, a third user interface (e.g., 1008, 1028, and/or 1034) associated with the first application, wherein the third user interface includes a third option (e.g., 1012a, 1012b, and/or 1012c) for initiating a process to share a second representation (e.g., a photo, avatar (e.g., a customized, anthropomorphized, and/or animated graphical representation of the user)) of the first user with the one or more contacts (e.g., one or more contactable users). In some embodiments, selecting the third option enables the one or more contacts to display the representation of the first user in various applications. In some embodiments, initiating the process to share a second representation of the first user with the one or more contacts allows the user to change a representation that's currently being shared with the one or more contacts (e.g., the first representation) with a different representation (e.g., the second representation). In some embodiments, in response to receiving the third set of one or more inputs and in accordance with a determination that the first mode of operation for sharing the one or more representations of the first user with the one or more contacts was previously enabled, the computer system (e.g., 606) displays, via the one or more display generation components, the third user interface (e.g., 1008, 1028, and/or 1034) associated with the first application, wherein the third user interface does not include the third option e.g., 1012a, 1012b, and/or 1012c) for initiating the process to share the second representation of the first user with the one or more contacts. In some embodiments, previously enabling the first mode of operation did not initiate and/or complete the process to share the representation with the one or more contacts. In some embodiments, in accordance with a determination that the first mode of operation for sharing the one or more representation of the first user with the one or more contacts was previously enabled, receiving an input (e.g., a swipe gesture) directed to the third user interface causes the display of the third option for initiating the process to share the second representation of the first user with the one or more contacts.

In some embodiments, initiating the process to share the first representation of the first user with the one or more contacts includes displaying, via the one or more display generation components, a representation sharing interface (e.g., 1020a), wherein the representation sharing interface includes automatically generated suggested representations (e.g., suggestions for representations of the first user that are based data associated with the first user and/or representations that the user has previously interacted with (e.g., used in the first application and/or a different application associated with the computer system)) that can be selected as the first representation of the first user to be shared with the one or more contacts.

In some embodiments, the first application is a messaging application (e.g., as shown in FIG. 10B) (e.g., an application used to send messages (e.g., text, audio, and/or video messages) to contactable uses).

In some embodiments, the first application includes one or more message threads (e.g., as seen in FIG. 10C) (e.g., representations of ongoing message conversations that are selectable to display a respective message transcript associated with the selected message thread) and the first option (e.g., 1012a) for initiating the process to share the first representation of the first user with the one or more contacts is displayed above the one or more message threads.

In some embodiments, in response to receiving the first input, the computer system (e.g., 606) displays a search bar (e.g., 1018) (e.g., a text input field that can be used to search key words associated with the one or more message threads of the first application) at a bottom portion of the first user interface (e.g., 1008) (e.g., below the display of the one or more message threads). In some embodiments the search bar is displayed at the bottom portion of the user interface by default (e.g., in response to receiving the first set of one or more inputs corresponding to the first application).

In some embodiments, the first application is a phone call log application (e.g., as shown in FIG. 10I) (e.g., an application for viewing a log of incoming and outgoing phone calls received and transmitted on the computer system).

In some embodiments, the first application is a live video communication application (e.g., as shown in FIG. 10F) for initiating a live video communication session with one or more participants (e.g., contactable users), wherein the one or more participants exchange live video transmissions (e.g., live video corresponding to the one or more participants is displayed in the first interface) and live audio transmissions during the live video communication session.

In some embodiments, the first interface (e.g., 1028) includes one or more representations of live video transmissions from the one or more participants, and wherein the first option (e.g., 1012b) for initiating the process to share the first representation of the first user with the one or more contacts is concurrently displayed with the one or more representations of the live video transmissions from the one or more participants.

In some embodiments, the first input (e.g., 1010, 1030, and/or 1036) is a first swipe input in a first direction (e.g., a downward direction).

In some embodiments, the computer system (e.g., 606) receives, via the one or more input devices, a second swipe input (e.g., 1016 and/or 1040) in a second direction (e.g., an upward direction), different from the first direction, directed to the first user interface. In some embodiments, in response to receiving the second swipe input (e.g., 1016 and/or 1040), the computer system ceases to display the first option (e.g., 1012a and/or 1012c) for initiating a process to share a representation of the first user with the one or more contacts. In some embodiments, if a search bar is displayed in a bottom portion of the first user interface in response to receiving the first swipe input, receiving the second swipe input will cease the display of the search bar.

Note that details of the processes described above with respect to method 1100 (e.g., FIG. 11) are also applicable in an analogous manner to the methods described above. For example, methods 700, 900, and/or 1300 optionally include one or more of the characteristics of the various methods described above with reference to method 1100. For example, the computer system of method 1100 can be the same computer system that performs methods 700, 900, and/or 1300. For brevity, these details are not repeated below.

FIGS. 12A-12N illustrate exemplary methods for configuring a custom user representation for sharing with one or more contacts. At FIG. 12A, computer system 606 displays sharing option 1202, an option for sharing a name and photo of the user of computer system 606 with one or more contacts, within messaging interface 1008. For example, as described with respect to FIG. 11 and sharing options 1012a-1012c in FIGS. 10C, 10G, and/or 10J, computer system 606 displays sharing option 1202 because the sharing name and photo mode (e.g., the mode that, when activated, causes the name and visual representation of the user of computer system 606 to be displayed on one or more external devices associated with one or more contacts) is not currently activated and/or in response to a particular input detected within messaging interface 1008 (e.g., a downward swipe, such as input 1010). At FIG. 12A, computer system 606 detects input 1204 directed to sharing option 1202.

At FIG. 12B, in response to detecting input 1204, computer system 606 displays sharing interface 1206a, a user interface for selecting and customizing a graphical component of a custom representation of the user of computer system 606 to be shared in the sharing name and photo mode. As illustrated in FIG. 12B, sharing interface 1206a includes avatar option 1022 and poster option 1024 (e.g., as described with respect to FIGS. 10D-10E, above), which correspond to two different graphical representation formats available for the sharing name and photo mode. For example, as illustrated in FIGS. 10D-10E, above, avatar option 1022 corresponds to a smaller, circular graphical representation format (e.g., such as the contact icons displayed next to the message threads in messaging interface 1008), and poster option 1024 corresponds to a larger, rectangular graphical representation format (e.g., such as the contact images shown in the top bar of call log interface 1034 in FIGS. 10I-10J). At FIG. 12B, avatar option 1022 is selected by default when sharing user interface 1206a is displayed in response to detecting input 1204; in other embodiments, poster option 1024 is selected by default.

Sharing interface 1206a includes category options 1208a-1208d and a plurality of suggested graphical representations 1210a. In some embodiments, suggested graphical representations 1210a include automatically-generated suggestions, which computer system 606 generates based on data associated with the user of computer system 606, such as the user's name, graphical representations previously used by the user (e.g., in a custom pictogram keyboard), and/or photos from the user's media library. Because avatar option 1022 is selected, category options 1208a-1208d represent categories (e.g., types) of graphical representations available for the avatar format, including monograms (e.g., category option 1208a), personalized characters (e.g., category option 1208b), photos (e.g., category option 1208c), and standard pictograms (e.g., category option 1208d), and suggested graphical representations 1210a are avatar graphical representations. Additionally, sharing interface 1206a includes cancel option 1212 for exiting sharing interface 1206a without activating the sharing name and photo mode and confirm option 1214 for confirming selection of a particular customized graphical representation for the sharing name and photo mode. As illustrated in FIG. 12B, because the user has not yet selected a customized graphical representation, confirm option 1214 is grayed out, indicating that the option is not currently available.

At FIG. 12B, computer system 606 detects one or more inputs (e.g., inputs 1216a-1216f) for customizing a graphical component of a custom representation for the sharing name and photo mode. For example, in response to detecting input 1216a, directed to one of the plurality of suggested graphical representations 1210a, computer system 606 selects the pictured avatar (e.g., a personalized robot character on a solid-color background) as one graphical component of the custom representation to be shared in the sharing name and photo mode. In response to detecting input 1216b, directed to poster option 1024, computer system 606 updates sharing interface 1206a to include category options and suggested graphical representations for the poster format, as shown and described below with respect to FIG. 12G. In response to detecting an input directed to one of category options 1208a-1208d (e.g., inputs 1216c-1216f, respectively), computer system 606 displays a sub-interface for customizing an avatar representation of the selected category (e.g., type), as shown and described below with respect to FIGS. 12C-12F.

At FIG. 12C, in response to detecting input 1216c directed to category option 1208a for the monogram category, computer system 606 displays sub-interface 1218 for customizing a monogram representation in the avatar format. As illustrated in FIG. 12C, sub-interface 1218 includes preview 1218a, which initially displays a preview of a monogram avatar with a default or automatically-generated configuration (e.g., the monogram “BC,” generated based on the first initials of the user of computer system 606's first and last names) and updates based on user-selected configuration options. Sub-interface 1218 includes customization options 1218b-1218d, which represent different options for customizing features of a monogram avatar, including customizing the text (e.g., customization option 1218b), changing font settings for the monogram (e.g., customization option 1218c), and changing a background color for the monogram (e.g., customization option 1218d). For example, in response to detecting an input directed to one of customization options 1218b-1218d (e.g., inputs 1220a-1220c), computer system 606 displays a sub-interface with controls for changing the corresponding feature of the monogram avatar, such as described below with respect to FIG. 12D. Additionally, sub-interface 1218 includes a plurality of suggested monogram representations 1218e (e.g., automatically-generated suggestions of different monograms in the avatar format). For example, in response to detecting an input directed to one of the plurality of suggested monogram representations 1218e (e.g., input 1220d), computer system 606 selects the pictured monogram avatar as a graphical component of the customized representation and updates preview 1218a to show the currently-selected monogram avatar. Finally, sub-interface 1218 includes cancel option 1218f for returning to sharing interface 1206a without selecting a monogram representation and confirm option 1218g for confirming selection of a monogram representation as currently shown in preview 1218a as a graphical component of the custom representation of the user of computer system 606 (e.g., and returning to sharing interface 1206a or proceeding to sharing interface 1206b, as described below with respect to FIG. 12H).

At FIG. 12D, in response to detecting input 1220a directed to customization option 1218b, computer system 606 displays sub-interface 1222 for customizing text included in a monogram representation in the avatar format. As illustrated in FIG. 12D, sub-interface 1222 includes virtual keyboard 1222a for entering text, cancel option 1222b for returning to sub-interface 1218, and confirm option 1222c for confirming selection of the monogram text currently shown in preview 1218a for a monogram representation. In response to detecting input 1224a, one or more typing inputs directed to virtual keyboard 1222a entering the custom text “BB,” computer system 606 updates preview 1218a to display the monogram avatar with the custom text. In some embodiments, sub-interface 1222 accepts custom text with a different number of characters than used by default. For example, although the initial (e.g., default/automatically-generated) monogram, “BC,” included two characters, sub-interface 1222 allows the user to enter as little as one character and as much as four characters (e.g., or another range of numbers of characters) for a customized monogram avatar. In response to detecting input 1224b directed to confirm option 1222c, computer system 606 saves “BB” as the monogram text, for example, returning to sub-interface 1218 and updating the plurality of suggested monogram representations 1218e to use the text “BB” instead of “BC.” Likewise, in response to detecting inputs directed to the other customization options (e.g., customization options 1218c-1218d) in sub-interface 1218, computer system 606 displays sub-interfaces with appropriate controls for the corresponding customization option (e.g., a typeface menu and/or font size slider for customization option 1218c; and/or a preselected color palette and/or color picker for customization option 1218d).

At FIG. 12E, in response to detecting input 1216d directed to category option 1208b for the personalized character category (e.g., as illustrated in FIG. 12B), computer system 606 displays sub-interface 1226 for customizing a personalized character representation in the avatar format. As illustrated in FIG. 12E, sub-interface 1226 includes preview 1226a, which initially displays a preview of a personalized character avatar (e.g., with a default or automatically-generated configuration, such as a cartoon robot character) and updates based on user-selected configuration options. Sub-interface 1226 includes customization options 1226b-1226d, which represent different options for customizing features of a personalized character avatar, including: customizing a character, pose, and/or expression of the character (e.g., customization option 1226b); changing the framing of the character within the avatar format (e.g., customization option 1226c); and changing a background color for the character (e.g., customization option 1226d). For example, in response to detecting an input directed to one of customization options 1226b-1226d (e.g., inputs 1228a-1228c), computer system 606 displays a sub-interface with controls for changing the corresponding feature of the character avatar, such as described below with respect to FIG. 12F. Additionally, sub-interface 1226 includes a plurality of suggested character representations 1226e (e.g., automatically-generated suggestions of different characters in the avatar format). For example, in response to detecting an input directed to one of the plurality of suggested character representations 1226e (e.g., input 1228d), computer system 606 selects the respective character avatar as a component of the customized graphical representation and updates preview 1226a to show the currently-selected character avatar. Finally, sub-interface 1226 includes cancel option 1226f for returning to sharing interface 1206a without selecting a character representation and confirm option 1226g for confirming (e.g., via input 1228e) selection of a character representation as currently shown in preview 1226a as a graphical component of the custom representation of the user of computer system 606 (e.g., and returning to sharing interface 1206a or proceeding to sharing interface 1206b, as described below with respect to FIG. 12H). Similarly to sub-interface 1218 and sub-interface 1226, in response to detecting inputs directed to category option 1208c and/or category option 1208d in sharing interface 1206a, computer system 606 displays sub-interfaces with customization options (e.g., options for selecting a photo, cropping a photo, and/or filtering a photo for category option 1208c; options for selecting a pictogram and/or selecting a background color for category option 1208d) and suggested graphical representations for the corresponding category.

At FIG. 12F, in response to detecting input 1228a directed to customization option 1226b, computer system 606 displays sub-interface 1230 for customizing the character type, expression, and/or pose used for a personalized character representation in the avatar format. As illustrated in FIG. 12F, sub-interface 1230 includes camera option 1230a for changing an expression and/or pose of the personalized character using a camera input. For example, in response to detecting input 1232a directed to camera option 1230a, computer system 606 begins to capture camera data using a user-facing camera (e.g., a camera pointing out from the surface of computer system 606 that includes the display) and displays a preview of a personalized character with a facial expression and/or pose (e.g., head, neck, shoulder, and/or hand pose) based on a facial expression and/or pose of the user detected using the user-facing camera. Additionally, sub-interface 1230 includes expression options 1230b for selecting between a plurality of preset facial expressions for the character and character options 1230c for selecting between a plurality of character types (e.g., different cartoon humans, animals, and/or humanoid characters). For example, in response to detecting input 1232b directed to one of expression options 1230b, computer system 606 updates the facial expression of the character representation displayed in preview 1226a to have the facial expression shown in the respective expression option, and in response to detecting input 1232c directed to one of character options 1230c, computer system 606 updates the type of the character representation displayed in preview 1226a to the selected character type. In response to detecting input 1232d directed to confirm option 1230e, computer system 606 saves the currently-selected character type, expression, and pose for the character avatar (e.g., returning to sub-interface 1226). Likewise, in response to detecting inputs directed to the other customization options (e.g., 1226c-1226d) in sub-interface 1226, computer system 606 displays sub-interfaces with appropriate controls for the corresponding customization option (e.g., a cropping tool for customization option 1226c; a preselected color palette and/or color picker for customization option 1226d).

At FIG. 12G, in response to detecting input 1216b directed to poster option 1024 for the personalized character category (e.g., as illustrated in FIG. 12B), computer system 606 displays sharing interface 1206a with category options 1208e-1208g and suggested graphical representations 1210b. As illustrated in FIG. 12G, because poster option 1024 is selected, category options 1208e-1208g represent categories of graphical representations available for the poster format, including monograms (e.g., category option 1208e), personalized characters (e.g., category option 1208f), and photos (e.g., category option 1208g) and suggested graphical representations 1210b are poster graphical representations. In some embodiments, the poster format is compatible with different categories of graphical representations than the avatar format. For example, as illustrated in FIG. 12G, computer system 606 does not display a category option for a standard pictogram (e.g., an emoji) to use as a larger-format graphical component of the custom representation. As described with respect to FIGS. 12B-12F, in response to detecting inputs directed to category options 1208e-1208g (e.g., inputs 1234a-1234c), computer system 606 displays sub-interfaces with customization options and suggested graphical representations for the corresponding category, and, in response to an input directed to one of suggested graphical representations 1210b (e.g., inputs 1234d), computer system 606 selects the pictured poster as a graphical component of the customized representation of the user.

As illustrated in FIG. 12G, because an avatar representation was already selected as a graphical component of the customized representation of the user (e.g., after customizing the avatar representation as described with respect to FIGS. 12B-12F), confirm option 1214 is no longer grayed out in sharing interface 1206a, indicating that confirm option 1214 can be selected (e.g., via input 1234e) to save the currently-selected graphical component(s) (e.g., either before or after selecting a poser representation as a second graphical component of the customized representation of the user) and proceed to sharing interface 1206b. In some embodiments, if the avatar representation was already customized via sharing interface 1206a (e.g., as described above with respect to FIGS. 12B-12F), suggested graphical representations 1210b are automatically generated based on the customizations made to the avatar representation. For example, as illustrated in FIG. 12G, computer system 606 generates suggested graphical representations 1210b in the poster format using the custom “BB” monogram selected at FIG. 12D.

At FIG. 12H, in response to detecting a selection of at least one graphical component (e.g., an avatar representation and/or a poster representation), computer system 606 displays sharing interface 1206b, a user interface for reviewing and configuring contact settings for the sharing name and photo mode prior to activating the sharing name and photo mode, causing the name and visual representation of the user of computer system 606 to be provided to one or more contacts of the user for display on external devices associated with the contacts. For example, as noted above, computer system 606 provides sharing interface 1206b once the user has indicated that customization of the one or more graphical components is complete by selecting one or more of the confirm options (e.g., 1214, 1218g, and/or 1226g) in sharing interface 1206a and/or its sub-interfaces (e.g., 1218 and/or 1226). Sharing interface 1206b includes first name option 1236a for customizing a first name component (e.g., for a first/given name) of the custom representation of the user, last name option 1236b for customizing a second name component of the custom representation of the user (e.g., for a last/family name), and automatic sharing option 1236c for configuring a mode to automatically share the custom representation of the user with one or more of contacts of the user. For example, in response to detecting input 1244a selecting first name option 1236a, computer system provides controls (e.g., a text input field, virtual keyboard, and/or dictation tool) to the user for inputting custom text (e.g., a nickname) to be used as the first name component, such as the text “BB” illustrated in FIG. 12I. At FIG. 12H, automatic sharing option 1236c indicates that a “contacts only” automatic sharing mode is activated, such that, when the sharing name and photo mode is activated, the custom representation is automatically sent to the user's contacts.

Additionally, sharing interface 1206b includes user interface elements for reviewing the currently-selected graphical components of the custom representation of the user, including preview 1238a, which displays one of the currently-selected graphical components (e.g., the avatar representation customized and selected as described with respect to FIGS. 12E-12G); edit option 1238b; and pairing option 1238c, which displays the other currently-selected graphical component. For example, in response to detecting input 1244b directed to edit option 1238b, computer system 606 returns to sharing interface 1206a as illustrated in FIG. 12B to allow the user to further customize the avatar representation for the custom representation, and in response to detecting input 1244c directed to pairing option 1238c, computer system 606 returns to sharing interface 1206a as illustrated in FIG. 12G to allow the user to further customize the poster representation for the custom representation. In some embodiments, if the user selected a customized graphical component in one of the graphical representation formats (e.g., an avatar representation) but not the other (e.g., a poster representation), computer system 606 displays preview 1238a with the user-customized graphical component and automatically generates the graphical component displayed in pairing option 1238c to provide a pairing in the other format.

Finally, sharing interface 1206b includes cancel option 1240 for returning to sharing interface 1206a (e.g., as last displayed by computer system 606) to continue customizing the one or more graphical components and confirm option 1242 for activating the sharing name and photo mode with the currently-selected components. As illustrated in FIGS. 12I-12J, in response to detecting input 1246 directed to confirm option 1242, computer system 606 activates the sharing name and photo mode and shares the custom representation of the user with the user's contacts, including the graphical components (e.g., avatar representation and poster representation) and name components (e.g., first name “BB” and last name “Chao”) as indicated in sharing interface 1206b at FIG. 12I. As illustrated in FIG. 12J, after detecting input 1246, computer system 606 returns to messaging interface 1008 and displays sharing option 1248, which includes the avatar (e.g., or poster) representation and name that are included in the custom representation currently being shared with the user's contacts in the sharing name and photo mode.

At FIG. 12K, after having activated the sharing name and photo mode as described with respect to FIG. 12I, computer system 606 displays sharing option 1248 within call log interface 1034. For example, as described with respect to FIG. 11 and sharing options 1012a-1012c in FIGS. 10C, 10G, and/or 10J, computer system 606 displays sharing option 1248 in response to a particular input detected within call log interface 1034 (e.g., a downward swipe, such as input 1010).

At FIG. 12L, in response to detecting input 1250 directed to sharing option 1248, computer system 606 displays sharing interface 1206c, which unifies certain features of sharing interface 1206a for customizing a graphical component of the custom representation of the user and sharing interface 1206b for configuring contact settings for the sharing name and photo mode into a scrollable user interface. As illustrated in FIG. 12L, sharing interface 1206c includes preview 1252a (e.g., a preview of the previously-selected avatar representation), pairing option 1252b (e.g., including a preview of the previously-selected poster representation), avatar option 1022, poster option 1024, cancel option 1260, and confirm option 1262. Additionally, sharing interface 1206c initially (e.g., prior to detecting an input scrolling down within sharing interface 1206c, such as input 1266d) includes first plurality of suggested graphical recommendations 1254a, second plurality of suggested graphical recommendations 1254b, and third plurality of suggested graphical recommendations 1254c. As described with respect to sharing interface 1206a, a selection of one of the suggested graphical representations, such as input 1266a, changes a graphical component of the custom representation of the user to the selected graphical representation. Sharing interface 1206c does not include the category options that were included in sharing interface 1206b (e.g., 1208a-1208d and/or 1208e-1208g); however, second plurality of suggested graphical representations 1254b and third plurality of graphical representations 1254c correspond to suggestions for the photo and personalized character categories, respectively. For example, in response to detecting input 1266b directed to header 1256a for second plurality of suggested graphical representations 1254b, computer system 606 provides a sub-interface for customizing a photo representation, and, in response to detecting input 1266c directed to header 1256b for third plurality of suggested graphical representations 1254c, computer system 606 provides a sub-interface (e.g., sub-interface 1226) for customizing a personalized character representation.

At FIG. 12M, in response to detecting input 1266d scrolling down within sharing interface 1206c (e.g., using an upward swipe gesture), computer system 606 scrolls sharing interface 1206c down, displaying fourth plurality of suggested graphical recommendations 1254d (e.g., with header 1256c), first name option 1258a, last name option 1258b, and automatic sharing option 1258c. As described with respect to FIG. 12H (e.g., 1236a-1236c), first name option 1258a, last name option 1258b, and automatic sharing option 1258c are options for configuring the contact (e.g., name and automatic sharing) settings for the sharing name and photo mode. For example, in response to an input (e.g., input 1268a) selecting one of the name options (e.g., 1258a-1258b), computer system 606 provides controls (e.g., a text input field, virtual keyboard, and/or dictation tool) to the user for changing the custom text to be used as the name component(s) of the custom representation of the user. As illustrated in FIGS. 12M-12N, in response to detecting input 1268b selecting automatic sharing option 1258c, computer system 606 changes the setting to automatically share the custom representation of the user with the one or more contacts. At FIG. 12N, automatic sharing option 1258c indicates that an “always ask” automatic sharing mode is activated, such that, when the sharing name and photo mode is activated, computer system 606 prompts the user before sending the custom representation to the user's contacts. Accordingly, by scrolling within sharing interface 1206c, the user is provided access to controls for configuring both the graphical component(s) and the contact settings without needing to follow the initial, sequential configuration process described with respect to FIGS. 12B-12I, where the options for configuring the contact settings for the sharing name and photo mode (e.g., sharing interface 1206b) are only provided after confirming the graphical component(s) of the custom representation (e.g., via sharing interface 1206a).

FIGS. 13A-13B are a flow diagram illustrating a method for configuring a custom user representation for sharing with one or more contacts. Method 1300 is performed at a computer system (e.g., 100, 300, 500, 600, 606, and/or 694) (e.g., a smartphone, a smartwatch, a tablet, personal computer and/or a head mounted device) that is in communication with one or more display generation components (e.g., a display, a touch-screen display, a monitor, a holographic display system, and/or a head-mounted display system) and one or more input devices (e.g., a touch-sensitive surface (e.g., a touch-sensitive display), a mouse, a keyboard, a remote control, a visual input device (e.g., one or more cameras such as an infrared camera, a depth camera, a visible light camera, and/or a gaze tracking camera), and/or an audio input device (e.g., a microphone)). Some operations in method 1300 are, optionally, combined, the orders of some operations are, optionally, changed, and some operations are, optionally, omitted.

As described below, method 1300 provides an intuitive way of configuring a custom user representation for sharing with one or more contacts. The method reduces the cognitive burden on a user when configuring a custom user representation for sharing with one or more contacts, thereby creating a more efficient human-machine interface. For battery-operated computing devices, enabling a user to configure a custom user representation for sharing with one or more contacts faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by providing a first user interface for configuring a graphical component of a custom representation of a user, then, in response to an input selecting at least one custom graphical representation, displaying a second user interface for configuring one or more contact settings of the custom representation of the user) enhances the operability of the device by reducing accidental and mistaken inputs, reducing energy usage by the device. Reducing the number of inputs needed to perform an operation (such as by displaying a scrollable user interface with options for both configuring a graphical component and configuring contact settings for a custom representation of the user after a process for sharing the custom representation of the user is performed) enhances the operability of the device by reducing the number of inputs and time required to perform a particular operation, reducing energy usage by the device.

The computer system (e.g., 606) displays (1302), via the one or more display generation components, a first user interface (e.g., 1206a) that is for configuring a graphical component (e.g., one or more badges, avatars, photos, symbols, cards, and/or posters for visually representing the user) of a custom representation of a user of the computer system (e.g., as illustrated in FIGS. 12B and/or 12G). In some embodiments, the first user interface includes a plurality of options for configuring the graphical component of the custom user representation, such as options for navigating to sub-menus for detailed graphical representation customization and/or a plurality of candidate graphical representations (e.g., such as the automatically-generated suggestions described with respect to FIGS. 10A-11). In some embodiments, the first user interface includes at least one option for accepting, saving, and/or finalizing a selection of one or more graphical representations to be used for the custom representation of the user, such as a “Save,” “Done” or “Next” option. In some embodiments, the computer system displays the first user interface in response to detecting a first input (e.g., a touch, spoken, air gesture, and/or hardware button input or series of inputs) that is directed to a displayed configuration option (e.g., an affordance and/or selectable graphical user interface object) that is for initiating a process for configuring a custom representation of a user of the computer system (e.g., generating and/or sharing a non-default user representation with one or more contacts). In some embodiments, the configuration option is the first option for initiating a process to share a representation of a user described with respect to FIGS. 10A-11. For example, the configuration option is displayed in a communication user interface (e.g., a messaging, audio call, video call, and/or call log user interface) if a custom (e.g., non-default) user representation had not been previously configured (e.g., generated and/or shared with one or more contacts) and/or in response an input of a particular type (e.g., a downwards swipe) received in the communication interface.

The computer system detects (1304), via the one or more input devices, a first set of one or more inputs (e.g., 1216a-1216f, 1220a-1220d, 1224a-1224b, 1228a-1228e, 1232a-1232d, and/or 1234a-1234e) selecting (e.g., accepting, saving, and/or finalizing) one or more custom graphical representations for the graphical component of the custom representation of the user of the computer system (e.g., as illustrated in FIGS. 12B-12G), wherein the first set of one or more inputs includes at least one input directed to the first user interface (e.g., 1216a-1216f and/or 1234a-1234e). For example, the first set of one or more inputs includes at least one input indicating that the user has finished configuring the graphical component of the custom representation. For example, the first set of one or more inputs includes inputs detected while displaying the first user interface or a sub-menu thereof.

In response to detecting (1304) the first set of one or more inputs, the computer system displays (1306), via the one or more display generation components, a second user interface (e.g., 1206b) that is for configuring one or more contact settings of the custom representation of the user of the computer system (e.g., as illustrated in FIGS. 12H-12I). In some embodiments, the second user interface includes options for configuring shareable contact information for the user of the computer system (e.g., the user's display name, title/honorific, organization, email address, mailing address, and/or birthday) and options for selecting one or more contacts of the user of the computer system with whom to share the custom representation. In some embodiments, the second user interface includes at least one option for accepting, saving, and/or finalizing the selected contact settings, such as a “Save,” “Done” or “Share” option.

While displaying the second user interface, the computer system detects (1308), via the one or more input devices, a second set of one or more inputs (e.g., 1244a-1244c and/or 1246) that includes a request (e.g., 1246) to share (e.g., to initiate a process to share) the custom representation of the user of the computer system with one or more contacts (e.g., as illustrated in FIG. 12I). For example, the first set of one or more inputs indicates that the user has finished configuring both the contact settings and the graphical component of the custom representation and is ready to share the custom representation with contacts.

In response to detecting (1308) the second set of one or more inputs, the computer system initiates (1310) a process to share the custom representation of the user of the computer system with the one or more contacts (e.g., as described with respect to FIGS. 12I-12J). For example, the process includes transmitting the custom representation of the user to the one or more contacts (e.g., to the one or more contacts' devices) and/or providing the one or more contacts with access to view and use the custom representation of the user.

After the process to share the custom representation of the user of the computer system with the one or more contacts is performed (e.g., as described with respect to FIGS. 12J-12K) (e.g., after the custom representation of the user of the computer system has been shared with the one or more contacts), the computer system detects (1312), via the one or more input devices, a second input (e.g., 1250) that corresponds to a request to configure the custom representation of the user of the computer system (e.g., as illustrated in FIG. 12K). In some embodiments, the second input includes a selection of a configuration option displayed in a communication user interface, such as the configuration option discussed above or another configuration option. In some embodiments, the second user input includes one or more inputs received via a contacts and/or settings user interface.

In response to detecting the second input, the computer system displays (1314), via the one or more display generation components, a scrollable configuration user interface (e.g., 1206c), including displaying a first set of options (e.g., 1022, 1024, 1252b, 1254a-1254c, and/or 1256a-1256b) for configuring the graphical component of the custom representation of the user of the computer system (e.g., as illustrated in FIG. 12L). While displaying the first set of options for configuring the graphical component of the custom representation of the user of the computer system, the computer system detects (1316), via the one or more input devices, a third input (e.g., 1266d) that corresponds to a request to scroll within the scrollable configuration user interface.

In response to detecting the third input, the computer system displays (1318), via the one or more display generation components, a second set of options (e.g., 1258a-1258c) for configuring the one or more contact settings of the custom representation of the user of the computer system. For example, the scrollable configuration user interface is a unified configuration user interface that includes at least some of the configuration options provided in the first user interface and at least some of the configuration options provided in the second user interface.

In some embodiments, the first user interface (e.g., 1206a) includes a plurality of selectable type options (e.g., 1208a-1208d and/or 1208e-1208g) (e.g., selectable graphical elements, buttons, icons, and/or affordances) that correspond to a respective plurality of graphical representation types (e.g., options for multiple different categories of representations available to use as part of the graphical component of the custom graphical representation of the user of the computer system, such as options for monograms, photos, images, symbols, and/or avatars (e.g., a customized, anthropomorphized, and/or animated graphical representation of the user)) and a first plurality of selectable suggestion options (e.g., 1210a and/or 1210b) that correspond to a respective first plurality of graphical representation suggestions (e.g., as illustrated in FIGS. 12B and/or 12G) (e.g., options of candidate graphical representations available to use as the graphical component of the custom graphical representation of the user of the computer system). In some embodiments, one or more of the respective first plurality of graphical representation suggestions are automatically generated suggested representations (e.g., suggestions for representations of the first user that are based data associated with the first user and/or representations that the user has previously interacted with). In some embodiments, the first set of one or more inputs selecting one or more custom graphical representations for the graphical component of the custom representation of the user includes an input selecting a graphical representation suggestion from the respective first plurality to be used as one of the one or more custom graphical representations.

In some embodiments, while displaying the first user interface (e.g., 1206a), the computer system detects, via the one or more input devices, an input (e.g., 1216c-1216f and/or 1234a-1234c) (e.g., a touch input detected via a touch-sensitive surface of a display) directed to a first type option of the plurality of selectable type options (e.g., the options for the multiple different types of available representations) that corresponds to a first graphical representation type of the respective plurality of graphical representation types(e.g., 1208a-1208d and/or 1208e-1208g). In some embodiments, in response to detecting the input directed to the first type option, the computer system displays, via the one or more display generation components, a plurality of selectable customization options (e.g., 1218b-1218d and/or 1226b-1226d) (e.g., selectable graphical elements, buttons, icons, and/or affordances) that correspond to a respective plurality of controls for customizing a graphical representation of the first graphical representation type and a second plurality of selectable suggestion options that corresponds to a respective second plurality of graphical representation suggestions (e.g., 1218e and/or 1226e), wherein the respective second plurality of graphical representation suggestions are graphical representations of the first graphical representation type (e.g., as illustrated in FIGS. 12C and/or 12E). In some embodiments, in response to a selection of a respective customization option, the computer system initiates a process for allowing the user to configure (e.g., select and/or modify) at least one parameter (e.g., background color, text color, font, text size, image cropping, image filter, avatar pose, avatar expression, and/or avatar type) for the graphical representation of the first graphical representation type. For example, the process includes displaying one or more interactive controls (e.g., buttons, sliders, pickers, menus, lists, galleries, and/or input fields) for the at least one parameter. In some embodiments, the respective second plurality of graphical representation suggestions is at least partially different from the respective first plurality of graphical representation suggestions. For example, the initial suggestions include suggested graphical representations of multiple different graphical representation types (e.g., monograms, photos, images, symbols, and/or avatars), while the suggestions displayed in response to selecting a graphical representation type include only suggestions of the selected type. In some embodiments, one or more of the respective second plurality of graphical representation suggestions are automatically generated suggested representations (e.g., suggestions for representations of the first user that are based data associated with the first user and/or representations that the user has previously interacted with). In some embodiments, the first set of one or more inputs selecting one or more custom graphical representations for the graphical component of the custom representation of the user includes an input selecting a graphical representation suggestion from the respective second plurality to be used as one of the one or more custom graphical representations.

In some embodiments, the computer system detects, via the one or more input devices, an input (e.g., 1228a) directed to a first customization option (e.g., 1226b) of the plurality of selectable customization options (e.g., the selectable options for the multiple customization options for the first graphical representation type) that corresponds to a camera-based control for customizing the graphical representation of the first graphical representation type (e.g., as illustrated in FIG. 12E). In some embodiments, the first graphical representation type is an avatar graphical representation (e.g., a customized, anthropomorphized, and/or animated graphical representation of the user). In some embodiments, in response to detecting the input directed to the first customization option, the computer system initiates a process that includes capturing, via one or more cameras that are in communication with the computer system, camera data and displaying (e.g., customizing), via the one or more display generation components, the graphical representation of the first graphical representation type having an appearance that is based on the camera data (e.g., as described with respect to FIG. 12E). For example, the computer system automatically sets one or more appearance, expression, and/or pose parameters for the avatar graphical representation based on an appearance, expression, and/or pose of the user detected in the camera data (e.g., using image processing and/or machine vision techniques).

In some embodiments, the computer system detects, via the one or more input devices, an input (e.g., 1220a) directed to a second customization option (e.g., 1218b) of the plurality of selectable customization options (e.g., the selectable options for the multiple customization options for the first graphical representation type) that corresponds to a text control for customizing the graphical representation of the first graphical representation type (e.g., as illustrated in FIG. 12C). In some embodiments, the first graphical representation type is a monogram graphical representation. In some embodiments, in response to detecting the input directed to the second customization option, the computer system displays, via the one or more display generation components, a text input user interface (e.g., 1222 and/or a text input field) for entering text to be included in the graphical representation of the first graphical representation type (e.g., as illustrated in FIG. 12D). In some embodiments, the text input user interface includes a virtual keyboard for entering the text. In some embodiments, the text input user interface accepts a limited number of characters, such as a monogram of up to two, three, or four characters. In some embodiments, the scrollable configuration user interface (e.g., 1206c) does not include the plurality of selectable type options (e.g., 1208a-1208d and/or 1208e-1208g) that corresponds to the respective plurality of graphical representation types (e.g., as illustrated in FIGS. 12L-12M). For example, after the process to share the custom representation of the user of the computer system with the one or more contacts is performed, the computer system forgoes surfacing the selectable category options in response to requests to configure the custom representation of the user of the computer system.

In some embodiments, the first user interface includes (e.g., 1206a) an indication (e.g., a selectable graphical element, button, icon, affordance, and/or text) of a first representation format (e.g., 1022) (e.g., a first size, shape, and/or layout) and an indication of a second representation format (e.g., 1024) that is different from the first representation format (e.g., a different size, shape, and/or layout). For example, the first representation format is a compact graphical representation format and the second representation format is a large-form graphical representation format. For example, the first representation format is a circular graphical representation format, and the second representation format is a rectangular graphical representation format. In some embodiments, when initially displaying the first user interface includes, the indication of the first representation format is selected (e.g., in a selected/active state) by default, and, in response to detecting an input directed to the indication of the second representation format, the indication of the second representation format is selected instead. In some embodiments, displaying the first user interface includes, in accordance with a determination that the indication of the first representation format is selected (e.g., in a selected/active state), displaying, via the one or more display generation components, a first plurality of selectable options (e.g., 1208a-1208d and/or 1210a) for configuring a custom graphical representation in the first representation format (e.g., as illustrated in FIG. 12B). For example, the first user interface includes type options (e.g., for accessing particular types of customization options and/or suggestions) and suggestions for a graphical representation in the first format. In some embodiments, displaying the first user interface includes, in accordance with a determination that the indication of the second representation format is selected (e.g., in a selected/active state), displaying, via the one or more display generation components, a second plurality of selectable options (e.g., 1208e-1208g and/or 1210b) for configuring a custom graphical representation in the second representation format (e.g., as illustrated in FIG. 12G). For example, the first user interface includes type options (e.g., graphical representation categories) and suggestions for a graphical representation in the second format. In some embodiments, the type options for configuring the custom graphical representation in the first format correspond to a different plurality of graphical representation types than the type options for configuring the custom graphical representation in the second format (e.g., monograms, photos/images, symbols, and avatars are available graphical representation types for the first format, but only monograms, photos/images, and avatars are available for the second format).

In some embodiments, the first set of one or more inputs selecting one or more custom graphical representations includes at least one input (e.g., 1216a-1216f, 1220a-1220d, 1224a-1224b, 1228a-1228e, 1232a-1232d) selecting (e.g., accepting, saving, and/or finalizing) an initial custom graphical representation in the first representation format (e.g., as illustrated in FIG. 12F). For example, the at least one input is detected while the indication of the first representation format is selected. In some embodiments, in response to detecting the at least one input selecting the initial custom graphical representation in the first representation format, the computer system displays, via the one or more display generation components, a suggested custom graphical representation (e.g., 1238c) in the second representation format, wherein the suggested custom graphical representation is automatically generated based on the initial custom graphical representation (e.g., as described with respect to FIG. 12H). For example, the computer system generates one (e.g., or more) suggested pairings for an initially-selected (e.g., first-configured) custom graphical representation. In some embodiments, in response to detecting the at least one input selecting the initial custom graphical representation in the first format, the computer system displays the suggested custom graphical representation in the second user interface. In some embodiments, the at least one input selecting the initial custom graphical representation in the first format includes an input directed to the indication of the second representation format (e.g., after configuring the custom graphical representation in the first representation format, the user selects the indication of the second format to view options for configuring another custom graphical representation in the second representation format), and the computer system displays the suggested custom graphical representation in the first user interface.

In some embodiments, the second user interface (e.g., 1206b) (e.g., the user interface for configuring the one or more contact settings of the custom representation of the user of the computer system) includes a first custom graphical representation in the first representation format (e.g., 1238a) and a second custom graphical representation in the second representation format (e.g., 1238c) (e.g., as illustrated in FIGS. 12H-12I). For example, the second user interface includes both a user-selected custom graphical representation in the first representation format and a user-selected or an automatically-generated custom graphical representation (e.g., pairing suggestion) in the second representation format. In some embodiments, in accordance with a determination that the first set of one or more inputs includes an input selecting the first custom graphical representation in the first representation format (e.g., 1216a-1216f, 1220a-1220d, 1224a-1224b, 1228a-1228e, and/or 1232a-1232d) and does not include an input selecting a respective custom graphical representation in the second representation format (e.g., 1234a-1234e) (e.g., the user has configured a custom graphical representation in the first representation format but did not configure a custom graphical representation in the second representation format), the second custom graphical representation in the second representation format is automatically generated based on the first custom graphical representation (e.g., as described with respect to FIG. 12H).

In some embodiments, the scrollable configuration user interface includes a third custom graphical representation in the first representation format (e.g., 1252a) and a fourth custom graphical representation in the second representation format (e.g., 1252b) (e.g., as illustrated in FIGS. 12L-12N). For example, after the process to share the custom representation of the user of the computer system with the one or more contacts is performed, the computer system presents both formats of the custom graphical representations for the graphical component of the custom representation of the user of the computer system in response to requests to configure the custom representation of the user of the computer system.

In some embodiments, the second user interface (e.g., 1206b) includes one or more identification options (e.g., 1236a and/or 1236b) (e.g., selectable user interface elements, icons, buttons, and/or affordances) for configuring (e.g., editing, adding, and/or removing) identification information included in the custom representation of the user of the computer system and one or more sharing options (e.g., 1236c) (e.g., selectable user interface elements, icons, buttons, and/or affordances) for configuring the process to share the custom representation of the user of the computer system with the one or more contacts (e.g., as illustrated in FIGS. 12H-12I). For example, the one or more identification options include options for configuring a contact name and/or other contact information, such as phone number information, organization information, mailing address information, and/or email address information. In some embodiments, while displaying the second user interface, in response to detecting an input corresponding to a selection of an identification option of the one or more identification options, the computer system initiates a process for configuring a respective identification parameter. For example, in response to a selection of an identification option for configuring a first (e.g., given) name parameter, the computer system displays a virtual keyboard for a user to enter custom text (e.g., a nickname). For example, the one or more sharing options include options for configuring when the custom representation is shared with the one or more contacts and/or which contacts are to receive the custom representation. In some embodiments, while displaying the second user interface, in response to detecting an input corresponding to a selection of a sharing option of the one or more sharing options, the computer system initiates a process for configuring a respective sharing parameter. For example, in response to a selection of a sharing option for an automatic sharing mode (e.g., a mode that, when active, automatically shares the custom representation with the one or more contacts), the computer system toggles between settings for the automatic sharing mode (e.g., activating and/or deactivating the mode) and/or displays a menu of options for the mode (e.g., additional options for when the custom representation is shared with the one or more contacts).

In some embodiments, the second set of options (e.g., 1258a-1258c) for configuring the one or more contact settings of the custom representation of the user of the computer system includes the one or more identification options (e.g., 1258a and/or 1258b) and the one or more sharing options (e.g., 1258c). For example, after the process to share the custom representation of the user of the computer system with the one or more contacts is performed, the user can edit the contact settings for the custom representation by scrolling down within the scrollable configuration user interface.

Note that details of the processes described above with respect to method 1300 (e.g., FIGS. 13A-13B) are also applicable in an analogous manner to the methods described above. For example, methods 700, 900, and/or 1100 optionally include one or more of the characteristics of the various methods described above with reference to method 1300. For example, the computer system of method 1300 can be the same computer system that performs methods 700 and/or 900. For example, the first user interface of method 1300 is displayed in response to a selection of the first option displayed as described with respect to method 1100. For brevity, these details are not repeated.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery to users of translation of audio and/or messages may be of interest to them. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be translated to another language.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

1-4. (canceled)

5. A computer system configured to communicate with one or more display generation components, one or more input devices, and one or more output devices, comprising:
one or more processors; and
memory storing one or more programs configured to be executed by the one or more processors, the one or more programs including instructions for:
receiving, via the one or more input devices, a first set of one or more inputs to initiate a first communication session between a first user associated with the computer system and a first participant associated with an external device;
in response to receiving the first set of one or more inputs:
in accordance with a determination that translation criteria are met, displaying, via the one or more display generation components, an option to enable operation of an automatic translation mode, wherein selection of the option to enable operation of the automatic translation enables translation of first audio received from the first participant; and
in accordance with a determination that the translation criteria are not met, forgoing displaying the option to enable operation of the automatic translation mode;
during the first communication session and while the automatic translation mode is enabled, receiving the first audio from the first participant, wherein the first audio is in a first language; and
in response to receiving the first audio:
outputting, via the one or more output devices, the first audio in the first language, wherein at least a portion of the first audio is output at a first volume; and
outputting, via the one or more output devices, second audio at a second volume, different from the first volume, wherein the second audio is in a second language and is a translated version of the first audio.

6. The computer system of claim 5, wherein the external device has an external phone number and the translation criteria includes a first criterion that is met when the external phone number corresponds to a foreign language.

7. The computer system of claim 5, wherein the option to enable operation of an automatic translation mode is an option to select a first suggested language that is identified as the first language during the first communication session, wherein the first suggested language is based off a determination that a first external phone number of the external device is associated with the first suggested language.

8. The computer system of claim 7, wherein the determination that the first external phone number is associated with the first suggested language is based on a respective geographical region associated with the first external phone number.

9. The computer system of claim 7, wherein:
in accordance with a determination that a first respective language model for the first suggested language has been downloaded, the option to select the suggested language, when selected, initiates the first communication session using the first suggested language as the first language and using the downloaded first respective language model.

10. The computer system of claim 7, wherein:
in accordance with a determination that a second respective language model for the first suggested language has not been downloaded, the option to select the first suggested language, when selected initiates a download of the second respective language model for the first suggested language.

11. The computer system of claim 10, wherein:
the option to enable operation of an automatic translation mode is displayed as part of a first user interface; and
the first user interface includes an option that, when selected, causes a display of a third language, different from the first suggested language, that is available to be used as the first language during the first communication session.

12. The computer system of claim 5, further comprising:
displaying a call log interface that includes an option that, when selected, initiates a process to download one or more language models that can be used as the first language during the first communication session.

13. The computer system of claim 12, further comprising:
receiving a first input corresponding to the option for initiating a process to download one or more language models; and
in response to receiving the first input, displaying a language download interface that includes a suggested language to be translated to and a suggested language to be translated from.

14. The computer system of claim 13, wherein the suggested language to be translated from is based on a current geographical location of the computer system.

15. The computer system of claim 13, wherein the suggested language to be translated from is a selectable option that, when selected, causes a download of a language model associated with the suggested language to be translated from.

16. The computer system of claim 13, wherein the language download interface includes a plurality of options for languages to be translated from, and wherein the plurality of options for languages to be translated from have a plurality of respective language models that are available to be downloaded.

17. The computer system of claim 5, wherein the first audio and the second audio overlap.

18. The computer system of claim 5, wherein:
the first audio has a first audio portion that does not overlap with the second audio and the first audio has a second audio portion that begins when the first audio overlaps with the second audio;
the first audio portion is output at a third volume that is louder than the first volume; and
the second audio portion is output at the first volume.

19. The computer system of claim 5, wherein the second volume is a volume corresponding to a current output volume setting of the computer system.

20. The computer system of claim 5, further comprising:
receiving, via the one or more input devices, an audio input from the first user in the second language; and
in response to receiving the audio input, outputting third audio in the first language at the first volume, wherein the third audio in the first language is a translated version of the audio input.

21. The computer system of claim 5, further comprising:
during the first communication session and while the automatic translation mode is enabled, prior to receiving the first audio from the first participant:
outputting first audio indicating that the first communication session is being translated, wherein the first audio indicating that the first communication session is being translated is output in the second language at the second volume; and
outputting second audio indicating that the first communication session is being translated, wherein the second audio indicating that the first communication session is being translated is output in the first language at the first volume.

22. The computer system of claim 21, wherein the first audio indicating that the first communication session is being translated includes first content and the second audio indicating that the first communication session is being translated includes second content that is different from the first content.

23. The method of claim 5, further comprising:
receiving, via the one or more input devices, a second set of one or more inputs to initiate a communication session between the first user and a second participant; and
in response to receiving the second set of one or more inputs:
initiating the communication session between the first user and the second participant; and
in accordance with a determination that the second participant is a known participant that is associated with a language that was used to translate previous audio received from the second participant, displaying an option to enable a second automatic translation mode that, when selected, enables translation of audio received from the second participant.

24. The computer system of claim 5, further comprising:
receiving, via the one or more input devices, a third set of one or more inputs to initiate a communication session between the first user and a third participant, wherein the third participant is an unknown participant;
in response to receiving the third set of one or more inputs, initiating the communication session between the first user and the third participant; and
during the communication session between the first user and the third participant, displaying, via the one or more display generation components, a first selectable user interface object that, when selected, initiates a process for enabling translation of audio received from the third participant.

25. The computer system of claim 24, further comprising:
during the communication session between the first user and the third participant receiving, via the one or more input devices, a fourth set of one or more inputs that includes an input corresponding to the first selectable user interface object; and
in response to receiving the fourth set of one or more inputs, displaying a language confirmation interface that includes a suggested language that can be used to translate the audio received from the third participant.

26. The computer system of claim 5, further comprising:
during the first communication session and while the automatic translation mode is enabled, displaying, via the one or more display generation components, a first transcript of the first communication session that includes a first textual representation of the first audio in the second language.

27. The computer system of claim 26, wherein the first transcript of the first communication session includes an option for modifying a visual appearance of the transcript of the communication session that, when selected, causes a display of a second textual representation of the first audio in the first language, wherein the first textual representation and the second textual representation are concurrently displayed.

28. The computer system of claim 5, further comprising:
during the first communication session and while the automatic translation mode is enabled, concurrently displaying via the one or more display generation components:
a transcript of the communication session; and
an option to deactivate the automatic translation mode.

29. The computer system of claim 5, further comprising:
during the first communication session and while the automatic translation mode is enabled:
displaying, via the one or more display generation components, a second selectable user interface object that, when selected, initiates a process for changing a translation model used to translate the first audio received from the first participant;
receiving, via the one or more input devices, an input corresponding to the second selectable user interface object; and
in response to receiving the input corresponding to the second selectable user interface object, initiating the process for changing the translation model used to translate the first audio received from the first participant.

30. The computer system of claim 5, further comprising:
receiving, via the one or more input devices, a set of one or more inputs to initiate a live video communication session between the first user and a fourth participant;
in response to receiving the one or more inputs to initiate a live video communication session between the first user and the fourth participant, initiating the live video communication session; and
during the live video communication session:
receiving audio from the fourth participant in a fourth language; and
displaying via the one or more display generation components:
a live video transmission from the fourth participant; and
a transcript of the live video communication session that includes a textual representation of the audio from the fourth participant in a fifth language, wherein the fifth language is a translated version of the fourth language.

31. The computer system of claim 5, further comprising:
during the first communication session and while the automatic translation mode is not enabled, receiving third audio from the first participant in the first language; and
in response to receiving the third audio and in accordance with a determination that a second automatic translation mode is currently operating on the external device:
outputting, via the one or more output devices, fourth audio in the second language; and
forgoing displaying a second message transcript of the first communication session.

32. The computer system of claim 31, further comprising:
in response to receiving the third audio and in accordance with a determination that the second automatic translation mode is currently operating on the external device, displaying, via the one or more display generation components, an option to display the second message transcript of the first communication session.

33. The computer system of claim 5, wherein the second audio in the second language is generated by the computer system.

34. A non-transitory computer-readable storage medium storing one or more programs configured to be executed by one or more processors of a computer system that is in communication with one or more display generation components, one or more input devices, and one or more output devices, the one or more programs including instructions for:
receiving, via the one or more input devices, a first set of one or more inputs to initiate a first communication session between a first user associated with the computer system and a first participant associated with an external device;
in response to receiving the first set of one or more inputs:
in accordance with a determination that translation criteria are met, displaying, via the one or more display generation components, an option to enable operation of an automatic translation mode, wherein selection of the option to enable operation of the automatic translation enables translation of first audio received from the first participant; and
in accordance with a determination that the translation criteria are not met, forgoing displaying the option to enable operation of the automatic translation mode;
during the first communication session and while the automatic translation mode is enabled, receiving the first audio from the first participant, wherein the first audio is in a first language; and
in response to receiving the first audio:
outputting, via the one or more output devices, the first audio in the first language, wherein at least a portion of the first audio is output at a first volume; and
outputting, via the one or more output devices, second audio at a second volume, different from the first volume, wherein the second audio is in a second language and is a translated version of the first audio.

35. A computer system comprising:
at a computer system that is in communication with one or more display generation components, one or more input devices, and one or more output devices:
receiving, via the one or more input devices, a first set of one or more inputs to initiate a first communication session between a first user associated with the computer system and a first participant associated with an external device;
in response to receiving the first set of one or more inputs:
in accordance with a determination that translation criteria are met, displaying, via the one or more display generation components, an option to enable operation of an automatic translation mode, wherein selection of the option to enable operation of the automatic translation enables translation of first audio received from the first participant; and
in accordance with a determination that the translation criteria are not met, forgoing displaying the option to enable operation of the automatic translation mode;
during the first communication session and while the automatic translation mode is enabled, receiving the first audio from the first participant, wherein the first audio is in a first language; and
in response to receiving the first audio:
outputting, via the one or more output devices, the first audio in the first language, wherein at least a portion of the first audio is output at a first volume; and
outputting, via the one or more output devices, second audio at a second volume, different from the first volume, wherein the second audio is in a second language and is a translated version of the first audio.
